(19) United States
(12) Patent Application Publication
(10) Pub. No.: US 2023/0309554 A1
(43) Pub. Date: Oct. 5, 2023

(54) Polymer Carriers for Delivery of Agrochemicals in Crop Plants

(71) Applicant: Carnegie Mellon University, Pittsburgh, PA (US)

(72) Inventors: Gregory Lowry, Pittsburgh, PA (US); Yilin Zhang, Pittsburgh, PA (US); Robert Tilton, Pittsburgh, PA (US); Krzysztof Matyjaszewski, Pittsburgh, PA (US)

(21) Appl. No.: 18/012,048

(22) PCT Filed: Jun. 22, 2021
(86) PCT No.: PCT/US2021/038449

§ 371 Date: Dec. 21, 2022

Related U.S. Application Data
(60) Provisional application No. 63/042,386, filed on Jun. 22, 2020.
(60) Provisional application No. 63/210,222, filed on Jun. 14, 2021.

(51) Int. Cl. A01N 25/10; A01N 25/28; C08L 5/16; C08L 53/00

(52) U.S. Cl. CPC A01N 25/10; A01N 25/28; C08L 5/16; C08L 53/005

(57) ABSTRACT

Polymeric nanoparticles are provided for use in delivery of cargoes to plants. A method of delivering cargoes to plants, and to particular plant parts is provided. A method of treating heat stress in a plant also is provided.

### CROSS REFERENCE TO RELATED APPLICATIONS

This application is the United States national phase of International Application No. PCT/US2021/038449 filed Jun. 22, 2021, and claims priority to United States Provisional Patent Application Nos. 63/042,386 filed Jun. 22, 2020, and 63/210,222 filed Jun. 14, 2021, the disclosures of which are hereby incorporated by reference in their entirety.

Current agricultural practices are unsustainable, in part due to low agrochemical use efficiency, e.g., <5% for applied pesticides, fungicides, and micronutrients. The unutilized agrochemicals (over 90%) wash off of the leaves and enter the environment, becoming pollution for water and soil. Stresses from climate change, including higher maximum daily temperatures are also lowering agricultural productivity at a time when global agricultural production needs to expand by 60% before 2050 to meet increased demand. Making agriculture more resilient against climate stress, and agricultural practices more efficient, are both essential to meeting several United Nations Sustainable Development Goals (Zero Hunger, Clean Water and Sanitation).

Plant abiotic stress, including extreme heat and cold, excess light, drought and nutrient deficiency are threatening agricultural production. More frequent extreme weather caused by climate change is projected to induce severe plant abiotic stress that leads to over 40% crop loss by 2070. Heat and excess light stress leads to Reactive Oxygen Species (ROS) production in leaves, causing photosynthetic activity and photosystem II (PSII) repair inhibition, and hurting plant health and productivity. Materials that alleviate plant stress are limited and often require injection or overspray to leaves, causing difficulties for large scale implements.

Traditional agrochemical application involves spraying large quantities of active ingredients on crops before disease incidences happen (pre-emergent application). Natural plant barriers like the leaf cuticle and epidermis inhibit uptake of the applied agrochemicals, often resulting in only ˜0.1% of active agent reaching the target pathogen or pest and low availability in important plant compartments when disease manifests. The pathogen related plant disease is causing over 20% losses of global agricultural productivity. Efficient control of plant diseases, especially those present in poorly accessible plant compartments (e.g., systemic or root-borne diseases), will benefit from a carrier that can efficiently deliver active agents into the vasculature, to roots, and make the active ingredient available at precisely the right time, e.g., at high temperatures when plants are vulnerable due to heat stress. Thus, it is desirable to develop an agrochemical carrier that can be pre-loaded with common agents such as pesticides, nutrients, or other agrochemicals. Agents efficiently enter the plants through the leaves, deliver the agent to desired internal plant targets, and release the agent precisely when plants are suffering from stresses, disease, or prophylactically.

### STATEMENT REGARDING FEDERAL FUNDING

This invention was made with United States government support under 1266252 and 1911820 awarded by the National Science Foundation. The U.S. government has certain rights in the invention.

### SUMMARY

A composition is provided comprising a star, comb, bottlebrush, or dendritic polymer particle having a diameter, optionally a hydrodynamic diameter, of 50 nm or less, the particle comprising: a core moiety; and pendent block copolymer chains extending from the core moiety and comprising a first, acidic or basic (co)polymer segment attached to and extending from the core, and a second, environment-sensitive (co)polymer segment attached to and extending from the first segment, wherein the pendent chains, the first segment, and the second segment each, independently, have a polydispersity index of no more than 2. The first copolymer segment may be acidic. The composition may comprise a cargo retained within the particle.

A method of introducing a cargo into a plant is provided. The method comprises administering to the plant a composition a star, comb, bottlebrush, or dendritic polymer particle having a diameter, optionally a hydrodynamic diameter, of 50 nm or less, the particle comprising: a core moiety; pendent block copolymer chains extending from the core moiety and comprising a first, acidic or basic (co)polymer segment attached to and extending from the core, and a second, environment-sensitive (co)polymer segment attached to and extending from the first segment, wherein the pendent chains, the first segment, and the second segment each, independently, have a polydispersity index of no more than 2; and a cargo retained within the particle.

A method of introducing a cargo into a plant to treat a disease in the plant is provided. The method comprises administering to the plant a composition comprising a star, comb, bottlebrush, or dendritic polymer particle having a diameter, optionally a hydrodynamic diameter, of 50 nm or less, the particle comprising: a core moiety; pendent block copolymer chains extending from the core moiety and comprising a first, acidic or basic (co)polymer segment attached to and extending from the core, and a second, environment-sensitive (co)polymer segment attached to and extending from the first segment, wherein the pendent chains, the first segment, and the second segment each, independently, have a polydispersity index of no more than 2; and a cargo retained within the particle, wherein the cargo treats the disease and is administered in an amount effective to treat the disease.

The following numbered clauses describe various aspects, embodiments, and/or examples of the present invention.

Clause 1. A composition comprising a star, comb, bottlebrush, or dendritic polymer particle having a diameter, optionally a hydrodynamic diameter, of 50 nm or less, the particle comprising:
a core moiety; and
pendent block copolymer chains extending from the core moiety and comprising a first, acidic or basic (co)polymer segment attached to and extending from the core, and a second, environment-sensitive (co)polymer segment attached to and extending from the first segment, wherein the pendent chains, the first segment, and the second segment each, independently, have a polydispersity index of no more than 2.

Clause 2. The composition of clause 1, wherein the first copolymer segment is acidic.

Clause 3. The composition of clause 1 or 2, further comprising a cargo retained within the particle.

Clause 4. The composition of clause 2, wherein the cargo is monoatomic.

Clause 5. The composition of clause 4, wherein the cargo comprises Mg²⁺, Fe²⁺/Fe³⁺, Zn²⁺, or Ca²⁺, K⁺, Cu²⁺, Mn²⁺/Mn⁴⁺, Mo²⁺/Mo⁶⁺, or Ni²⁺.

Clause 6. The composition of clause 2, wherein the cargo is a non-peptidyl compound.

Clause 7. The composition of clause 2, wherein the cargo is crystal violet, a polyamine plant growth promoter such as spermidine, spermine, choline, streptomycin, and/or tetracycline.

Clause 8. The composition of clause 2, wherein the cargo is an antimicrobial peptide.

Clause 9. The composition of clause 8, wherein the cargo is streptomycin, tetracycline, a bacteriocin, a defensin, a peptaibol, an antimicrobial cyclopeptide (e.g., an amphisin, a corpeptin, a putisolvin, a syringomycin, a syringopeptin, a tolaasin, a viscosin, a gramicidin, a calophycin, a bacitracin, or a laxaphycin) or pseudopeptide, or an antimicrobial fragment of any of the preceding, or an antimicrobial synthetic peptide.

Clause 10. The composition of any one of clauses 1-9, wherein the particle is a comb or bottlebrush polymer.

Clause 11. The composition of any one of clauses 1-9, wherein the particle is a star polymer.

Clause 12. The composition of any one of clauses 1-11, wherein the core is a polysaccharide residue.

Clause 13. The composition of any one of clauses 1-12, wherein the core is cyclical.

Clause 14. The composition of clause 13, wherein the core is a cyclodextrin residue, such as a p-cyclodextrin residue.

Clause 15. The composition of any one of clauses 1-14, wherein the first segment comprises from 25 to 150 monomer residues.

Clause 16. The composition of any one of clauses 1-15, wherein the first segment comprises acrylic acid, methacrylic acid, styrene sulfonic acid, or 2-acrylamido-2-methyl-1-propane sulfonic acid residues.

Clause 17. The composition of clause 16, wherein the first segment is poly((meth)acrylic acid).

Clause 18. The composition of any one of clauses 1-17, wherein the ratio of the number of monomer residues in the first segment to the number of monomer residues in the second segment ranges from 1:0.25 to 1:<9, or from 1:1 to 1:7.

Clause 19. The composition of any one of clauses 1-18, wherein the second segment is thermoresponsive.

Clause 20. The composition of clause 19, wherein the second segment imparts a lower critical solution temperature (LCST) between 25° C. to 40° C. to the pendant block copolymer chains.

Clause 21. The composition of clause 19, wherein the second segment comprises a monomer selected from N-isopropyl acrylamide (NIPAAm), 2-(dimethylamino)ethyl methacrylate (DMAEMA), vinylcaprolactam, 2-hydroxyethyl methacrylate (HEMA diethylacrylamide, and/or poly(ethylene glycol) methyl ether methacrylate.

Clause 22. The composition of any one of clauses 1-18, wherein the first segment is poly((meth)acrylic acid) and/or the second segment is poly(NIPAAm).

Clause 23. The composition of any one of clauses 1-18, wherein the second segment oxidizes in the presence of a reactive oxygen species (ROS), becoming more soluble in an aqueous solution.

Clause 24. The composition of clause 23, wherein the second segment comprises one or more pendant thioether, boronic ester, or selenium-containing groups, and optionally comprises one or more 2-(Methylthio)ethyl acrylate residues.

Clause 25. The composition of any one of clauses 1-24, wherein the first and second segments are (meth)acrylic polymer segments.

Clause 26. The composition of any one of clauses 1-25, further comprising a surfactant, such as a non-ionic detergent, e.g., 3-(2-methoxyethoxy)propyl-methyl-bis(trimethylsilyloxy)silane.

Clause 27. The composition of any one of clauses 1-26, wherein the particle has a diameter, optionally a hydrodynamic diameter, ranging from 3 nm to 6 nm, or ranging from 35 nm to 50 nm.

Clause 28. The composition of any one of clauses 1-27, wherein the particle does not precipitate at pH 2.0 in an aqueous environment, such as water.

Clause 29 A method of introducing a cargo into a plant, comprising administering to the plant a composition a star, comb, bottlebrush, or dendritic polymer particle having a diameter, optionally a hydrodynamic diameter, of 50 nm or less, the particle comprising:
a core moiety;
pendent block copolymer chains extending from the core moiety and comprising a first, acidic or basic (co)polymer segment attached to and extending from the core, and a second, environment-sensitive (co)polymer segment attached to and extending from the first segment, wherein the pendent chains, the first segment, and the second segment each, independently, have a polydispersity index of no more than 2; and
a cargo retained within the particle.

Clause 30 A method of introducing a cargo into a plant to treat a disease in the plant, comprising administering to the plant a composition comprising a star, comb, bottlebrush, or dendritic polymer particle having a diameter, optionally a hydrodynamic diameter, of 50 nm or less, the particle comprising:
a core moiety;
pendent block copolymer chains extending from the core moiety and comprising a first, acidic or basic (co)polymer segment attached to and extending from the core, and a second, environment-sensitive (co)polymer segment attached to and extending from the first segment, wherein the pendent chains, the first segment, and the second segment each, independently, have a polydispersity index of no more than 2; and a cargo retained within the particle,
wherein the cargo treats the disease and is administered in an amount effective to treat the disease.

Clause 31. The method of clause 29 or 30, wherein the particles have a hydrodynamic diameter of less than 20 nm to target new growth in the plant.

Clause 32. The method of clause 29 or 30, wherein the particles have a hydrodynamic diameter of at least 20 nm to target roots and stem of the plant.

Clause 33. The method of clause 29 or 30, wherein the pendant block copolymer chains are thermoresponsive, having an LCST between 25° C. to 40° C., and the cargo optionally comprises an antimicrobial peptide, crystal violet, a polyamine plant growth promotor such as spermidine, Mg²⁺, Fe²⁺/Fe³⁺, Zn²⁺, or Ca²⁺, K⁺, Cu²⁺, Mn²⁺/Mn⁴⁺, Mo²⁺/Mo⁶⁺, or Ni²⁺.

Clause 34. The method of clause 33, wherein the second segment is poly(NIPAAm).

Clause 35. The method of clause 29 or 30, wherein the second segment comprises pendant thioether, boronic ester, or selenium-containing groups.

Clause 36 The method of clause 35, wherein the second segment comprises a plurality of 2-(Methylthio)ethyl acrylate residues.

Clause 37. The method of any one of clauses 31-36, for treating heat stress in the plant, wherein the cargo is an antimicrobial peptide, crystal violet, a polyamine plant growth promotor such as spermidine, Mg²⁺, Fe²⁺/Fe³⁺, Zn²⁺, or Ca²⁺, K⁺, Cu²⁺, Mn²⁺/Mn⁴⁺, Mo²⁺/Mo⁶⁺, or Ni²⁺.

Clause 38. The method of clause 37, wherein the cargo is an antimicrobial peptide, such as tetracycline or streptomycin.

Clause 39. The method of any one of clauses 29-38, wherein the particle has a diameter, optionally a hydrodynamic diameter, ranging from 3 nm to 6 nm.

Clause 40. The method of any one of clauses 29-38, wherein the particle has a diameter, optionally a hydrodynamic diameter, ranging from 35 nm to 50 nm.

Clause 41. The method of any one of clauses 29-40, wherein the first copolymer segment is acidic.

Clause 42. The method of any one of clauses 29-40, wherein the cargo is monoatomic.

Clause 43. The method of any one of clauses 29-40, wherein the cargo comprises Mg²⁺, Fe²⁺/Fe³⁺, Zn²⁺, or Ca²⁺, K⁺, Cu²⁺, Mn²⁺/Mn⁴⁺, Mo²⁺/Mo⁶⁺, or Ni²⁺.

Clause 44. The method of any one of clauses 29-41, wherein the cargo is a non-peptidyl compound.

Clause 45. The method of any one of clauses 29-41, wherein the cargo is crystal violet, a polyamine plant growth promoter such as spermidine, spermine, choline, streptomycin, and/or tetracycline.

Clause 46. The method of any one of clauses 29-41, wherein the cargo is an antimicrobial peptide.

Clause 47. The method of clause 46, wherein the cargo is streptomycin, tetracycline, a bacteriocin, a defensin, a peptaibol, an antimicrobial cyclopeptide (e.g., an amphisin, a corpeptin, a putisolvin, a syringomycin, a syringopeptin, a tolaasin, a viscosin, a gramicidin, a calophycin, a bacitracin, or a laxaphycin) or pseudopeptide, or an antimicrobial fragment of any of the preceding, or an antimicrobial synthetic peptide.

Clause 48. The method of any one of clauses 29-47, wherein the particle is a comb or bottlebrush polymer.

Clause 49. The method of any one of clauses 29-47, wherein the particle is a star polymer.

Clause 50. The method of any one of clauses 29-49, wherein the core is a polysaccharide residue.

Clause 51. The method of any one of clauses 29-50, wherein the core is cyclical.

Clause 52. The method of clause 51, wherein the core is a cyclodextrin residue, such as a p-cyclodextrin residue.

Clause 53. The method of any one of clauses 29-52, wherein the first segment comprises from 25 to 150 monomer residues.

Clause 54. The method of any one of clauses 29-53, wherein the first segment comprises acrylic acid, methacrylic acid, styrene sulfonic acid, or 2-acrylamido-2-methyl-1-propane sulfonic acid residues.

Clause 55. The method of clause 54, wherein the first segment is poly((meth)acrylic acid).

Clause 56. The method of any one of clauses 29-55, wherein the ratio of the number of monomer residues in the first segment to the number of monomer residues in the second segment ranges from 1:0.25 to 1:<9, or from 1:1 to 1:7.

Clause 57. The method of any one of clauses 29-56, wherein the second segment is thermoresponsive.

Clause 58. The method of clause 57, wherein the second segment imparts a lower critical solution temperature (LCST) between 25° C. to 40° C. to the pendant block copolymer chains.

Clause 59. The method of clause 58, wherein the second segment comprises a monomer selected from N-isopropyl acrylamide (NIPAAm), 2-(dimethylamino)ethyl methacrylate (DMAEMA), vinylcaprolactam, 2-hydroxyethyl methacrylate (HEMA diethylacrylamide, and/or poly(ethylene glycol) methyl ether methacrylate.

Clause 60. The method of clause 57, wherein the first segment is poly((meth)acrylic acid) and/or the second segment is poly(NIPAAm).

Clause 61. The method of any one of clauses 29-56, wherein the second segment oxidizes in the presence of a reactive oxygen species (ROS), becoming more soluble in an aqueous solution.

Clause 62. The method of clause 61, wherein the second segment comprises one or more pendant thioether, boronic ester, or selenium-containing groups, and optionally comprises one or more 2-(Methylthio)ethyl acrylate residues.

Clause 63. The method of any one of clauses 29-62, wherein the first and second segments are (meth)acrylic polymer segments.

Clause 64. The method of any one of clauses 29-63, further comprising a surfactant, such as a non-ionic detergent, e.g., 3-(2-methoxyethoxy)propyl-methyl-bis(trimethylsilyloxy)silane.

Clause 65. The method of any one of clauses 29-64, wherein the particle does not precipitate at pH 2.0 in an aqueous environment, such as water.

Clause 66. The method of any one of clauses 29-64 for treating heat stress in the plant.

Clause 67. The method of any one of clauses 29-66, wherein the plant is a tomato plant.

### BRIEF DESCRIPTION OF THE DRAWINGS

FIGS. 1A-1E. 1H NMR spectra of PtBA₅₀-b-PNIPAm₅₀ (FIG. 1A), PtBA₅₀-b-PNIPAm₁₅₀ (FIG. 1B), PtBA₅₀-b-PNIPAm₃₀₀ (FIG. 1C), PtBAS₅₀-b-PNIPAm₄₅₀ (FIG. 1D) star polymers and 21 Br β-CD macroinitiator (FIG. 1E) in CDCl₃. The peak integration ratio of g/e equals 9.6 for PtBA₅₀-b-PNIPAm₅₀ star polymer (FIG. 1A), g/e equals 3.05 for PtBA₅₀-b-PNIPAm₁₅₀ star polymer (FIG. 1B), g/e equals 1.59 for PtBA₅₀-b-PNIPAm₃₀₀ star polymer (FIG. 1C), and g/e equals 0.98 for PtBA₅₀-b-PNIPAm₄₅₀ star polymer (FIG. 1D), confirming the molar ratio S3 between PAA and PNIPAm block among the synthesized star polymers. For 21 Br β-CD macroinitiator, peak area ratio a/d=17.4, confirming total conversion of hydroxyl groups in β-CD into ATRP initiating sites.

FIG. 2. GPC-MALLS trace of (PtBA)ₙ-(β-CD) in chloroform for number average molecular weight (Mn) measurement. The dn/dc value for PtBA star polymers in chloroform was 0.02249±0.00038 mL/g. The 21 Br β-CD macroinitiator to tBA monomer ratio was 1:2100 in the reaction, with 50% monomer conversion to polymer, the theoretical number average molecular weight should be M_{n theory}=1.34×10⁵ while the measured value is Mₙ=1.22×10⁵ with Ð=1.15. According to previous studies, high initiation efficiency of BiBB and a nearly equal growth rate for each arm in the star polymer can be assumed for ATRP reactions, which gives 21 arms in each polymer molecule with 21 initiating sites at each macroinitiator and approximately 50 tBA repeating units in each arm.

FIG. 3. Size distribution of PAA₅₀-b-PNIPAm₅₀ (a), PAA₅₀-b-PNIPAm₁₅₀ (b), PAA₅₀-b-PNIPAm₃₀₀ (c) and PAA₅₀-b-PNIPAm₄₅₀(d) star polymers in water at pH 6.5 measured by dynamic light scattering (DLS).

FIG. 4. Temperature responsive behavior of PAA₅₀-b-PNIPAm₅₀ (a), PAA₅₀-b-PNIPAm₁₅₀ (b), PAA₅₀-b-PNIPAm₃₀₀ (c) and PAA₅₀-b-PNIPAm₄₅₀ (d) star polymers in water at pH 6.5 measured by total scattering intensity detected in the dynamic light scattering apparatus.

FIG. 5 shows schematically the loading of Crystal violet (CV) into a particle as described in Example 1, and release of the CV on application of heat to the particle.

FIGS. 6A and 6B provide graphs showing (FIG. 6A) Cumulative release rate of CV for PAA50-b-PNIPAm50 and (FIG. 6B) PAA50-b-PNIPAm450 star polymers after 24 h at 20 and 40° C. in 10 mM phosphate buffer adjusted to pH 4.5, 6.0 or 7.5. 40° C. left bar, 20° C. right bar for each pH value, as described in Example 1. Error bars represent standard deviations. ANOVA test followed by Fisher's LSD test for multiple comparisons, P≤0.05.

FIGS. 7A and 7B provide graphs showing (FIG. 7A) Full CV release profile of PAA₅₀-b-PNIPAm₅₀ and (FIG. 7B) PAA₅₀-b-PNIPAm₄₅₀ star polymers at pH 6.0 in 24 h, as described in Example 1. Error bars represent standard deviations. ANOVA test followed by Fisher's LSD test for multiple comparisons, P≤0.05.

FIG. 8. Changes in hydrodynamic diameter of PAA₅₀-b-PNIPAm₅₀ (a), PAA₅₀-b-PNIPAm₁₅₀ (b), PAA₅₀-b-PNIPAm₃₀₀ (c) and PAA₅₀-b-PNIPAm₄₅₀ (d) upon pH drop from 7.5 to 4.5 and temperature increase from 20° C. to 40° C. with 1 g L⁻¹ star polymer concentration.

FIG. 9. Uptake and transport of Gd loaded star polymers in tomato plants with 0.1 v/v % SILWET® L-77 for (a) PAA₅₀-b-PNIPAm₅₀ star polymers and (b) PAA₅₀-b-PNIPAm₄₅₀ star polymers at 1.0 g L⁻¹ exposure, and (c) PAA₅₀-b-PNIPAm₅₀ star polymers and (d) PAA₅₀-b-PNIPAm₅₀ star polymer at 200 mg L⁻¹ exposure expressed by both percentage and weight of Gd detected in each plant compartment. Error bars represent standard deviations. Three plants are used for each treatment as biological replicates. Statistical analysis was performed either between panel a and c or between panel b and d for each plant compartments. ANOVA test followed by Fisher's LSD test for multiple comparisons, P≤0.05. For each graph, up, down, stem, root, exposed, are presented left-to-right.

FIG. 10. Uptake and transport of Gd³⁺ loaded star polymers in tomato plants for PAA₅₀-b-PNIPAm₅₀ star polymer (a), Gd³⁺ ion control for PAA₅₀-b-PNIPAm₅₀ star polymer (b), PAA₅₀-b-PNIPAm₄₅₀ star polymer (c), Gd³⁺ ion control for PAA₅₀-b-PNIPAm₄₅₀ star polymer (d) shown by weight of Gd in each parts of tomato plants. For each surfactant group in each graph, up, down, stem, root, exposed, are presented left-to-right.

FIG. 11. CO₂ assimilation rate of tomato leaves 15 days after 1 g L⁻¹ Gd loaded star polymer or free Gd³⁺ ion exposure measured by Li-Cor 6800. The CO₂ assimilation rate of plant leaves could be used to quantify photosynthesis rate and plant health condition. ‘Gd SP exp’ and ‘Gd salt exp’ represents leaves exposed with Gd loaded star polymers or free Gd³⁺ ions. ‘Gd SP control’ and ‘Gd salt control’ represents the leaf next to the exposed leaves at the same growth stage at the same plant. The star polymer treatment did not decrease carbon respiration rate of tomato leaves showing the star polymer treatment did not affect plant health by inhibiting photosynthesis.

FIG. 12. Normalized light absorbance spectra of free CV in water, CV loaded PAA₅₀-b-PNIPAm₅₀ star polymer and CV loaded PAA₅₀-b-PNIPAm₄₅₀ star polymer acquired by UV-Vis.

FIG. 13. (a) Stacked averaged hyper-spectra of free CV and CV loaded PAA₅₀-b-PNIPAm₅₀ star polymers. (b) Stacked averaged hyper-spectra of free CV and CV loaded PAA₅₀-b-PNIPAm₄₅₀ star polymers. Both spectra are acquired by enhanced dark-field microscopy with hyperspectral imaging in tomato leaves at 20° C. without SILWET® L-77 before and after incubation for 16 h at either 20° C. or 40° C. Each spectrum is the average of over 40 individual spectra. Strategies for building the hyperspectral libraries are describes in the supporting information. Peak ratios in the averaged spectra of (c) PAA₅₀-b-PNIPAm₅₀ star polymers and (d) PAA₅₀-b-PNIPAm₄₅₀ star polymers with peak1 centered at 558 nm, peak2 at 605 nm and peak3 at 633 nm. Histogram bars represent the average of the peak ratios. Error bars represent the 95% confidence level. (ANOVA test followed by Fisher's LSD test for multiple comparisons, *P≤0.05). The legend for (c) and (d) represent bars in graphs from left to right for each Peak group, respectively (original in color).

FIG. 14. Measured and fitted spectra for PAA₅₀-b-PNIPAm₅₀ (a) and PAA₅₀-b-PNIPAm₄₅₀ star polymers (b), solid line is the sample spectra and the red markers are the fits. Sum of squared error (SSE) versus fraction of free CV spectra in fitted spectra for PAA₅₀-b-PNIPAm₅₀ (c) and PAA₅₀-b-PNIPAm₄₅₀ (d) star polymers at 40° C.

FIGS. 15A-E. ¹H NMR spectra of (a) MTEA, (b) MSEA, (c) PtBA₂₅-b-PMSEA₁₂₅, (d) PtBA₂₅-b-P(MSEA₁₀₀-co-MTEA₂₅), (e) PtBA₂₅-b-P(MSEA₇₅-co-MTEA₅₀), (f) PtBA₁₂₅-b-PMSEA₂₅, (g) PtBA₇₅-b-PMSEA₇₅, (h) PtBA₂₅-b-PMSEA₂₅ and (i) PtBA₁₅₀-b-PMSEA₁₅₀ star polymers in CDCl₃.

FIG. 16. (a) Different physical and chemical properties of star polymers investigated in this study. Size is adjusted by changing total DP of each arm, charge content is adjusted by varying the PAA (negatively charged) to PMSEA (neutral) molar ratio, and star polymer hydrophobicity is adjusted by copolymerizing hydrophilic MSEA with hydrophobic MTEA in the outer block of star polymer arms. (b) Number average diameter distribution of PAA-b-PMSEA and PAA-b-P(MSEA-co-MTEA) star polymers. Hydrodynamic diameters were determined in water at 100 mg L⁻¹ star polymer concentration at pH 6.5 (10 mM NaCl) by dynamic light scattering (Malvern zetasizer nano zs). The electrophoretic mobility was measured in the same solutions (pH=6.5, 10 mM NaCl) using the Malvern zetasizer nano zs. Apparent zeta potentials (ζ) were calculated from the mobility via the Smoluchowski model. (c) Schematic illustration of the chemical composition of PAA-b-P(MSEA-co-MTEA) star polymer arms and chemical properties of different repeating units. (d) Optical density at 541 nm vs pH for PAA₂₅-b-PMSEA₁₂₅, PAA₂₅-b-P(MSEA₁₀₀-co-MTEA₂₅) and PAA₂₅-b-P(MSEA₇₅-co-MTEA₅₀) star polymers. Increased optical density indicates star polymer aggregation driven by hydrophobicity.

FIG. 17. GPC traces of PtBA star polymers with ((a)-(d), respectively) DP=25, 75, 125 and 150 in each arm in THE for number average molecular weight (Mₙ) measurement. Note that the Mₙ measured by the refractive index detector is not accurate for star polymers.

FIG. 18. Number average hydrodynamic diameter of PAA-b-PMSEA and PAA-b-P(MSEA-co-MTEA) star polymers. Error bars represent standard deviations for 3 replicates. ANOVA test followed by Fisher's LSD test for multiple comparisons, P≤0.05.

FIG. 19. Uptake and transport of foliarly applied Gd loaded star polymers in tomato plants with 0.1 v/v % SILWET® L-77 surfactant for (a) PAA₁₅₀-b-PMSEA₁₅₀ star polymers, (b) PAA₇₅-b-PMSEA₇₅ star polymers, (c) PAA₂₅b-PMSEA₂₅ star polymers, (d) PAA₂₅b-PMSEA₁₂₅ star polymers, (e) PAA₂₅-b-P(MSEA₁₀₀-co-MTEA₂₅) star polymers, (f) PAA₂₅-b-P(MSEA₂₅-co-MTEA₅₀) star polymers and (g) PAA₁₂₅-b-PMSEA₂₅ star polymers at 1.0 g L⁻¹ exposure, expressed by both percentage and weight of Gd detected in each plant compartment. Five to six plants were used for each treatment. Error bars represent standard deviations.

FIG. 20. Fraction of transported (phloem loaded) star polymers from exposed leaves to different organs of tomato plants. (a) PAA₂₅-b-PMSEA₂₅, PAA₇₅-b-PMSEA₇₅ and PAA₁₅₀-b-PMSEA₁₅₀ star polymers with different hydrodynamic sizes. (b) PAA₁₂₅-b-PMSEA₂₅, PAA₇₅-b-PMSEA₇₅ and PAA₂₅-b-PMSEA₁₂₅ star polymers with different charge content and (c) PAA₂₅-b-PMSEA₁₂₅, PAA₂₅-b-P(MSEA₁₀₀-co-MTEA₂₅) and PAA₂₅-b-P(MSEA₇₅-co-MTEA₅₀) star polymers with different hydrophobicity. Error bars represent standard deviations for 5-6 replicates. ANOVA test followed by Fisher's LSD test for multiple comparisons, P≤0.05.

FIG. 21. Fraction of applied star polymers transported out of the exposed leaf.

FIGS. 22A and 22B. Characterization of star polymers. (FIG. 22A) Hydrodynamic diameter of RSP, Mg loaded RSP and CSP in water at pH 6.5. (FIG. 22B) Apparent zeta potential of RSP, Mg loaded RSP and CSP in 10 mM NaCl water solution at pH 6.5. Apparent zeta potential was calculated from electrophoretic mobility using the Smoluchowski approximation. Error bars represent standard deviation (n=3). ANOVA testing followed by Fisher's LSD testing was used for multiple comparisons, P≤0.05.

FIGS. 23A-23D. ROS scavenging and responsive agent release of RSP. (FIG. 23A) Mg release profile of Mg loaded RSP with (red)/without(blue) the addition of 50 mM H₂O₂ at pH 4.5 and 7.5 over 24 h. (FIG. 23B) Conversion of PMTEA in RSP into PMSEA through reaction with H₂O₂ monitored by ¹H NMR. (FIG. 23C) DCFH-DA fluorescence as function of H₂O₂ concentration with and without the presence of RSP and CSP. (FIG. 23D) Changes in DCF fluorescence intensity (Iₜ) relative to initial Intensity (Iₒ) indicate ROS scavenging by RSP but not CSP star polymers in leaf mesophyll cells compared to no star polymer controls. Error bars represent standard deviation (n=5). ANOVA test followed by Fisher's LSD test was used for multiple comparisons, P≤0.05.

FIG. 24. Illustration of the reaction mechanism between PMTEA (thioether) in star polymers and common ROS species, including hydrogen peroxide, superoxide and hydroxyl radical.

FIG. 25. (a) Carbon response curve (b) light response curve, (c) photosystem II quantum yield of regular tomato plants 24 h after treatments with Mg loaded RSP, RSP, CSP, Mg²⁺ and MilliQ water and before stress. (d) Carbon response curve (e) light response curve, (f) photosystem II quantum yield of regular tomato plants 24 h after treatments with 0, 50, 250, 500 or 1000 mg L⁻¹ RSP and before stress. Error bars represent standard deviation. ANOVA test followed by Fisher's LSD test for multiple comparisons (n=4-7), P≤0.05.

FIG. 26. RSP and Mg loaded RSP enhance photosynthesis of tomato plants under combination of heat (40° C.) and light (2000 μmol m⁻² s⁻¹ PAR) stress for 1.5 h. (a) Carbon response (A-Ci) curve (b) maximum carboxylation rate V_{Cmax}, (c) light response (A-PAR) curve and (d) photosystem II quantum yield of tomato plants treated with either Mg loaded RSP, RSP, CSP, Mg²⁺ or MilliQ water applied with 0.1 vol % Silwet L-77. (e) Carbon response (A-Ci) curve (f) maximum carboxylation rate V_{Cmax}, (g) light response (A-PAR) curve and (h) photosystem II quantum yield (PhiPSII) of tomato plants treated with either 0, 50, 250, 500 or 1000 mg L⁻¹ RSP. Error bars represent standard deviation. ANOVA test followed by Fisher's LSD test was used for multiple comparisons (n=4-7), P≤0.05.

FIG. 27. (a) Quantum yield of CO₂ assimilation of tomato plants treated with either Mg loaded RSP, RSP, CSP, Mg²⁺ or MilliQ water applied with 0.1 vol % SILWET® L-77. (b) quantum yield of CO₂ assimilation of tomato plants treated with either 0, 50, 250, 500 or 1000 mg L⁻¹ RSP. Error bars represent standard deviation. ANOVA test followed by Fisher's LSD test was used for multiple comparisons (n=4-7), P≤0.05.

FIG. 28. Plant photosynthetic activities of Mg deficient tomato plants before treatments and stress. (a) Carbon response curve (b) light response curve, (c) photosystem II quantum yield. (d) photosystem II quantum yield of Mg loaded RSP, RSP and Mg²⁺ treated plants before heat and light stress. (e) photosystem II quantum yield of Mg loaded RSP, RSP and Mg²⁺ treated plants after heat and light stress. Error bars represent standard deviation. ANOVA test followed by Fisher's LSD test for multiple comparisons (n=4-6), P≤0.05.

FIG. 29. RSP partly alleviates plant Mg deficiency. (a) Carbon response (A-Ci) curve, (b) Rubisco carboxylation rate V_{Cmax}, (c) light response curve (A-PAR) and (d) quantum yield of CO₂ assimilation of Mg deficient plants 3 days after treatments with Mg loaded RSP, RSP, Mg²⁺ and MilliQ water. (e) Carbon response (A-Ci) curve (f) light response curve (A-PAR) of treated Mg deficient plants after combination of heat (40° C.) and excess light (2000 μmol m⁻² s⁻¹ PAR) stress for 1.5 h. Error bars represent standard deviation (n=4-6). ANOVA test followed by Fisher's LSD test was used for multiple comparisons (n=4-6), P≤0.05.

### DETAILED DESCRIPTION

Other than in the operating examples, or where otherwise indicated, the use of numerical values in the various ranges specified in this application are stated as approximations as though the minimum and maximum values within the stated ranges are both preceded by the word “about”. In this manner, slight variations above and below the stated ranges can be used to achieve substantially the same results as values within the ranges. Also, unless indicated otherwise, the disclosure of ranges is intended as a continuous range including every value between the minimum and maximum values. Further, as used herein, all numbers expressing dimensions, physical characteristics, processing parameters, quantities of ingredients, reaction conditions, and the like, used in the specification and claims are to be understood as being modified in all instances by the term “about”. Moreover, unless otherwise specified, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like.

As used herein “a” and “an” refer to one or more. The term “comprising” is open-ended and may be synonymous with “including”, “containing”, or “characterized by”. The term “consisting essentially of” limits the scope of a claim to the specified materials or steps and those that do not materially affect the basic and novel characteristic(s) of the claimed invention.

As used herein, spatial or directional terms, such as “left”, “right”, “inner”, “outer”, “above”, “below”, “over”, “under”, and the like, relate to the invention as it is shown in the drawing FIGS. are provided solely for ease of description and illustration, and do not imply directionality, unless specifically required for operation of the described aspect of the invention. It is to be understood that the invention can assume various alternative orientations and, accordingly, such terms are not to be considered as limiting.

As used herein, the terms “treating”, or “treatment” refer to a beneficial or desired result, such as improving one of more functions, or symptoms of a disease.

“Therapeutically effective amount,” as used herein, is intended to include the amount of a therapeutic agent as described herein that, when administered to a plant having a disease, is sufficient to effect treatment of the disease (e.g., by diminishing, ameliorating or maintaining the existing disease or one or more symptoms of disease). The “therapeutically effective amount” may vary depending on compound or composition, how it is administered, the disease and its severity in the target organism. A “therapeutically-effective amount” also includes an amount of an agent that produces some desired local or systemic effect at a reasonable benefit/risk ratio applicable to any treatment. Compounds and compositions described herein may be administered in a sufficient amount to produce a reasonable benefit/risk ratio applicable to such treatment.

A “moiety” (pl. “moieties”) is a part of a chemical compound, and includes groups, such as functional groups but can include any portion of a compound. As such, a nucleobase moiety is a nucleobase that is modified by attachment to another compound moiety, such as a polymer monomer, e.g., the nucleic acid or nucleic acid analog monomers described herein, or a polymer, such as a nucleic acid or nucleic acid analog as described herein.

“Alkyl” refers to straight, branched chain, or cyclic hydrocarbon groups including from 1 to about 20 carbon atoms, for example and without limitation C₁₋₃, C₁₋₆, C₁₋₁₀ groups, for example and without limitation, straight, branched chain alkyl groups such as methyl, ethyl, propyl, butyl, pentyl, hexyl, heptyl, octyl, nonyl, decyl, undecyl, dodecyl, and the like. “Substituted alkyl” refers to alkyl substituted at 1 or more, e.g., 1, 2, 3, 4, 5, or even 6 positions, which substituents are attached at any available atom to produce a stable compound, with substitution as described herein. “Optionally substituted alkyl” refers to alkyl or substituted alkyl. “Halogen,” “halide,” and “halo” refers to F, Cl, Br, and/or I. “Alkylene” and “substituted alkylene” refer to divalent alkyl and divalent substituted alkyl, respectively, including, without limitation, ethylene (—CH₂—CH₂—). “Optionally substituted alkylene” refers to alkylene or substituted alkylene.

“Alkene or alkenyl” refers to straight, branched chain, or cyclic hydrocarbyl groups including, e.g., from 2 to about 20 carbon atoms, such as, without limitation C₁₋₃, C₁₋₆, C₁₋₁₀ groups having one or more, e.g., 1, 2, 3, 4, or 5, carbon-to-carbon double bonds. “Substituted alkene” refers to alkene substituted at 1 or more, e.g., 1, 2, 3, 4, or 5 positions, which substituents are attached at any available atom to produce a stable compound, with substitution as described herein. “Optionally substituted alkene” refers to alkene or substituted alkene. Likewise, “alkenylene” refers to divalent alkene. Examples of alkenylene include without limitation, ethenylene (—CH═CH—) and all stereoisomeric and conformational isomeric forms thereof. “Substituted alkenylene” refers to divalent substituted alkene. “Optionally substituted alkenylene” refers to alkenylene or substituted alkenylene.

A “polymer composition” is a composition comprising one or more polymers. As a class, “polymers” includes, without limitation, homopolymers, heteropolymers, co-polymers, block polymers, block co-polymers and can be both natural and/or synthetic. Homopolymers contain one type of building block, or monomer, whereas copolymers contain more than one type of monomer. The term “(co)polymer” and like terms refer to either homopolymers or copolymers. A polymer may have any shape for the chain making up the backbone of the polymer, including, without limitation: linear, branched, networked, star, bottlebrush, comb, or dendritic shapes.

Cyclodextrins are a family of cyclic oligosaccharides, consisting of a macrocyclic ring of glucose subunits joined by α-1,4 glycosidic bonds. A polysaccharide is a compound comprising two or more saccharide residues, and includes oligosaccharides, such as cyclodextrins.

A polymer “comprises” or is “derived from” a stated monomer if that monomer is incorporated into the polymer. Thus, the incorporated monomer (monomer residue) that the polymer comprises is not the same as the monomer prior to incorporation into a polymer, in that at the very least, certain groups/moieties are missing and/or modified when incorporated into the polymer backbone. A polymer is said to comprise a specific type of linkage if that linkage is present in the polymer, such as, without limitation: ester, amide, carbonyl, ether, thioester, thioether, disulfide, sulfonyl, amine, carbonyl, or carbamate bonds. The polymer may be a homopolymer, a copolymer, and/or a polymeric blend.

A polymer may be prepared from and therefore may comprise, without limitation, one or more of the following ethylenically-unsaturated monomer residues: vinyl, styryl, or acrylate monomers. Non-limiting examples of such acrylate monomers include: (meth)acrylic acid (where the (meth) prefix collectively referring to both acrylic acid forms and methacrylic acid forms), laurel acrylate, PEG acrylates, such as methoxy-capped oligo(ethylene oxide) (meth)acrylate, such as methoxy-capped (ethylene oxide)_{8,9} (meth)acrylate, zwitterionic (meth)acrylates, such as betaine moiety-containing (meth)acrylates, DMSO-like (meth)acrylates, such as 2-(methylsulfinyl)C₁₋₆ alkyl acrylate, e.g., 2-(methylsulfinyl)ethyl acrylate fatty acid (meth)acrylates, such as lauryl acrylate or octadecyl methacrylate, dimethylaminoethyl methacrylate, 2-hydroxy C₁₋₆ alkyl (e.g., 2-hydroxyethyl) (meth)acrylates, 3-azidopropyl methacrylate, glycidyl (meth)acrylates, t-butyl acrylates, methyl methacrylate, n-butyl methacrylate, styrene, acrylonitrile, (meth)acrylamides, 4-vinyl pyridine, or dimethyl(1-ethoxycarbonyl)vinyl phosphate among others.

A “saturated carbon backbone” for a polymer refers to a polymer or polymer, polymer block, or polymer segment having an uninterrupted carbon-only backbone, such as are present in polyvinyl polymers or polymer segments. Polymers having saturated carbon backbones may be prepared using one or more ethylenically unsaturated monomers. A saturated carbon backbone may include linear, branched, or cyclic alkane segments. A segment of a polymer composition is a portion of a polymer comprising one or more monomer residues. A block of a block copolymer may be considered to be a segment. Polymer compositions with saturated carbon backbones may be prepared in any suitable manner, and may be formed by radical polymerization, by anionic polymerization, or by other methods as are broadly known.

Monomers useful in preparing polymers described herein, for example by radical polymerization methods such as controlled radical polymerization, ATRP, Reversible Addition-Fragmentation chain Transfer (RAFT) polymerization, Activators ReGenerated by Electron Transfer (ARGET) ATRP, Initiators for Continuous Activator Regeneration (ICAR) ATRP, supplemental activator and reducing agent atom transfer radical polymerization (SARA) ATRP, electrochemically-controlled ATRP (e-ATRP), and photoinduced ATRP, may comprise ethylenic unsaturation, as are broadly-known. Illustrative of such ethylenically unsaturated monomers include the alkenes, such as ethylenes, e.g., propene, butene, octene, or decene, though typically the alkenes have a terminal carbon-carbon unsaturation, such as propene; aryl alkenes, such as styrene or α-methylstyrene; vinyl esters such, as vinyl acetate, vinyl propionate; acrylic monomers, such as acrylic acid, methyl methacrylate, methylacrylate, 2-ethyl-hexyl-acrylate, acrylamide, or acrylonitrile; divinyl phenyls, such as divinyl benzene; vinyl naphthyls; alkadienes, such as 1,3-butadiene; isoprene, chloroprene, and the like; vinyl halides, such as vinyl chloride or vinyl fluoride; vinylidene halides, such as vinylidene bromide, vinylidene fluoride, or vinylidene chloride.

In general, the monomers used to prepare the pendent block copolymer strands of the particles as described herein are (meth)acrylates, (meth) acrylamides, and styrenics. The monomers are functionalized with functional groups or moieties to impart a desired functionality to the block. For the first (inner) block for complexing the cargo, the functionality may be acidic, zwitterionic, or basic. For the second block, the functionality imparts a specific environment-sensitivity to the polymer chain and thus the particle. Acidic functional groups include, without limitation carboxylic or sulfonic moieties, though the weaker carboxylic moieties may be favored. Basic functional groups may comprise, without limitation, amine moieties, including quaternary amine moieties, such as dialkyamino moieties or a primary, secondary, tertiary, or quaternary amine moiety. Zwitterionic functionality may be imparted using suitable groups, such as phosphoryl choline, caboxybetaine and sulfobetaine, e.g.: [2-(Methacryloyloxy)ethyl]dimethyl-(3-sulfopropyl)ammonium hydroxide. For temperature-sensitivity, a monomer can impart an LCST, or UCST to the pendant copolymer chain. Such monomers are broadly-known in the polymer chemistry arts, and include, without limitation, N-isopropyl acrylamide, 2-(dimethylamino)ethyl methacrylate (DMAEMA), vinylcaprolactam, 2-hydroxyethyl methacrylate (HEMA), diethylacrylamide, and/or poly(ethylene glycol) methyl ether methacrylate (e.g., oligo(ethylene glycol)methyl ether methacrylate. pH-sensitive monomers, include acidic or basic monomers with suitable pKa's or pKb's, and/or hydrolyze at certain pH extremes to alter the solubility, swellability, or charge of the polymer strands, or otherwise disrupt the physical configuration or chemistry of the particle to cause the cargo to release. ROS-sensitivity can be imparted by use of suitable ROS-sensitive moieties in the polymer strands, such that ROS alter the solubility, swellability, or charge of the polymer strands, or otherwise disrupt the physical configuration or chemistry of the particle to cause the cargo to release. Non-limiting examples of ROS-sensitive moieties include: thioether, boronic esters, and selenium-containing moieties.

An acrylic polymer is a polymer comprising polymerized acrylate monomers (acrylates, or acrylate residues as integrated into the polymer). Acrylates are prop-2-enoates, and also may be referred to as acrylic acid derivatives or α,β unsaturated carbonyl compounds. Acrylates may be substituted in a variety of ways, such as by adding a methyl group to the α carbon, or by adding a functional group to the carbon of the carbonyl group, for example such as by including an amine or a substituted amine moiety to form an acrylamide, by including a PEG moiety to form poly(ethylene glycol) acrylate, by including a zwitterionic moiety, such as a carboxybetaine moiety, to form zwitterionic acrylate, such as a carboxybetaine acrylate, or by including a methylsulfinylalkyl moiety to form a methylsulfinylalkyl acrylate having dimethyl sulfoxide-like properties.

A “cargo” is a compound or atom, such as an ion, that is carried by a particle as described herein. The cargo may be cationic so it associates with acidic (co)polymer blocks of the particles. That is, the cationic cargo is associated with, adsorbed to, or complexed with the acidic moieties of the first block. The cationic cargo may be a monoatomic ionic, as with Mg²⁺, Fe²⁺/Fe³⁺, Zn²⁺, or Ca²⁺, K⁺, Cu²⁺, Mn²⁺/Mn⁴⁺, Mo²⁺/Mo⁶⁺, or Ni²⁺. The cationic cargo may be a therapeutic agent, such as an antimicrobial compound or peptide, e.g., crystal violet, streptomycin, or tetracycline. The cationic cargo may be a co-factor, vitamin, or nutrient, such as, without limitation: a polyamine growth promotor such as spermidine, spermine, or choline. In one example the cationic cargo is an antimicrobial peptide. Non-limiting examples of suitable antimicrobial peptides include: bacteriocins, defensins, peptaibols, antimicrobial cyclopeptides (e.g., amphisins, corpeptins, putisolvins, syringomycins, syringopeptins, tolaasins, viscosins, gramicidins, calophycin, bacitracins, or laxaphycin, among many others) or pseudopeptides, antimicrobial fragments of any of the preceding, and antimicrobial synthetic peptides (See, e.g., Montesinos E., Antimicrobial peptides and plant disease control. FEMS Microbiol Lett. 2007 May; 270(1):1-11, providing a substantial, but non-exhaustive list of useful antimicrobial peptides or pseudopeptides). For heat-stress, Mg²⁺, spermine, or spermidine can be administered as a cargo of the particles as described herein.

The cargo may be anionic, for example when the first block is basic. Suitable anionic cargoes include, without limitation, nucleic acid reagents, including RNA interference reagents, antisense reagents, genetic constructs, aptamers, and anionic nutrients and therapeutics. A nucleic acid may be a nucleic acid analog, such as an RNA or DNA analog or comprising a modified base or backbone.

The polymer or polymers, or segments or blocks thereof, may have a number-average molecular weight (Mₙ) between approximately 1 kDa and 60 kDa or between approximately 1 kDa and 50 kDa. The polymer(s) may have a polydispersity index (PDI) (or dispersity (D)) between 1 and 2, between 1 and 1.5 or between 1 and 1.2, where PDI=M_{w}/Mₙ, where M_{w} is the weight average molecular weight and Mₙ is the number average molecular weight. Of note, PDI for a polymer may increase as the length of the polymer increases. That said, controlled radical polymerization methods, e.g., ATRP, yield low PDI values, in the range of 2.0 or less. Unless specified otherwise, the molecular weight of a polymer, or a polymer block or segment, is expressed as a number average molecular weight (Mₙ).

In a number of embodiments, the polymer(s) is/are formed via controlled radical polymerization (CRP). The polymer(s) may, for example, be formed via atom transfer radical polymerization or activators generated by electron transfer atom transfer radical polymerization, such as by Activators ReGenerated by Electron Transfer (ARGET) ATRP, Initiators for Continuous Activator Regeneration (ICAR) ATRP, supplemental activator and reducing agent atom transfer radical polymerization (SARA) ATRP, electrochemically-controlled ATRP (e-ATRP), or photoinduced ATRP.

In further detail, polymers suitable for use herein may, for example, be prepared via anionic polymerization, cationic polymerization, condensation polymerization, free radical polymerization, or CRP. Controlled radical polymerization processes have been described by a number of workers (see, for example, Baker, S. L.; Kaupbayeva, B.; Lathwal, S.; Das, S. R.; Russell, A. J.; Matyjaszewski, K., “Atom Transfer Radical Polymerization for Biorelated Hybrid Materials”, Biomacromolecules, 2019, 20 (12):4272-4298 and Matyjaszewski, K., “Advanced Materials by Atom Transfer Radical Polymerization”, Advanced Materials, 2018, 30(23):1706441, among many other publications). The use of a CRP for the preparation of an oligo/polymeric material allows control over the molecular weight, molecular weight distribution of the (co)polymer, topology, composition and functionality of a polymeric material. The topology can be controlled, allowing the preparation of linear, star, graft or brush copolymers, formation of networks or dendritic or hyperbranched materials. Composition can be controlled to allow preparation of homopolymers, periodic copolymers, block copolymers, random copolymers, statistical copolymers, gradient copolymers, and graft copolymers. In a gradient copolymer, the gradient of compositional change of one or more comonomers units along a polymer segment can be controlled by controlling the instantaneous concentration of the monomer units in the copolymerization medium, for example. Molecular weight control is provided by a process having a substantially linear growth in molecular weight of the polymer with monomer conversion accompanied by essentially linear semilogarithmic kinetic plots for chain growth, in spite of any occurring terminations. Polymers from controlled polymerization processes typically have molecular weight distributions, characterized by the polydispersity index of less than or equal to 2. Polymers produced by controlled polymerization processes may also have a PDI of less than 1.5, less than 1.3, or even less than 1.2.

In CRP, further functionality may be readily placed on the oligo/polymer structure including side-functional groups, end-functional groups or can comprise site specific functional groups, or multifunctional groups distributed as desired within the structure. The functionality can be dispersed functionality or can comprise functional segments. The composition of the polymer may comprise a wide range of radically (co)polymerizable monomers, thereby allowing the properties of the polymer to be tailored to the application. Materials prepared by other processes can be incorporated into the final structure.

In general, polymerization processes performed under controlled polymerization conditions achieve the above-described properties by consuming the initiator early in the polymerization process and, in at least one embodiment of controlled polymerization, an exchange between an active growing chain and dormant polymer chain that is equivalent to or faster than the propagation of the polymer. In general, CRP process is a process performed under controlled polymerization conditions with a chain growth process by a radical mechanism, such as, but not limited to; atom transfer radical polymerization (ATRP), stable free radical polymerization (SFRP), specifically, nitroxide mediated polymerization (NMP), reversible addition-fragmentation transfer (RAFT), degenerative transfer (DT), and catalytic chain transfer (CCT) radical systems. A feature of controlled radical polymerizations is the existence of equilibrium between active and dormant species. The exchange between the active and dormant species provides a slow chain growth relative to conventional radical polymerization, all polymer chains grow at the same rate, although overall rate of conversion can be comparable since often many more chains are growing. Typically, the concentration of radicals is maintained low enough to minimize termination reactions. This exchange, under appropriate conditions, also allows the quantitative initiation early in the process necessary for synthesizing polymers with special architecture and functionality. CRP processes may not eliminate the chain-breaking reactions; however, the fraction of chain-breaking reactions is significantly reduced from conventional polymerization processes and may comprise only 1-10% of all chains.

ATRP is one of the most robust CRP and a large number of monomers can be polymerized providing compositionally homogeneous well-defined polymers having predictable molecular weights, narrow polydispersity, and high degree of end-functionalization. Matyjaszewski and coworkers disclosed ATRP, and a number of improvements in the basic ATRP process, in a number of patents and patent applications. See, for example, U.S. Pat. Nos. 5,763,546; 5,807,937; 5,789,487; 5,945,491; 6,111,022; 6,121,371; 6,124,411; 6,162,882; 6,624,262; 6,407,187; 6,512,060; 6,627,314; 6,790,919; 7,019,082; 7,049,373; 7,064,166; 7,157,530 and U.S. patent application Ser. No. 09/534,827; PCT/US04/09905; PCT/US05/007264; PCT/US05/007265; PCT/US06/33152 and PCT/US2006/048656, the disclosures of which are herein incorporated by reference.

The ATRP process can be described generally as comprising: polymerizing one or more radically polymerizable monomers in the presence of an initiating system; forming a polymer; and isolating the formed polymer. The initiating system comprises: an initiator having a radically transferable atom or group; a transition metal compound, i.e., a catalyst, which participates in a reversible redox cycle with the initiator; and a ligand, which coordinates with the transition metal compound. The ATRP process is described in further detail in international patent publication WO 97/18247 and U.S. Pat. Nos. 5,763,548 and 5,789,487.

An ATRP initiator may be any initiator suitable for initiating an ATRP polymerization reaction in the context of the methods described herein. A suitable ATRP initiator may be a group comprising an alkyl halide, such as an alkyl bromide or alkyl chloride, such as an α-bromoisobutyrate (iBBr) group, for photoinitiation. Other suitable initiators, such as α-functionalized ATRP initiators, are broadly-known, and initiators can be selected or designed to best balance polymer structure and polymerization kinetics.

A “functional group” or a “reactive group” is a reactive chemical moiety that can be used to covalently link a chemical compound to another chemical compound and/or to impart a physical property to a polymer. Examples of functional groups include, without limitation: hydroxyl, carbonyl, carboxyl, methoxycarbonyl, sulfonyl, thiol, amine, or sulfonamide. In the context of the present disclosure, the functional groups may impart acidity to a block of a polymer, a desired LCST to a polymer chain, an overall charge to a block of a polymer, hydrophobicity or hydrophilicity to a block of a polymer, or a desired solubilization pH to a block of a polymer.

In the context of the present disclosure, a particle is provided that is useful for delivery of a cationic therapeutic or prophylactic agent or nutrient to a vascularized plant, including monocots and dicots. The particle may be formed from a star polymer, a comb polymer, a bottlebrush polymer, or a dendritic polymer having a core a first, inner acidic layer, and a second layer. The particle may comprise the cationic therapeutic or prophylactic agent or nutrient located in, and optionally complexed with polymer strands of the acidic layer. The acidic layer and the second layer are each formed from or comprise two or more, and more typically ten or more block copolymer strands extending from the core, each strand comprising a first, acidic block, closer to the core of the particle than the second layer, and a second block farther from the core than the first block. The first block comprises acidic monomer residues that impart acidity to the block. The second block comprises a functional group that imparts environmental sensitivity to the particle. In one example the particle can exist in two physical states, an expanded state at a first environmental condition, in which the second block and/or the polymer strands are soluble in an aqueous solvent, and an active agent is retained within the acidic layer, and a collapsed state at a second environmental condition, in which the second block and/or the polymer strands are insoluble in an aqueous solvent, and an active agent is released by the particle on transition from the first environmental condition to the second environmental condition.

In one example, the environmental condition is temperature, and the second layer imparts an lower critical solution temperature (LCST) to the particle, such that the polymer chains of the particle become immiscible in their aqueous environment over the LCST. The LCST may preferably range from 25° C. to 40° C. such that the particle transitions from an expanded state below the LCST, and collapses, releasing the therapeutic and/or nutritional contents retained within the acidic layer when the temperature is raised to or above the LCST. This is particularly useful to deliver thermoprotective agents, such as antimicrobial or nutritional agents, to a plant. The particle comprising the therapeutic and/or nutritional agent may be administered to a plant at a temperature below the LCST, and the particle will travel to tissues of the plant, depending on physical qualities of the particle. So long as the plant temperature is below the LCST, the therapeutic agent and/or nutrition agent is retained substantially within the particle. Once the plant temperature is raised to near or above the LCST of the polymer chains, the particles will release the therapeutic agent and/or nutrition agent, thereby treating the plant and/or preventing infection or other undesirable consequences of heat stress in the plant.

In one example, the environmental condition is pH, and the second layer imparts pH-sensitivity to the particle, such that the polymer chains of the particle become immiscible in their aqueous environment at a target pH. The target pH may preferably range from 25° C. to 40° C. such that the particle transitions from an expanded state at or near neutral pH (pH 7.0±0.5), and collapses, releasing the therapeutic and/or nutritional contents retained within the acidic layer when the pH is more acidic or alkaline, as may be present in diseased tissue, for example, when the pH of the tissue is less than 6.5. This is particularly useful to deliver therapeutic agents, such as antimicrobial or nutritional agents, to a plant. The particle comprising the therapeutic and/or nutritional agent may be administered to a plant, and the particle will travel to tissues of the plant, depending on physical qualities of the particle. Once the local pH in the plant is changed, e.g., lowered, as with diseased tissue, below the pH in which the polymer strands of the particle become immiscible, the particles will release the therapeutic agent and/or nutrition agent, thereby treating the plant and/or preventing infection in the plant.

A non-ionic detergent is a detergent comprising a non-ionic head group. Non-ionic detergents, such as SILWET® L-77, may be used to facilitate transfer of compounds into plants. Other anionic, cationic, and amphoteric surfactants are commonly used in agriculture. The surfactants may be used with spreaders and wetting agents that lower the surface tension of water. They may be used with alkyl polyglucosides and biosurfactants like coconut oils, palm oils, etc.

Association of one molecule with another may be covalent or non-covalent. By attaching or linking one moiety to another, it is meant the linkage is covalent, as in, for example, polymerization, cross-linking, click chemistry reactions, or linking reactions using linkers. Complexing two molecules refers to a non-covalent association, such as by Van der Waals forces, hydrogen bonding, pi stacking, or ionic interactions. Hybridization of two complementary oligonucleotides, nucleic acids, and/or nucleic acid analogs, is a form of complexing, as used herein.

The diameter of a particle as described herein may be determined or characterized in any useful way. In one example, the diameter of the particle is the “hydrodynamic diameter”, which is “the diameter of a hypothetical hard sphere that diffuses with the same speed as the particle being measured. In practice, particles are solvated and can be spherical, spherical-like or non-spherical, while moving dynamically in solution. The determined diameter is therefore an indicator of the apparent size of the solvated particle that is approximated as being spherical” (Maguire, Ciardn Manus et al., “Characterisation of particles in solution—a perspective on light scattering and comparative technologies.” Science and technology of advanced materials vol. 19,1 732-745. 18 Oct. 2018). Examples of methods of determining hydrodynamic diameter include dynamic light scattering (DLS) and particle or nanoparticle tracking analysis (PTA or NTA) (Id.).

As demonstrated in Example 2, below, the diameter of the particles affects delivery of the particle to various plant compartments (portions of the plant, for example and without limitation, leaves, branches, stems, and roots). Particles in the range of from 35 nm to 50 nm will mainly migrate to the root. Particles in the range of from 3 nm to 6 nm will mainly migrate to the younger leaves. Also, hydrophobicity/hydrophilicity of the particles will dictate where the particles will travel in the plant. Hydrophobicity/hydrophilicity can be measured by monitoring solution optical density as a function of pH. The more hydrophobic the particle, for example and without limitation the polymer starts to precipitate at pH below 4.0, the more likely the particle will be retained in the leaf cuticle, while the more hydrophilic the particle, e.g., the particle does not precipitate at a pH below 2.0, the more likely the particle will be transported into the plant. As such, particle size and/or hydrophobicity/hydrophilicity can be tailored to target the particles to different plant tissue.

An organic compound, moiety, or group, such as the core moiety of a particle as described herein, refers to a compound that comprises carbon-hydrogen bonds, and/or carbon-carbon bonds. The organic compounds forming the core moiety of the star polymer particles as described herein may be an atom, but due to the need for a significant number of polymer chains extending from the core to form a suitably-dense field of polymer chains for retention of cationic compounds, to be released on collapse of the polymer chains, the core organic moiety typically is macromolecular, such as a branched, cyclic, or polycyclic molecule from which the polymer chains extend. In the “core-first” methods of making the particles as described herein, the core may be a residue of an initiator for a CRP method, such as an ATRP method. The core may comprise one or more cyclical alkane moieties, or, as shown below, a cyclical polysaccharide residue, such as a cyclodextrin (e.g., p-cyclodextrin) residue. For a comb polymer structure the core is linear or branched organic compound, such as an alkane or a polysaccharide residue. It is noted that although the core moiety may be described as being a specific compound, the core moiety, when incorporated into the described particles, is a residue of that specific compound. As such, a cyclodextrin may be used to prepare a particle as described herein, but may lose some or all of its pendant hydroxyl groups when incorporated into the particle, and is therefore a residue of the original cyclodextrin. That said, a particle comprising a p-cyclodextrin core moiety actually comprises a residue of the p-cyclodextrin as the core moiety.

The polymer chains extending from the core comprise at least two blocks, and may be a diblock copolymer. The polymer chains and blocks thereof are low polydispersity, with the first, or inner, block attached to the core moiety. The second block is attached to the end of the first block opposite the core moiety. The polydispersity index (PDI) of the polymer chains and/or blocks thereof are less than or equal to 2, less than 1.5, less than 1.3, or less than 1.2. Low polydispersity is preferred for uniformity of environmental responsiveness, high cationic cargo loading, uniform delivery to different plant parts, and high delivery rates. The polymer chains may be acrylic, e.g., formed from acrylate and/or methacrylate (collectively (meth)acrylate) monomers, or another ethylenically-unsaturated monomer, such as a styrene, acrylamide, or acrylonitrile monomer.

The first, or inner block of the polymer chains of the star or comb polymer particles described herein is acidic, comprising residues of acidic monomers or acidic hydrolysis products of monomers used to prepare the copolymer. The acid functional group may be, for example and without limitation, carboxylic (—COOH), sulfonic (—SO₃H), phosphonic, or boronic. The acidic group may be present in the as-polymerized monomers, or may be formed after the polymer chain is made, such as by hydrolysis or removal of a blocking group, as with the use of tert-butyl acrylate monomers in the Examples below, which is later hydrolyzed to produce carboxylic acrylic acid residues. The acidic block may be a copolymer of two or more monomers, such as two or more acidic or acid-forming monomers, or acidic or acid-forming monomers in combination with a neutral residue, or another acidic monomer, in blocks or intermixed.

Non-limiting examples of acidic monomers include: acrylic acid, methacrylic acid, styrene sulfonic acid, and 2-acrylamido-2-methyl-1-propane sulfonic acid. Non-limiting examples of acid-forming monomers include tBA and tBmA.

The second block of the polymer chains is connected to the outer ends of the first block opposite, or distal to the core. The second block imparts environment-sensitivity to the particle. By environment-sensitivity, it is meant the aqueous environment in which the particles are suspended, and not the external-environment of an organism or vessel in which the aqueous solution comprising the polymer is contained. That said, in an organism, such as a plant, the external environment can dictate the aqueous environment in which the particles are suspended, for example external heat can raise the local temperature of the particle. Although reactivity to many environmental conditions can be used to trigger release of a cargo from the particles described herein, as exemplified by the examples, below, changes in temperature, changes in pH, and the presence of reactive oxygen species may trigger release of the cargo by effectively changing at least one aspect of the block copolymers of the particles described herein.

For temperature-sensitivity, the second block imparts an LCST to the chain in water, ranging from 0° C. to 45° C., such as ranging from 15° C. to 40° C. or from 20° C. to 45° C., for example and without limitation ranging from 25° C. to 45° C., ranging from 25° C. to 40° C., or ranging from 32° C. to 40° C., including any increment therebetween, such as 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., or 45° C. Suitable monomers for forming a temperature-sensitive block using a controlled-radical polymerization method include, without limitation: N-isopropyl acrylamide, 2-(dimethylamino)ethyl methacrylate (DMAEMA), vinylcaprolactam, 2-hydroxyethyl methacrylate (HEMA), diethylacrylamide, and/or poly(ethylene glycol) methyl ether methacrylate (e.g., oligo(ethylene glycol)methyl ether methacrylate. The temperature-sensitive block may be a copolymer of two or more monomers, such as monomers for forming a temperature-sensitive block, or monomers for forming a temperature-sensitive block in combination with other monomers, in blocks or intermixed.

For pH sensitivity, the monomers of the second block change their ability to complex with loaded cargo and colloidal stability in aqueous solutions at different pH values. At lower pH, below pKa of acrylic acids, the protonation of carboxylic groups will induce release of loaded cargo molecules.

For ROS-sensitivity, the swellability of the second block in an aqueous environment is changed by reaction of functional groups in the second block with the ROS, which causes water-swelling of the particle, allowing diffusion of a cationic cargo complexed with the first block from the particle. In the example below, thioether groups of MTEA (2-(Methylthio)ethyl acrylate) are converted to thiosulfinyl and thiosulfone groups. Aside from MTEA, other useful monomers for imparting ROS-sensitivity to the particles include: 2-(methylthio)ethyl methacrylate, or 4,4,5,5-tetramethyl-2-(4-vinylphenyl)-1,3,2-dioxaborolane. Other ROS-sensitive monomers include, without limitation boronic ester, and selenium-containing functional groups.

### EXAMPLES

Although heat stress is a mounting problem, development of carriers that release agrochemicals in an environmentally-responsive fashion, e.g., in a temperature responsive fashion are not available. Linear PNIPAm-b-poly(butyl methacrylate) diblock copolymers and copoly(oligo(ethylene oxide) methacrylates) were employed for medical use in micelle structures. While micelles can demonstrate the necessary thermal responsiveness, micelles can only form when the polymer concentration in solution exceeds the critical micelle concentration (CMC), which makes micelles vulnerable to disassembly due to dilution while entering plants, hampering their ability to carry agents through the plants to target any particular part of the plant. As such, a structure that does not spontaneously disassemble is needed to penetrate plant leaves and translocate agrochemicals to other plant compartments. In addition to temperature-triggered drug delivery, the agent carriers also should release agents under relevant pH conditions existing in plants. pH-responsive materials also need to be developed to release drugs under pH conditions that exist in certain diseased tissues. Likewise, agent carriers also should release agents when triggered by ROS existing in plants. ROS-responsive materials also need to be developed to release drugs under pH conditions that exist in certain diseased tissues

A temperature-responsive cargo delivery system is described herein that relies on polymers that display a lower critical solution temperature (LCST) that is relevant to heat stress in plants. In an examples below, poly(N-isopropylacrylamide) (PNIPAm) and its copolymers may be used because of their sharp chain collapse response above their LCST. Poly(acrylic acid) (PAA) was chosen in the Examples below due to its pH responsiveness (pKa-4.5) and ability to associate with common cationic antibiotics. Combining the temperature-responsive properties of PNIPAm and the active agent-carrying capacity of PAA provides a polymer that can deliver agrochemicals to plants and release them when they experience extreme temperature.

In addition, foliar application of polymeric carriers of agrochemicals may be a highly efficient delivery strategy. However, the carrier must be able to penetrate the cuticle waxy layer and epidermal cells to enter the leaf mesophyll and reach the phloem, which is the major vasculature delivering nutrients from leaves into other plant compartments. Atom transfer radical polymerization (ATRP) and other controlled radical polymerization methods has enabled facile fabrication of polymer based nano-structures with desired size, architecture and functionality, and may be employed to prepare particles described herein.

### Example 1

Here, we report the synthesis and characterization of temperature and pH-responsive ˜30 nm star polymers with PAA-b-PNIPAm block copolymer arms. We assessed the effect of four different PAA:PNIPAm block length ratios on in vitro controlled release profiles for a model cationic antimicrobial agent. The routes of uptake and translocation of two foliar-applied star polymers were determined in tomato plants by dark field hyperspectral imaging (DF-HSI), and the temperature responsive in vivo release was demonstrated.

### Materials and Methods

Materials. N-isopropylacrylamide (NIPAm, 97%), tert-butylacrylate (tBA, 98%), p-cyclodextrin (p-CD), 2-bromoisobutyryl bromide (BiBB, 98%), 1-methyl-2-pyrrolidone (NMP), dichloromethane (DCM), copper powder (Cu⁰, 99.7%) crystal violet (CV, >90.0%), and chloroform-d (CDCl₃) were obtained from Sigma Aldrich. Tris[2-(dimethylamino)ethyl]amine (Me₆Tren), gadolinium(II) chloride hexahydrate (GdCl₃·6H₂O, 99%), anisole (99%), N,N-dimethylformamide (DMF, 99%) and trifluoroacetic acid (TFA) were purchased from Alfa Aesar. HNO₃ (70%, trace metal grade) and H₂O₂(30%, ACS grade) were purchased from Fisher Scientific. Acrylate monomers were passed through a basic alumina column before use. The NIPAm monomer was recrystallized in hexane. All solvents and other reagents were used as received. Dialysis bags with various molecular weight cutoffs were purchased from Spectrum lab (Spectra/Por 7).

Synthesis of PAA-b-PNIPAm Star Polymers with Different Arm Compositions by a Core-First Method

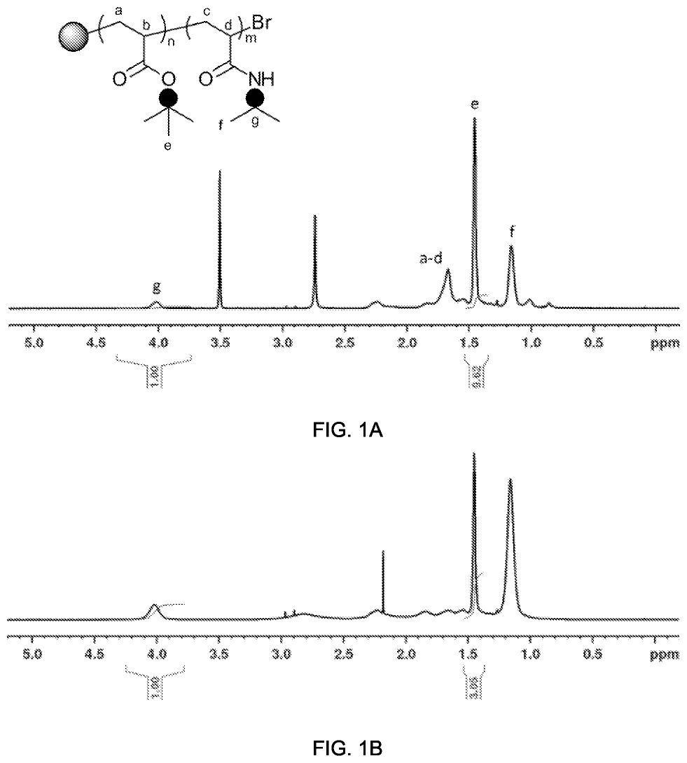

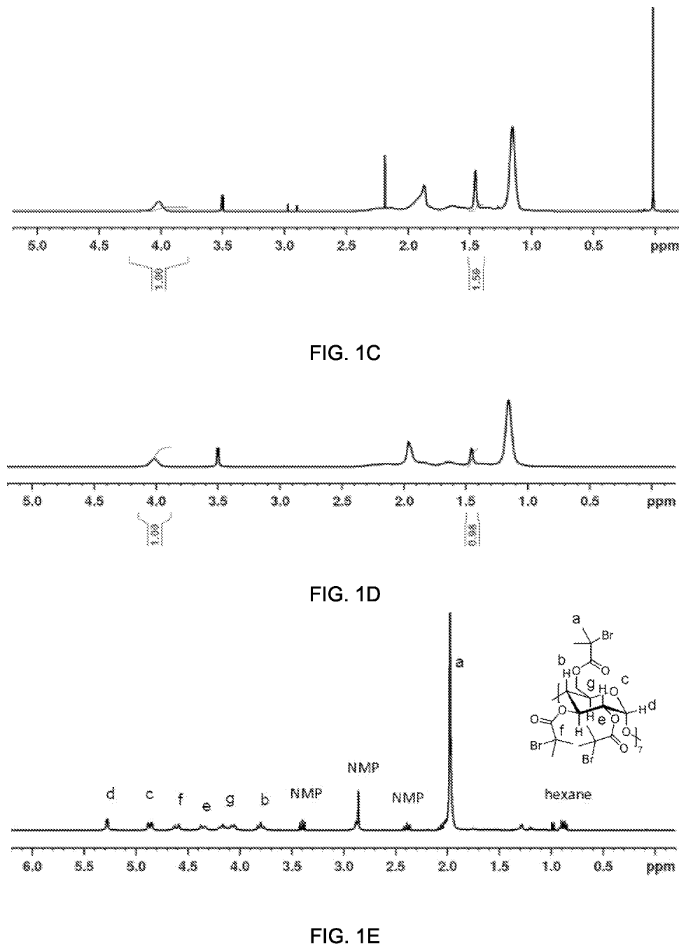

Synthesis of p-CD-21 Br ATRP Initiator. The p-CD core with 21 ATRP initiation sites was synthesized. Three grams of p-CD (2.64 mmol) was dried under vacuum overnight, put into a 100 mL round-bottom flask in an ice bath, and dissolved into 20 mL of anhydrous NMP. BiBB (13.72 mL, 111.01 mmol) was dissolved in anhydrous NMP (10 mL) and added dropwise to the β-CD solution. The solution was gradually warmed to room temperature and the reaction was proceeded for 1 day. The dark brown solution was dialyzed against distilled water (MWCO=1000) for 3 cycles. The remaining product was concentrated under vacuum using a Schlenk line and crystallized in cold hexane. The composition of this macro-initiator was confirmed by NMR using a Bruker Advance 500 MHz NMR spectrometer (See FIG. 1E). ¹H NMR (CDCl₃ 300 MHz) δ: 5.28 (7H, d, J=3.6 Hz), 4.86 (7H, dd, J=10.2, 3.5 Hz), 4.61 (7H, m), 4.35 (7H, m), 4.11 (14H, m), 3.79 (7H, t, J=9.2 Hz), 1.97 (21H, s) ppm.

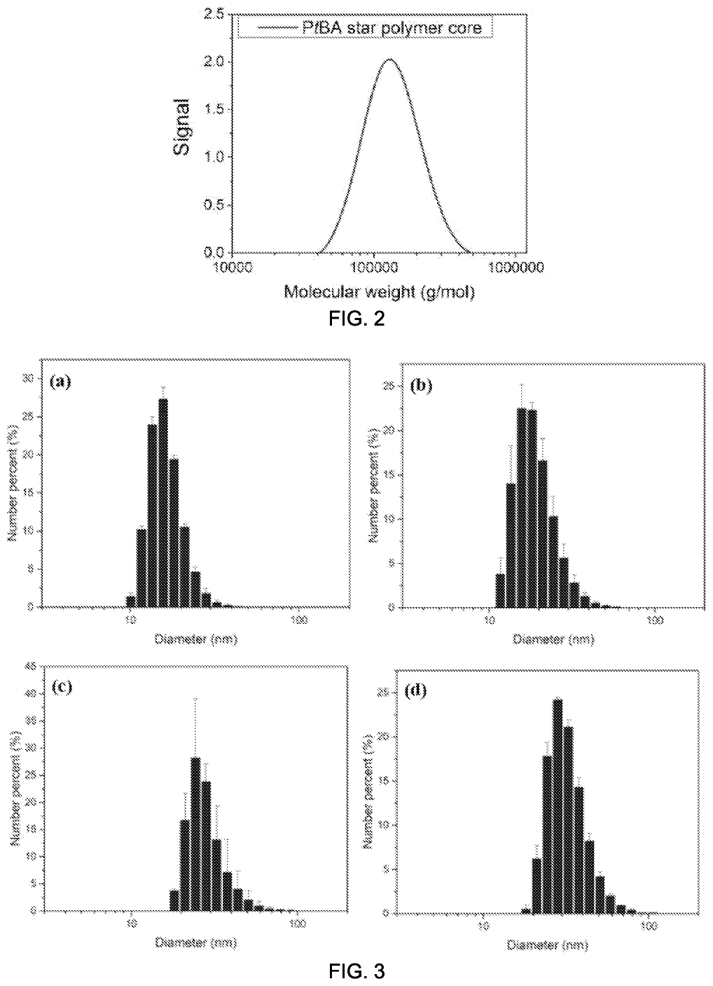

Synthesis of PtBA core for PAA-b-PNIPAm star polymers. The PtBA star polymer core with 21 PtBA arms was prepared using Supplemental Activation Reducing Agent (SARA) ATRP. Briefly, 0.049 g of p-CD-21Br initiator (p-CD-211Br, 1 equiv), 2.71 mL of tBA (2100 equiv), 0.394 mg CuBr₂ (0.4 equiv), 0.001 mg Me6Tren (1 equiv), 3.55 mL anisole and 1 cm Cu⁰ wire were mixed in a sealed Schlenk flask equipped with a stir bar. The Schlenk flask was degassed by purging with N₂ for 20 min, and the reaction was allowed to proceed at room temperature for ˜20 h. The reaction was monitored by 1H NMR and stopped at 50% conversion to yield PtBA star polymers with 50 tBA repeat units in each arm. The products were purified by dialysis (MWCO=8000) against methanol for 3 cycles. The dn/dc value of PtBA star polymer in chloroform was measured to be 0.0225 mL g⁻¹ using a Wyatt r-Ex refractometer. The molecular weight and molecular weight distribution (D) of PtBA star polymers were measured by size exclusion chromatography (SEC) equipped with a Waters 515 HPLC pump, Wyatt Optilab refractive index detector, Wyatt DAWN HELEOS-II multiangle light scattering detector and PSS GRAM columns containing polyester copolymer networks operated at 50° C. in chloroform (FIG. 2).

Synthesis of PtBA₅₀-b-PNIPAm₅₀ star polymers. The PNIPAm chain extension procedure was adapted from Chmielarz, P. et al., PEO-b-PNIPAM Copolymers via SARA ATRP and EATRP in Aqueous Media. Polym. (United Kingdom) 2015, 71,143-147. Briefly, 0.2 g of as synthesized PtBA star polymer (1 equiv), 0.339 g of NIPAm (2100 equiv), 0.335 mg CuBr₂ (1.05 equiv), 0.00083 mL MeeTren (2.1 equiv), 0.0385 g NaBr (0.1 M) and 3.74 mL of DMF were mixed and sealed in a 10 mL Schlenk flask with a stir bar. The flask was deoxygenated by purging the reaction mixture with N₂ for 20 min. The reaction mixture was then frozen by plunging it into liquid nitrogen. The flask was opened briefly to add 0.056 g (0.68 cm⁻¹) Cu0 powder to the frozen reaction mixture. The flask was again sealed and purged with N₂ for 30 min. The reaction mixture was then allowed to warm to room temperature. Samples were withdrawn periodically to monitor the reaction progress by ¹H NMR in CDCl₃. The reaction was stopped at ˜50% conversion to yield PtBA₅₀-b-PNIPAm50 star polymers with PtBA:PNIPAm=1:1 in each arm. The reaction mixture was first filtered by a column filled with cotton to remove the Cu powder, then dialyzed against methanol for 3 cycles (MWCO=8000) to remove excess copper. The chemical composition of product was verified by ¹H NMR in CDCl₃ (FIG. 1A).

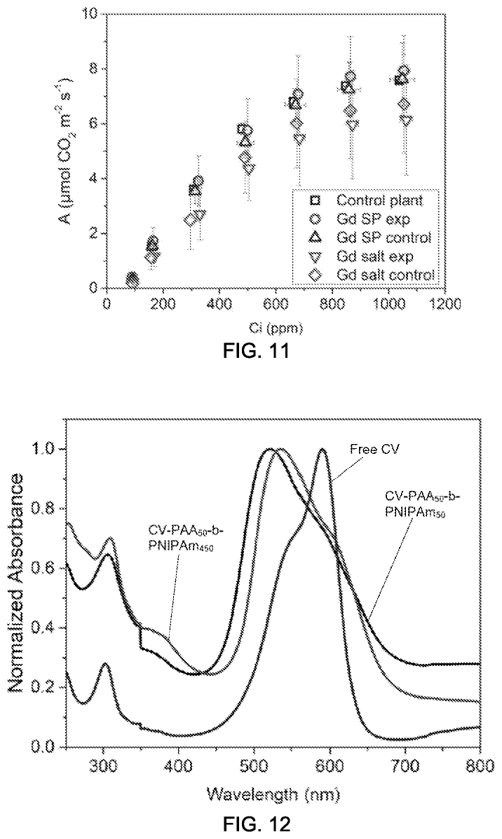

Synthesis of PtBA₅₀-b-PNIPAm₁₅₀ star polymers. The synthesis of this polymer followed the same procedures as described above, but used 0.2 g of as synthesized PtBA (1 equiv) star polymer, 1.36 g of NIPAm (8400 equiv), 1.34 mg CuBr₂ (4.2 equiv), 0.00333 mL Me₆Tren (8.4 equiv), 0.0154 g NaBr (0.1 M) and 15 mL DMF. The amount of Cu⁰ powder used was 0.227 g (0.68 cm⁻¹). The reaction was stopped at ˜37.5% conversion to yield PtBA₅₀-b-PNIPAm₁₅₀ star polymers with PtBA:PNIPAm=1:3 in each arm (FIG. 11B).

Synthesis of PtBA₅₀-b-PNIPAm₃₀₀ star polymers. The synthesis of this polymer followed the same procedures as above, but used 0.08 g of as synthesized PtBA (1 equiv) star polymer, 1.36 g of NIPAm (21000 equiv), 1.34 mg CuBr₂ (10 equiv), 0.00333 mL Me6Tren (20 equiv), 0.1544 g NaBr (0.1 M) and 15 mL DMF were mixed and sealed in a 25 mL Schlenk flask with a stir bar. For this synthesis the Cu⁰ powder was first activated by washing in with HCl in methanol and quickly rinsing with methanol, followed by drying under a N2 stream. The amount of Cu⁰ powder used was 0.227 g (0.68 cm⁻¹). The reaction was stopped at ˜30% conversion to yield PtBA50-b-PNIPAm300 star polymers with PtBA:PNIPAm=1:6 in each arm (FIG. 1C).

Synthesis of PtBA₅₀-b-PNIPAm₄₅₀ star polymers. The synthesis of this polymer followed the same procedures as above, but used 0.08 g of as synthesized PtBA (1 equiv) star polymer, 1.36 g of NIPAm (21000 equiv), 1.34 mg CuBr₂ (10 equiv), 0.00333 mL Me₆Tren (20 equiv), 0.1544 g NaBr (0.1 M) and 7.5 mL DMF. The amount of activated Cu0 powder used was 0.113 g (0.68 cm⁻¹). The reaction was stopped at ˜45% conversion to yield PtBA₅₀-b-PNIPAm₄₅₀ star polymers with PtBA:PNIPAm=1:9 in each arm (FIG. 1D).

Hydrolysis of PtBA-b-PNIPAm into PAA-b-PNIPAm star polymers. A 0.5 g mass of synthesized PtBA-b-PNIPAm star polymer was dissolved in 10 mL DCM with magnetic stirring. The polymer solution was then placed in an ice bath and 1 mL of TFA was added into the star polymer solution. The reaction mixture was sealed, allowed to warm to room temperature and to react for ˜12 h. The resulting solution was dialyzed against methanol for 3 cycles (MWCO=8000) to remove excess TFA.

CV loading and in vitro controlled release experiments. To load CV into the star polymers, 10 mg of PAA-b-PNIPAm star polymer was first dissolved into 5 mL of a 0.05 M aqueous NaOH solution. The sample was sonicated in an ice bath for 30 min (isonic P4800, 60 W) to accelerate star polymer dissolution. The pH of the star polymer solution was adjusted to 6.5 by adding aliquots of 0.1 M NaOH or 0.1 M HCl aqueous solution. Then, 20 mg of CV was added into the star polymer solution. The mixture was vortex mixed for 1 day. The resulting solution was dialyzed against 2 L of MilliQ water (MWCO=8000) for 2 cycles to remove free CV. The CV concentration in the dialysate was measured by UV-Vis spectrophotometry (Agilent Cary 4000) at 590 nm absorbance wavelength and the CV loading in the star polymer was calculated from a mass balance.

To assess the temperature and pH responsive release properties of the PAA-b-PNIPAm star polymers, the controlled release experiments were conducted at either 20° C. or 40° C. in 10 mM phosphate buffer at pH=4.5 by adjusting the pH of a 10 mM NaH₂PO₄ solution to 4.5 with 0.1 M HCl and NaOH, at pH=6.0 by mixing 8.6 mM of NaH₂PO₄ and 1.4 mM of Na₂HPO₄ or at pH=7.5 by mixing 1.91 mM of NaH₂PO₄ and 8.09 mM Na₂HPO₄ and adjusting the pH to 7.5 with HCl and NaOH. In the typical procedure, 4 mL of CV loaded star polymer solution was dialyzed against 100 mL of phosphate buffer solution (MWCO=8000). The dialysate was sampled and measured for CV concentration by UV-Vis spectrophotometry at multiple time points to assess the CV release profiles of each star polymer under the different temperature and pH conditions.

Gd³⁺ loading into star polymers. To load Gd into the star polymers, 20 mg of PAA-b-PNIPAm star polymer was first dissolved into a 0.05 M NaOH aqueous solution in an ice bath with sonication, and adjusted to pH 6.5 as described above. Then, 0.1 g of GdCl₃·6H₂0 was dissolved into the star polymer solution and mixed by vortex mixer for 3 days to allow complete reaction between Gd and star polymers. The resulting solution was dialyzed against MilliQ water for 7 days and water was replaced once a day until the Gd concentration in the dialysate was not detectable by ICP-MS (<0.1 ppb). The final Gd³⁺ content of the loaded star polymers was measured by ICP-MS. (Agilent 7700X).

Plant growth. For plant uptake experiments, Solanum lycopersicum seeds were surface sterilized by 10% (w/v) bleach for 10 min, then thoroughly rinsed by Milli Q water 3 times. The sterilized seeds were germinated in the dark on water-moistened filter paper in a Petri dish. After 10 days, the seedlings were transplanted to 100 mL plastic containers. Each seedling was grown hydroponically using ¼ strength Hoagland's solution aerated using air pumps. The plants were grown at room temperature (˜20° C.) with a 16 h light and 8 h dark cycle. The plants were used for foliar uptake experiments after 18 days of growth. All the tomato plants used for star polymer exposure had at least 4 leaves.

Star polymer foliar exposure, uptake and transport in tomato plants. The uptake of star polymers into plants was measured after foliar application. To enhance uptake, two types of agriculturally relevant surfactants, SILWET® L-77 (3-(2-methoxyethoxy)propyl-methyl-bis(trimethylsilyloxy)silane) and TWEEN® 80 (Polyoxyethylene sorbitan monooleate), were added into Gd-star polymer solution at 0.1% v/v. Each treatment was examined in triplicate with 3 plants. Four droplets of 5 μL Gd-star solution at either 1 g L⁻¹ or 200 mg L⁻¹ star polymer concentration were applied onto the 3rd leaf of the tomato plants. The plants were harvested 3 days after exposure. The plants were cut into five parts: leaf where the Gd-star solutions were applied (denoted as ‘exposed zone’), leaves at growth stages higher than exposed leaves (denoted as ‘up’), leaves at growth stages lower than exposed leaves (denoted as ‘down’), main stem of the entire plant (denoted as ‘stem’) and roots (denoted as ‘root’). A control experiment was conducted by applying Gd salt solution at the same Gd concentration as the Gd-star solution with/without surfactants onto tomato leaves.

To determine Gd³⁺ abundance in plant tissues, all plant samples were first dried at 105° C. for 48 h to fully remove water from the tissue. The dried plants were weighed and digested overnight at room temperature in a 2:1 v/v mixture of 1 mL concentrated HNO₃ and 30% H₂O₂ aqueous solution heated to 100° C. for 30 min (protocol adapted from EPA Method 3050b). Post digestion, all samples were diluted to 5% HNO₃ by ultrapurified water and filtered by 0.45 μm PTFE syringe filter before analysis by ICP-MS. (Agilent 7700X).

In-vivo CV controlled release study. Free CV and CV loaded star polymers applied onto tomato plant leaves were imaged by enhanced dark field hyperspectral imaging (DF-HSI). A total of 20 μL (four 5 μL droplets) of either free CV or CV loaded star polymer solutions were applied onto leaves of tomato plants. Free CV was applied at the same concentration and volume as CV loaded in star polymer. The plants were kept at room temperature for 2 h. Then, the as exposed leaves were imaged by Cyto-viva. This is defined as time zero. After the time zero measurement, one group of plants was transferred into a dark 40° C. incubator and another group was kept in the dark at room temperature. The exposed leaves of these plants were imaged again at room temperature 4 h and 16 h after the initial image. Two plants were used in each star polymer treatment and 2 leaves in each plant were imaged.

Imaging leaf-polymers interactions. The interactions between leaves and the polymers loaded with CV was assessed using an enhanced dark-field microscope couple to a hyperspectral imaging system (DF-HSI) (CytoViva Inc., USA). This enhanced resolution dark-field microscope system (BX51, Olympus, USA) was equipped with a 150 W halogen light source (FIBER-LITE®, Dolan-Jenner, USA), and a hyperspectral camera (CytoViva Hyperspectral Imaging System 1.4). The leaves were observed at 10× in air or in oil immersion at 60× magnification. Hyperspectral images were acquired using 100% light source intensity and 0.1 to 0.25 s acquisition per line and corrected for the lamp contribution. The hyperspectral libraries were built using images of leaves exposed to the different loaded star polymer. All contributions of the hyperspectrum contained in control images were background subtracted from exposed samples before image analysis.

The hyperspectral libraries were used to map the locations of loaded star polymer in hyperspectral images of dosed leaves. A spectral angular mapping algorithm (SAM, ENVI 5.2) was used to identify the pixels matching the loaded star polymer hyperspectral libraries (angles≤0.085 rad were considered similar) on bands 1-177 (between 400 and 670 nm). Each pixel identified that way was highlighted in red. All the hyperspectral images were acquired at cross-section focus. Because of the narrow depth of field (less than a μm), signals of CV and CV loaded star polymers were only mapped by SAM in the focal plane shown on the pictures, and out-of-focus CV and CV loaded star polymers adsorbed on top or under the focus plane were not mapped, in agreement with previous studies that allows distinguishing polymers inside vs outside cells.

In further detail, the loaded star-polymer spectral libraries were built based on images of the star polymer on leaves, using the following steps: (i) Spectral data reduction: The images were transformed into minimum noise fraction (MNF) images, where a noise covalence matrix is used to decorrelate and rescale the noise in the data (algorithm adapted from Green, A. A., et al., A Transformation for Ordering Multispectral Data in Terms of Image Quality with Implications for Noise Removal. IEEE Trans. Geosci. Remote Sens. 1988, 26, 65-74). Coherent MNF images (containing spectral information with minimal noise) can then be separated from the noise-dominated ones. (ii) Endmember identification and pre-library building: A pixel purity index serves to find the most spectrally pure pixels in the images. This PPI is used as input parameter in an n-dimensional visualizer (n is the number of reflectance spectra or pixels), in which an n-dimensional vector represents each spectrum. This visualization allows identifying and grouping the purest pixels, i.e., the most extreme spectral responses (here termed endmembers). The endmembers constitute the pre-library. The pre-library can still contain some spectra of materials other than the loaded star polymer. (iii) Endmembers Library building: The hyperspectral libraries were filtered using the “spectral filter” option of the software ENVI 5.2. During that step all of the hyperspectral signal coming from a control leaf were filtered out. This was done using a spectral angular mapping algorithm (SAM). The SAM algorithm provides a measure for the similarity between 2 spectrums (here between the one in the pre-library and the ones on the pixels of a control image) calculating the angle between the two spectra (again treated as n-dimensional vectors). The angle for SAM processing was set as the lowest level allowing the identification of endmembers in their own pictures (i.e., 0.085 rad). Vectors with angles≤0.085 rad were considered as similar. The spectra (vectors) in the pre-library that matched pixels on hyperspectral images of the negative control leaves were considered as false positives and removed from the pre-library. The remaining spectra built the final hyperspectral library (i.e., a hyperspectral loaded star polymer specific signature).

### Results and Discussion

Synthesis and Characterization of PAA-b-PNIPAm Star Polymers with Different Arm Compositions.

Star polymers with 21 PAA-b-PNIPAm block copolymer arms were synthesized by a core-first approach. β-Cyclodextrin was functionalized with 2-bromoisobutyryl bromide (BiBB). A parent batch of star polymers with arms of poly(tert-butyl acrylate), the precursor to PAA, was subdivided, and the arms were extended with NIPAm to produce block copolymer arms with identical PAA and four different PNIPAm block lengths to investigate the influence of block length ratio on the temperature and pH programmed release response. Chemical compositions and molecular weights of star polymers were assessed by combining results from GPC-MALLS and ¹H NMR spectra of PtBA-b-PNIPAm star polymers (FIGS. 1A-1E). The number average molecular weight of the star polymer with PtBA arms before chain extension with NIPAm is Mn=1.22×10⁵ with dispersity D=1.15, which corresponds to approximately 50 tBA repeat units in each arm for 21-arm star polymers as measured by GPC-MALLS (FIG. 2). The total molecular weight of the PAA-b-PNIPAm star polymers was calculated according to the molar ratio between PtBA and PNIPAm in each star polymer sample measured by ¹H NMR, and by assuming Mn=6.86×10⁴ for the hydrolyzed PtBA block (now PAA). The calculated molecular weights of PAA₅₀-b-PNIPAm₅₀ PAA₅₀-b-PNIPAm₁₅₀, PAA₅₀-b-PNIPAm₃₀₀, and PAA₅₀-b-PNIPAm₄₅₀ star polymers are shown in Table 1.

TABLE 1
Calculated number average molecular weight (Mn),
hydrodynamic diameter (Dh) and crystal violet
loading efficiency of PAA-b-PNIPAm star copolymers.

| PAA-b-PNIPAm | Mₙ | Dₕ | CV loading |
|---|---|---|---|
| star copolymer^{a} | (g/mol)^{b} | (nm)^{c} | (mg CV/g polymer) |
| PAA₅₀-b-PNIPAm⁵⁰ | 1.76 × 10⁵ | 13.7 ± 4.0 | 431 ± 147 |
| PAA₅₀-b-PNIPA¹⁵⁰ | 3.92 × 10⁵ | 17.4 ± 5.5 | 234 ± 66 |
| PAA₅₀-b-PNIPAm³⁰⁰ | 7.15 × 10⁵ | 29.6 ± 6.0 | 114 ± 26 |
| PAA₅₀-b-PNIPAm⁴⁵⁰ | 1.04 × 10⁶ | 32.3 ± 8.6 | 103 ± 21 |

^{a}The molar ratio between PAA and PNIPAm was confirmed by ¹H NMR.
^{b}Number average molecular weight confirmed by GPC-MALLS and ¹H NMR.
^{c}Number average hydrodynamic diameter at 1 gL⁻¹ polymer concentration in deionized water at pH 6.5 was measured by DLS. Error represents half of the full width at half maximum (FWHM) to approximate the width of the star polymer size distribution.

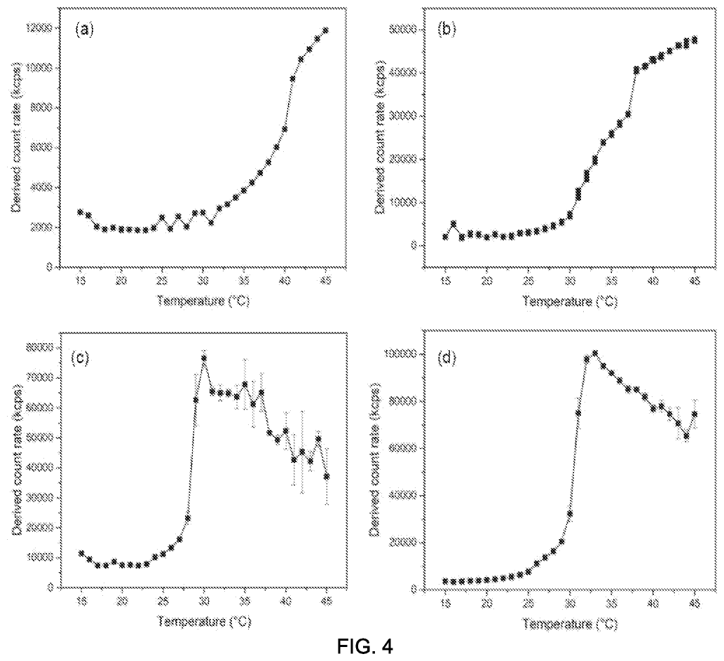

Star copolymers exhibit structures that resemble micelles formed by linear amphiphilic block copolymers but which are non-dissociable and normally less polydisperse than polymer micelles. The hydrodynamic diameter and size distribution of star polymers with different PAA to PNIPAm ratios measured by dynamic light scattering (DLS) are shown in Table 1 and FIG. 3. All of PAA-b-PNIPAm star polymers reported in this study have a mean size of 30 nm or less in number average hydrodynamic diameter. The LCST behaviors of PAA-b-PNIPAm star polymers were also assessed by light scattering. Results are shown in FIG. 4. Each of the PAA-b-PNIPAm star polymers exhibited an increase in total light scattering intensity, caused by star polymer aggregation under the poor solvent conditions for PNIPAm above a threshold temperature. The PAA₅₀-b-PNIPAm₃₀₀ and PAA₅₀-b-PNIPAm₄₅₀ star polymers with longer PNIPAm blocks exhibited abrupt transitions, with total scattering intensity starting to increase at ˜25° C. and reaching a maximum scattering intensity at around 32° C., corresponding to the LCST reported for linearPNIPAm (FIG. 4 (c,d)). While the PAA₅₀-b-PNIPAm₅₀ and PAA₅₀-b-PNIPAm₁₅₀ star polymers with shorter PNIPAm blocks exhibited less abrupt responses. Their total scattering intensity also started gradually increasing at ˜25° C., but the maximum scattering intensity shifted to a higher temperature (˜45° C.) (FIG. 4 (a,b)). The broader transition temperature range of star polymers with the smaller PNIPAm blocks (PAA₅₀-b-PNIPAm₅₀ and PAA₅₀-b-PNIPAm₁₅₀) compared to the star polymers with the larger PNIPAm blocks (PAA₅₀-b-PNIPAm₃₀₀ and PAA₅₀-b-PNIPAm₄₅₀) demonstrates a greater resistance to temperature induced aggregation. For polymers with short PNIPAm blocks, the electrostatic repulsions between the charged PAA blocks dominate the interaction energy between the star polymers, inhibiting aggregation at the near neutral pH used to measure these transitions (pH 6.5). For star polymers with the larger PNIPAm blocks, the attractive hydrophobic interactions between the collapsed PNIPAm blocks above the LCST of 32° C. were sufficiently large to overcome the electrostatic repulsion of the PAA core, leading to more rapid aggregation and a sharper temperature transition.

Crystal Violet Loading and In Vitro Controlled Release for Star Polymers with Different PAA to PNIPAm Ratios

Crystal violet (CV) was used as a model antimicrobial agent in this study, because the positively charged amine groups in CV also exist in several types of antimicrobial agents used in plant disease management, and CV can be easily quantified by UV-Vis spectroscopy. CV has been used as a fungicide for controlling plant diseases. With pKₐ values of 5.31 and 9.30, CV is loaded into the star polymers at pH 6.5 via electrostatic attraction between positively charged amine groups in the CV and negatively charged carboxylate groups in the PAA blocks of the star polymers.

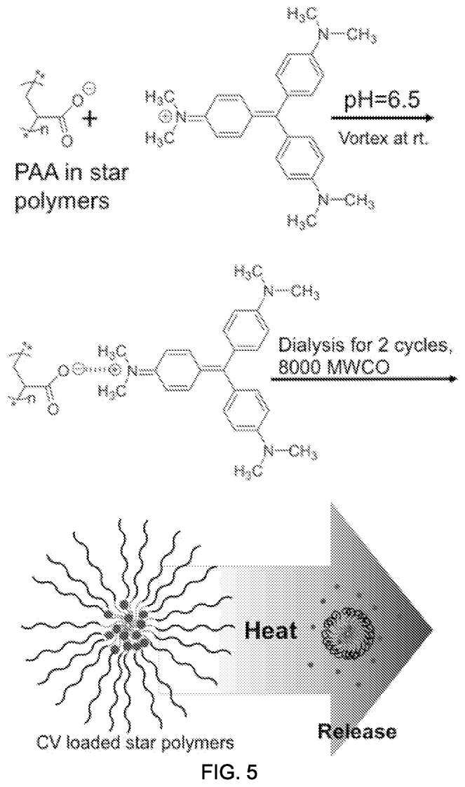

The loading procedure and reaction mechanism are described above (See, also, FIG. 5). CV loading efficiency, expressed as bound mass of CV per unit mass of star polymer, for PAA₅₀-b-PNIPAm₅₀, PAA₅₀-b-PNIPAm₁₅₀, PAA₅₀-b-PNIPAm₃₀₀, and PAA₅₀-b-PNIPAm₄₅₀ star polymers varied from 103±21 mg CV g⁻¹ to 431±147 mg CV g⁻¹ as shown in Table 1, corresponding to a range of 186±63 to 263±54 CV molecules bound to each star polymer. CV mass loading efficiency is lower for star polymers with higher PNIPAm content.

The exterior PNIPAm blocks in water are swollen at temperatures below, and collapsed at temperatures above, their LCST of −32° C. In this system design, swollen PNIPAm blocks obstruct CV release at low temperatures. At temperatures higher than 32° C., PNIPAm collapses to a globular state, lowering its hydrodynamic volume and less efficiently blocking release from the star polymers (See, FIG. 5).

Star polymers with four different PAA to PNIPAm molar ratios at constant PAA content were tested in-vitro to evaluate the impact of chain composition on temperature- and pH-responsive CV release profiles.

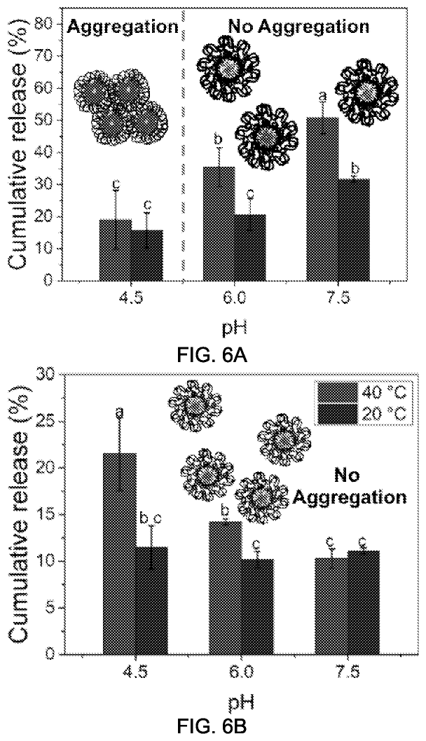

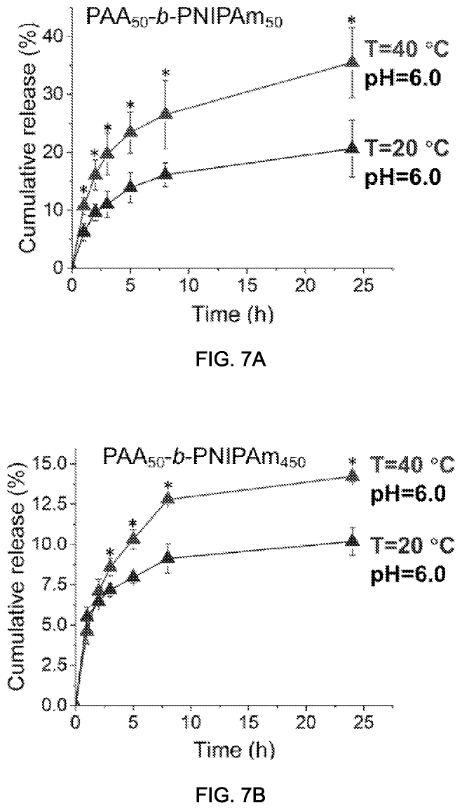

We explored the temperature-responsive release from two different PAA-b-PNIPAm architectures: PAA₅₀-b-PNIPAm₅₀ and a PAA₅₀-b-PNIPAm₄₅₀ (FIGS. 6A and 6B) due to the substantial difference in their chemical compositions. The smaller PAA₅₀-b-PNIPAm₅₀ star polymers released a higher percentage of its CV cargo than the larger PAA₅₀-b-PNIPAm₄₅₀ star polymers under same pH and T conditions. This indicates that the larger and bulkier PNIPAm block is limiting the overall release of the CV from the PAA core. The majority of CV release occurred after ˜10 h (FIGS. 7A and 7B).

In addition, we determined the CV release profile of PAA₅₀-b-PNIPAm₅₀, PAA₅₀-b-PNIPAm₁₅₀, PAA₅₀-b-PNIPAm₃₀₀ and PAA₅₀-b-PNIPAm₄₅₀ star polymers at 20° C. and 40° C. in 10 mM phosphate buffers at pH 4.5 and 7.5 and PAA₅₀-b-PNIPAm₅₀ and PAA₅₀-b-PNIPAm₄₀ star polymers with 0.1 v/v % SILWET® L-77 incubated at 20° C. and 40° C. in 10 mM phosphate buffers with pH 4.5 and 7.5. For PAA₅₀-b-PNIPAm₅₀ star polymer, the CV release profile is influenced by both pH and temperature, and the two effects are coupled. Higher cumulative release after 24 h was observed at pH 7.5 than at pH 4.5 for both temperatures. The cumulative 24 h release was significantly higher at 40° C. than at 20° C. for pH 7.5, but at pH 4.5, the temperature effect on 24 h release was insignificant. CV has a pKₐ₁ of 5.3, indicating CV can become more positively charged when the pH is decreased from 7.5 to 4.5. The CV with more positive charge can interact more strongly with PAA. So, although the protonation of PAA at lower pH would tend to weaken its interaction with CV, protonation of the latter compensates for this effect: the net attraction between CV and carboxylic acids has been shown to be nearly invariant when pH is varied between 4.5 and 7.5. The weak pH dependence of the CV/carboxyl group interaction cannot explain why 24 h release is more extensive at pH 7.5 than at 4.5 at both temperatures. Protonation of carboxylic groups at lower pH induces strong hydrogen bonding between PAA chains. Enhanced intermolecular attractions among protonated PAA, combined with the decreased electrostatic repulsion, may promote aggregation of the star polymers, reducing the surface area in contact with aqueous phase and inhibiting drug release from star polymers.

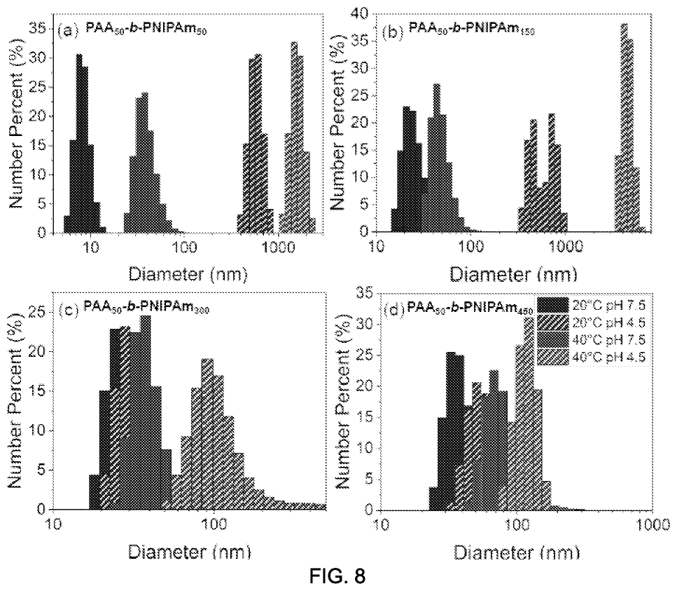

Evidence for PAA₅₀-b-PNIPAm₅₀ star polymer aggregation at pH 4.5 and 20° C. was provided by DLS, where the size distribution significantly broadened and shifted to larger size compared to pH 7.5 (FIG. 8 (a)).

PAA₅₀-b-PNIPAm₄₅₀ star polymers showed temperature responsive CV release at pH 6.0 and 7.5, but not at pH 4.5 (FIG. 6A). CV binding to PAA is nearly pH-independent in the pH range from 4.5 to 7.5, so the lower release at pH 4.5 was likely due to pH induced PAA aggregation at pH 4.5 at both 20 and 40° C., but not at pH 6 or 7.5 (FIG. 8 (a)). Protonation of the carboxylate groups in PAA weakened electrostatic repulsion between the negatively charged PAA cores and the short PNIPAm blocks (50 DP) could not provide sufficient steric stabilization to prevent aggregation.

The PAA₅₀-b-PNIPAm₄₅₀ star polymer with the longer PNIPAm block showed temperature responsive CV release at lower pH (4.5 and 6.0) but not at pH 7.5 (FIG. 6B). The longer PNIPAm block provided sufficient steric stabilization to prevent aggregation of these star polymers at the lower pH (FIG. 8 (d)). However, H-bonding between CV and acrylamide groups in PNIPAm increases as pH increases from 4.5 to 7.5. This is likely responsible for inhibiting CV release at higher pH. The effects of PNIPAm thermal collapse and increased CV H-bonding to PNIPAm evidently are mutually compensating at pH 7.5. This effect manifests more in the PAA₅₀-b-PNIPAm₄₅₀ star polymers than in the PAA₅₀-b-PNIPAm₅₀ star polymers because the longer PNIPAm blocks have nine times more acrylamide groups available for binding with CV than the PAA₅₀-b-PNIPAm₅₀ star polymers. This is consistent with the overall lower amount of CV release from the PAA₅₀-b-PNIPAm₄₅₀ star polymer compared to the PAA₅₀-b-PNIPAm₅₀ star polymers. Thus, the CV release behavior of the smaller star polymers is dominated by the PAA block behavior, whereas the CV release behavior is dominated by the PNIPAm block in the larger star polymer. Also, the presence of 0.1 v/v % SILWET® L-77, which we used in the plant transport study did not eliminate temperature responsive release. Overall, these data indicate that the rate and extent of release of CV should be greater at 40° C. than at 20° C. This release was demonstrated in vivo in tomato plants.

Star polymers with intermediate (150 and 300 DP) PNIPAm blocks showed temperature responsive CV release at both pH 4.5 and 7.5. The pH response of PAA₅₀-b-PNIPAm₁₅₀ star polymer was more similar to that of PAA₅₀-b-PNIPAm₅₀, while the behavior of PAA₅₀-b-PNIPAm₃₀₀ star polymers was more similar to PAA₅₀-b-PNIPAm₄₅₀ star polymers, confirming that the release behaviors of these materials are structure-dependent.

This combination of both temperature and pH responsiveness enables design of agrochemical carriers capable of releasing activated ingredients into selected plant compartments according to their pH and temperature conditions. For example, pH in the plant apoplastic spaces is slightly acidic, and has been reported to be around 5.0-6.0 even under normal conditions. Biotrophic pathogens can also transport more effectively in plants with acidic surroundings. Thus, a carrier that preferentially releases protective agents against pathogens under low pH conditions may be desirable. The star polymers with longest PNIPAm block (PAA50-b-PNIPAm450) can therefore potentially protect plants against pathogen infections under stress by releasing antimicrobial agents in the apoplastic spaces in stressed plants. Conversely, the star polymers with the smallest PNIPAm block length (PAA₅₀-b-PNIPAm₅₀), which had a higher antimicrobial agent release rate at pH 7.5 may serve as agrochemical carriers targeting systemic diseases in plant phloem, where pH is normally neutral. Either of these polymers would potentially serve as temperature-responsive release systems near pH 6. In summary, the in vitro release data demonstrates that PAA-b-PNIPAm star polymers satisfy one of the desired attributes of a triggered agrochemical release system. They produce temperature- and/or pH-dependent CV release kinetics, depending on the PAA:PNIPAm ratio. The next section addresses the degree to which these carriers are taken up by plants after foliar application.

### Star Polymer Uptake and Transport in Tomato Plants

Tomato (Solanum lycopersicum) plants were selected as a model system to evaluate star polymer uptake, transport and contents release is plant tissues. In order to track their movement in vivo, the PAA-b-PNIPAm star polymers were coupled with Gd³⁺ ions as tracers and applied onto tomato leaves by drop deposition either with or without agriculturally relevant surfactants as wetting agents (SILWET® L-77 and TWEEN® 80). Gd³⁺ was selected as a tracer for the star polymers because it binds nearly irreversibly to carboxyl groups of PAA, it has a low background concentration in plants, and it is readily quantified in excised plant tissue samples by inductively couple plasma mass spectrometry (ICP-MS) to track its distribution in the plants. Uptake experiments were conducted with the lowest (1:1) and highest (1:9) PAA:PNIPAm ratio star polymers with largest differences in size. PAA₅₀-b-PNIPAm₅₀ and PAA₅₀-b-PNIPAm₄₅₀ star polymers were loaded with Gd³⁺ from GdCl₃·6H₂O aqueous solutions then dialyzed against MilliQ water to remove any loosely bound Gd. Star polymer solutions containing 1.0 g L⁻¹ star polymer were loaded with Gd³⁺ at 0.11 g Gd³⁺/g polymer and 0.012 g Gd³⁺/g polymer for PAA₅₀-b-PNIPAm₅₀ and PAA₅₀-b-PNIPAm₄₅₀, respectively. Leaching measurements showed that less than 0.1% of the bound Gd³⁺ dissociated from star polymers over the course of 72 h with or without surfactants (Table 2). Lack of dissociation validates the use of bound Gd³⁺ as a tracer for the relative abundance of star polymers.

TABLE 2
Gd concentration within and out of dialysis bag after mixing
Gd loaded star polymer without surfactant or with 0.1
v/v % Silwet L-77 at pH 6.5 and dialyzed against water for 3 days.

| | Gd in star | Free Gd out of star |
|---|---|---|
| Sample name | polymer (mg/L) | polymer (μg/L) |
| PAA50-b-PNIPAm50 | 110.3 | <0.00 |
| PAA50-b-PNIPAm450 | 11.5 | <0.00 |
| PAA50-b-PNIPAm50 | 94.85 | 3.95 |
| SILWET ® L-77 | | |
| PAA50-b-PNIPAm50 | 10.06 | <0.00 |
| SILWET ® L-77 | | |

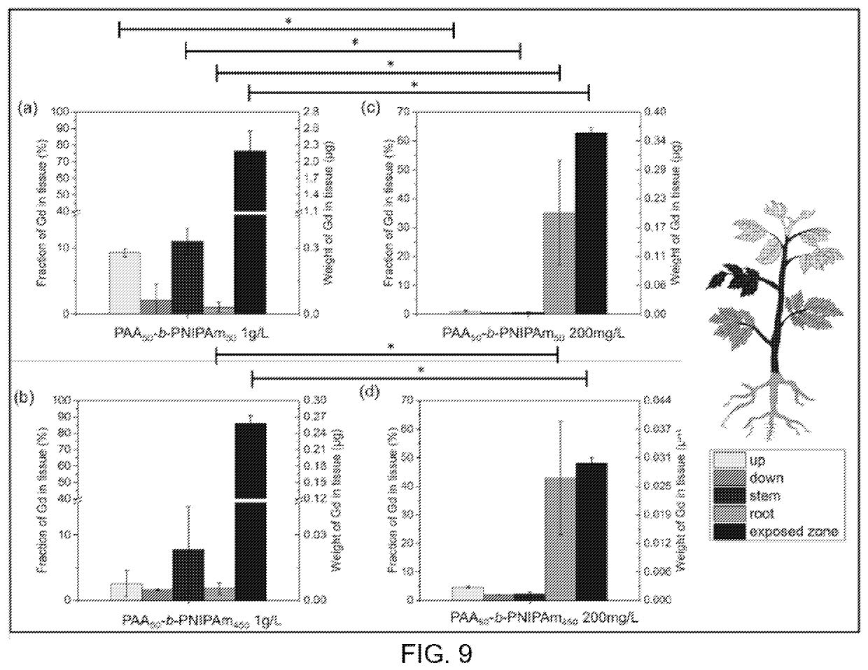

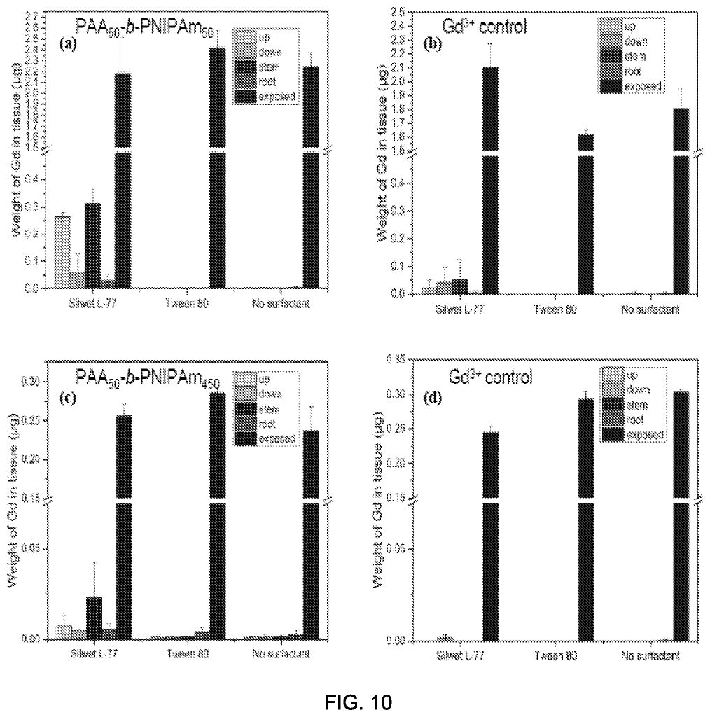

After deposition of four, 5 μL drops of solution containing star polymer and 0.1 v/v % SILWET® L-77, Gd was detected at levels far exceeding background of the stem, leaves above and below the initially exposed leaf and the roots (FIG. 9). Using 1.0 g L-1 of star polymer, up to 24±6% of PAA₅₀-b-PNIPAm₅₀ and 14±9% of PAA₅₀-b-PNIPAm₄₅₀ star polymers were transported from the initially exposed leaf zone to other plant compartments (FIG. 9 (a, b)). Using a more dilute polymer concentration (200 mg L⁻¹), a higher percentage of applied star polymers translocated, with 35±18% of PAA₅₀-b-PNIPAm₅₀ and 43° 21% of PAA₅₀-b-PNIPAm₄₅₀ star polymer migrating to other plant compartments (FIG. 9 (c,d)). The uptake and translocation of Gd present in the star polymers was significantly higher than for free Gd³⁺ applied to leaves, either with or without SILWET® L-77 (FIG. 10 (b,d)), indicating that the star polymers are facilitating uptake and translocation to other parts of the plant. Previous studies of heavy metal transport in plants have shown that cell wall components inhibit transport by binding heavy metal ions. The star polymers can apparently shield the ions from cell wall binding. The accumulation of star polymers in multiple plant leaves also demonstrates transport via the plant vasculature. While no attempt was made to distinguish between phloem and xylem transport, the transport of star polymer to the root suggest phloem transport.

The concentration of star polymer applied to the leaves also affected the translocation pattern in plants. For the more dilute polymer concentration (200 mg L⁻¹), a significantly higher fraction of applied star polymers transported to the roots compared to the other parts of the plant (FIG. 9). Reasons for this are unclear, but the lower star polymer concentration could lead to less aggregation in the vasculature, favoring star polymer delivery deeper into plant roots. Thus, applying star polymers at lower dose can make it more efficiently taken up and can change its biodistribution in plants.

It is noteworthy that limited translocation of star polymers (<2 wt %) away from the region of deposition was observed for both PAA₅₀-b-PNIPAm₅₀ and PAA₅₀-b-PNIPAm₄₅₀ star polymers without the use of (0.1 v/v %) SILWET® L-77 in the deposition solution. The surfactant TWEEN® 80 was also not able to improve the translocation of applied star polymers (FIG. 10 (a, c)). The role of the surfactant SILWET® L-77 was explored further with hyperspectral imaging as discussed next.

To study the pathway for star polymer uptake and its enhancement by the SILWET® L-77 adjuvant, we imaged the tomato leaf in the presence of CV loaded star polymers, with or without surfactants by enhanced dark-field microscopy coupled with hyperspectral imaging (DF-HSI). Enhanced-dark-field microscopy with hyperspectral imaging showing the distribution of CV loaded into star polymers (PAA₅₀-b-PNIPAm₅₀ or PAA₅₀-b-PNIPAm₄₅₀) 3 days after drop deposition in DI water or with 0.1 v/v % SILWET® L-77. Pixels containing the loaded polymers were highlighted based on their hyperspectral signature.

The focal plane for the images was at the top of the epidermis. With SILWET® L-77, the absence of the spectral signature of the stars at the top of the epidermis indicates that they have penetrated this layer and moved further into the leaf mesophyll and vasculature. Enhanced dark-field microscopy presents a narrow depth of field (d=λ/2=250 nm), which allows imaging of different leaf structures at a precise focal plane (e.g., at the cuticle surface, above or below the epidermis). For that reason, several studies have used it to study plant cell-nanoparticle interactions. Images of CV loaded star polymers on and in tomato leaves with or without SILWET® L-77 were recorded three days after deposition onto the leaf surface at 1.0 g L⁻¹. The focal plane for the hyperspectral imaging was selected to be at the top of the epidermis cell layer of the tomato leaf. This allowed us to determine if the star polymers have penetrated the cuticle (a key first barrier to uptake) and the epidermis, another important biological barrier to leaf uptake). According to the images, without SILWET® L-77, both CV loaded PAA₅₀-b-PNIPAm₅₀ and PAA₅₀-b-PNIPAm₄₅₀ star polymers were mostly found to be associated with the anticlinal wall or apoplast area above the epidermal cells but underneath the cuticle wax layer as indicated by the red coloring indicating the presence of star polymers. This indicates that star polymers, without SILWET® L-77 can cross the cuticle of tomato plants, as previously observed for polymer-coated AuNPs in wheat. This could be referred as sticking agent in common agricultural practice. However, the accumulation of star polymers on the epidermis layer reveals that, in the absence of SILWET® L-77 the epidermal cell layer acts as a barrier, preventing most of the star polymers from migrating deeper in the plant leaf to reach the phloem. When applying star polymers in a solution containing SILWET® L-77, hyperspectral imaging showed an absence of CV loaded star polymers at the epidermis, indicating that they were able to penetrate this barrier and enter the leaf mesophyll tissue beneath the focal plane of the Cyto-viva. This is consistent with the greater translocation of star polymer in the presence of SILWET® L-77 compared to its absence.

As described above, in-vitro study of PAA₅₀-b-PNIPAm₅₀ and PAA₅₀-b-PNIPAm₄₅₀ star polymers with SILWET® L-77 was conducted to confirm that the spreading agent cannot largely promote CV release from star polymers. It is noted that the axial resolution of Cyto-viva is only 2 μm, while thickness of tomato leaf is well above 100 μm. The microscope images revealed that the shape of the epidermal cells on the tomato leaf were altered, indicating that SILWET® L-77 has disrupted the epidermal cells. This is likely the reason for the enhanced uptake in the presence of SILWET® L-77.

All images acquired around the leaf vasculature showed some CV loaded star polymer associated with them, suggesting star polymer transport via the vasculature. In these studies, purple color of the vasculature was observed, but it is noted that the purple color of the vasculature is not necessarily conferred by the presence of the CV loaded star polymer. The hyperspectral analysis could identify the spectral signature of the latter, distinguishing them from natural color of the leaf tissues as confirmed by control leaf images. Enhancement in transport of star polymers achieved by SILWET® L-77 could thus be explained by the surfactant disrupting the epidermal cells in tomato leaves, altering their selective permeability, decreasing their ability to inhibit transport of star polymers to phloem, and thereby increasing the fraction of star polymers transported to different plant compartments. It is also worth noting that the Gd loaded star polymer exposure did not affect health condition of the exposed leaves in longer term (15 days) as the CO₂ respiration rate of star polymer treated leaves is the same as unexposed control leaves. (FIG. 11) Indicating the PAA-b-PNIPAm star polymer treatment could deliver agents into plants without significant toxicity effects.

### In Vivo Temperature Responsive CV Release for PAA-b-PNIPAm Star Polymers

CV binding to carboxylic acid groups shifts its optical absorbance spectrum relative to free CV in aqueous solution. This spectral shift was pursued as a means to determine whether CV detected in plant leaves remains bound to PAA carboxyl groups in the star polymers or if the CV has been released into the surrounding solution. Hyperspectral imaging records an optical absorbance spectrum from each pixel. Comparing these spectra with that of free CV provides information about the degree of dissociation of CV from star polymers for every pixel where CV was detected. Ultraviolet-visible absorbance spectra of free CV and CV loaded PAA₅₀-b-PNIPAm₅₀, PAA₅₀-b-PNIPAm₄₅₀ star polymers measured with a UV-Vis spectrophotometer are shown in FIG. 12. A red shift in the maximum absorbance peak was observed from spectra of CV loaded star polymers compared to free CV.

Although star polymers exhibited enhanced translocation with SILWET® L-77, the CV loaded star polymers had moved beneath the focal place of the Cyto-viva and could not be detected. Thus, the responsive CV release in vivo was evaluated by acquiring spectra from images of free CV and CV loaded PAA₅₀-b-PNIPAm₅₀, PAA₅₀-b-PNIPAm₄₅₀ star polymers deposited onto leaves without SILWET® L-77, where they penetrate the cuticle and reside largely at the epidermis.

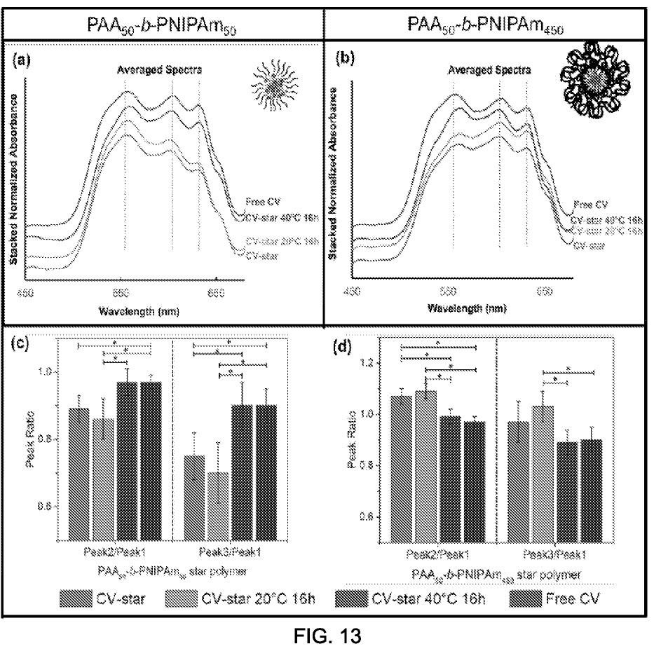

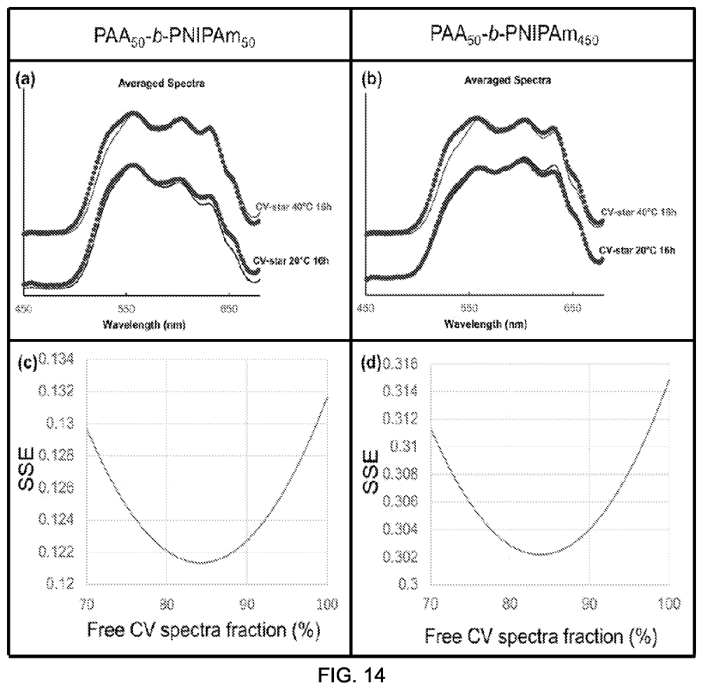

Both PAA₅₀-b-PNIPAm₅₀ and PAA₅₀-b-PNIPAm₄₅₀ star polymers applied to tomato leaves released CV when they were incubated at 40° C. for 16 h, but did not release CV when they were incubated at 20° C. (FIG. 13 (a,b)). To our knowledge, this demonstration of an in vivo temperature-activated release of an active ingredient in plants has never been reported. For the PAA₅₀-b-PNIPAm₅₀ star polymer, the spectra look like CV-star for plants incubated at 20° C., but look like free CV when incubated at 40° C. These comparisons are statistically significant (ANOVA test, P≤0.05) (FIG. 13 (c)). For the PAA50-b-PNIPAm450 star polymers, the spectra indicate the same behavior. The Peak 1/Peak 2 ratios are statistically significantly different. However, the Peak 1/Peak 3 ratios are not statistically significantly different at the p<0.05 level (FIG. 13 (d)). The ratios of free CV to CV-star were also calculated using linear combination fitting of spectra acquired after incubation at 20 and 40° C. The spectral components used in the fits were those of free CV and CV-star on tomato plants at t=0. The fitting results were consistent with the peak ratio comparison results (FIG. 14, Table 3), with 40° C. spectra fitted mostly with free CV spectra (˜85%), while the 20° C. spectra were fitted by 100% CV-star spectra. The spectra collected at 20° C. and 40° C. clearly indicate that the CV loaded into the stars is released after 16 h exposure at 40° C., but not after 16 h at 20° C.

TABLE 3
Linear combination fitting of CV loaded star polymers
incubated under 20 and 40° C. by spectra of free CV and CV
loaded star polymers. Minimized sum of squared error
between the fitted and observed spectra were also reported.

| | Free CV | CV-star, t0 | |
|---|---|---|---|
| Sample | (%) | (%) | SSEa |
| PAA₅₀-b-PNIPAm₅₀ | 0 | 100 | 0.150 |
| 20° C., 16 h | | | |
| PAA₅₀-b-PNIPAm₅₀ | 84 | 16 | 0.121 |
| 40° C., 16 h | | | |
| PAA₅₀-b-PNIPAm₄₅₀ | 0 | 100 | 0.067 |
| 20° C., 16 h | | | |
| PAA₅₀-b-PNIPAm₄₅₀ | 82 | 18 | 0.302 |
| 40° C., 16 h | | | |

According to the in-vitro controlled release results, PAA₅₀-b-PNIPAm₅₀ star polymer released more CV under neutral pH (7.5) while PAA₅₀-b-PNIPAm₄₅₀ star polymers release more CV under slightly acidic pH (4.5) at 40° C. (FIGS. 6A and 6B). The fact that both polymers can release CV to a similar extent in vivo suggests that the pH at the location where star polymers have reached, i.e., in the apoplastic space between the epidermis but below the cuticle, should be between 4.5 and 7.5 as both star polymers exhibited temperature responsiveness at pH 6.0 (FIGS. 6A, 6B, 7A, and 7B). According to previous studies, plant apoplast pH is normally 5.0-6.0, 57, 58 within the pH range suggested by the in-vitro and in-vivo study.

In conclusion, we have synthesized temperature and pH responsive PAA-b-PNIPAm star polymers that can be loaded with crystal violet, a model cationic antimicrobial agent, and provide temperature and/or pH-triggered cargo release. This material may serve as a promising nano-carrier for high efficiency agrochemical delivery in plants. A CV loading capacity of 103 to 431 mg CV/g polymer was achieved depending on the ratio of PAA and PNIPAm blocks. In vitro controlled release studies also demonstrate that the PAA to PNIPAm block ratios also result in different temperature and pH responsiveness, resulting from different pH-dependent aggregation states. Enhancement in CV release at 40° C. for PAA₅₀-b-PNIPAm₅₀ and PAA₅₀-b-PNIPAm₄₅₀ star polymer was demonstrated under both in-vitro and in-vivo conditions, indicating the temperature responsive functionality of PAA-b-PNIPAm star polymers even after being applied to tomato plants. Star polymer uptake and transport experiments have shown up to 35% of PAA₅₀-b-PNIPAm₅₀ star polymer and up to 45% of PAA₅₀-b-PNIPAm₄₅₀ star polymers translocate from the exposed leaf to the other plant compartments in the presence of SILWET® L-77. Using an exposure concentration of 200 mg/L in the deposited solution, the majority of the transported star polymers accumulates in the roots, providing an opportunity for such polymers to efficiently treat root disease via foliar application. Dark field hyperspectral imaging (DF-HSI) showed that star polymers can efficiently penetrate the cuticle wax layer and reach the epidermis cell apoplastic space without an adjuvant like SILWET® L-77. However, SILWET® L-77 disrupted the leaf epidermal cells and enhanced star polymer translocation efficiency in tomato plants.

Overall, the PAA-b-PNIPAm star polymers demonstrate significant active agent loading capacity, in-vitro and in-vivo temperature- and pH-responsive release properties, and significant foliar uptake and translocation in tomato plants. These materials are a promising approach for high efficiency delivery of agrochemicals into plant leaves or roots, and the temperature-responsive nature of the materials may help to combat heat stress or heat stress-induced plant diseases. The properties of the star polymers most affecting their transport and bio-distribution in plants may be determined to target these nanocarriers to specific plant locations (e.g., into chloroplasts). A range of agriculturally-relevant active ingredients can be tested to determine the suitability of this approach for a broad range of diseases. Other than antimicrobial agents, the current PAA-b-PNIPAm star polymers may also carry other cationic micronutrient ions (e.g., Fe, Mg, Zn) and macronutrients like ammonia. Core of star polymer can also be constructed by different monomers with various functional groups to adapt to desired agents. While relatively effective in tomato plants (a dicot), the applicability of this approach to a broader range of plants can be evaluated.

### Example 2

As a follow-on to the work described in Example 1, determining how the properties of nanocarriers of agrochemicals affects their uptake and translocation in plants would enable more efficient agent delivery. Here, we synthesized star polymer nanocarriers poly(acrylic acid)-block-poly(2-(methylsulfinyl)ethyl acrylate) (PAA-b-PMSEA) and poly(acrylic acid)-block-poly((2-(methylsulfinyl)ethyl acrylate)-co-(2-(methylthio)ethyl acrylate)) (PAA-b-P(MSEA-co-MTEA)) with well-controlled sizes (from 6 nm to 35 nm), negative charge content (from 17% to 83% PAA) and hydrophobicity, and quantified their leaf uptake, phloem loading, and distribution in tomato (Solanum lycopersicum) plants 3 days after foliar application of 20 μL of a 1 g L⁻¹ star polymer solution. Despite their property differences, ˜30% of the applied star polymers translocated to other plant organs, higher than uptake of conventional foliar applied agrochemicals (<5%). The property differences affected their distribution in the plant. The ˜6 nm star polymers exhibited 3 times higher transport to younger leaves than larger ones, while the ˜35 nm star polymer had over 2 times higher transport to roots than smaller ones, suggesting small star polymers favor symplastic unloading in young leaves, while larger polymers favor apoplastic unloading in roots. As such, it is expected that, for example and without limitation, smaller, e.g., 3-10 nm polymer particles will exhibit higher transport to younger leaves than larger ones, while larger, e.g., 30-50 nm polymer particles will exhibit higher transport to roots than smaller ones. For the same sized star polymer, a smaller negative charge content (yielding ζ˜−12 mV) enhanced translocation to young leaves and roots, whereas a larger negative charge (ζ<−26 mV) had lower mobility. Hydrophobicity only affect leaf uptake pathways, but not translocation. This study can help design agrochemical nanocarriers for efficient foliar uptake and targeting to desired plant organs, which may decrease agrochemical use and environmental impacts of agriculture.

Further, the factors affecting NP uptake and their systemic translocation pathways in plants remain unclear, and this prevents their delivery in a controlled and targeted manner. NPs can enter plant leaves through two major paths: stomata infiltration and cuticle penetration. The NP surface properties play a role in foliar uptake. The more hydrophobic polyvinylpyrrolidone (PVP) and hydrophilic citrate coated AuNPs can interact with cuticle differently. The PVP coated AuNPs translocated through the cuticle more than the citrate coated AuNPs (Avellan, A.; Yun, J.; Zhang, Y.; Spielman-Sun, E.; Unrine, J. M.; Thieme, J.; Li, J.; Lombi, E.; Bland, G.; Lowry, G. V., Nanoparticle Size and Coating Chemistry Control Foliar Uptake Pathways, Translocation, and Leaf-to-Rhizosphere Transport in Wheat Article. ACS Nano 2019, 13, 5291-5305). The monocot and dicot plants, with different leaf anatomy, will experience NP foliar uptake differently due to differences in stomata density and mesophyll cell packing density. Monocot maize plants were found to take up NPs mainly through the stomata pathway, while the dicot cotton plants take up NPs through both stomata and cuticle pathways (Hu, P.; An, J.; Faulkner, M. M.; Wu, H.; Li, Z.; Tian, X.; Giraldo, J. P., Nanoparticle Charge and Size Control Foliar Delivery Efficiency to Plant Cells and Organelles. ACS Nano. 2020, pp 7970-7986). While transcuticular pathways are being explored, almost nothing is known about how NP properties affect transport through the leaf mesophyll into the vasculature, i.e. phloem and xylem. After crossing the cuticle and epidermis, NPs may move through mesophyll by either symplastic (within cells and through plasmodesmata) or apoplastic transport (through the extracellular space) to reach the phloem and be further transported from the exposed leaves to other plant organs. Phloem transports photosynthates (sugars) from photosynthetic organelles in mature leaves to younger leaves and roots. After being loaded into phloem, NP transport could still be regulated by sieve plates, callose and phloem proteins produced during plant immune responses. To reach other non-vascular plant organs other than the dosed leaf, the NPs also first must go through the vasculature in the stem. While being transported in phloem, NPs could also be exchanged from the phloem to the xylem, depending on the vascular structure of the plants and the properties of NPs. Finally, the NP unloading from phloem into other non-vascular tissue may also influence their distribution in plants.

NP physical and chemical properties can affect their interactions with different plant organelles and influence their transport behavior in plants. Systems have been studied where NPs having a size and net charge above critical values can penetrate cell membranes, enabling their entrance into mesophyll cells and chloroplasts. However, sizes exceeding a certain range could also inhibit NP colocalization with plant cells. Besides net charge, the sign of charge also affects NP affinity to different organelles, as negatively charged nanoceria delivered by needle-less syringe infiltration in buffer have shown higher colocalization with Arabidopsis thaliana chloroplasts than positively charged counterparts. However, positively charged NPs delivered by topical foliar application in surfactants are more efficiently delivered to chloroplasts in maize and cotton than their negatively charged counterparts. The physical and chemical properties of polymer carriers, including size, charge and hydrophobicity, could therefore all play important roles deciding their uptake, transport and biodistribution in plants organs after foliar exposure.

Polymer based nanocarriers are emerging materials for more efficient agrochemical delivery in plants. New materials, including star polymers (described above), have been developed for agent delivery and plant stress management through targeted delivery approaches. However, the properties affecting star polymer (nanocarrier) uptake and transport in plants have not yet been investigated. Star polymers consist of multiple polymer chain “arms” emanating from a central core. Since the arms of soluble star polymers are swollen with solvent, they are soft materials. As such, they may interact with plant compartments differently compared to rigid metal or metal oxide NPs. The general trends now emerging from metal/metal oxide NP-plant interaction studies may not be applicable for star polymers. In this study, PAA-b-PMSEA and PAA-b-P(MSEA-co-MTEA) star polymers with well-controlled sizes (6-35 nm, determined by degree of polymerization of their arms), negative charge content (determined by the charged AA monomer content) and hydrophobicity (determined by MSEA:MTEA ratio) were synthesized by atom transfer radical polymerization (ATRP). The total transport (phloem loading) efficiency and biodistribution of foliar applied star polymers in tomato plants were assessed by inductively coupled plasma mass spectrometry (ICP-MS). The route of uptake and interaction between star polymers and tomato leaves with or without surfactants was studied by Hyperspectral-Enhanced Dark Field Microscopy (DF-HSI). These studies revealed that the star polymer properties affected the delivery location, but not overall uptake efficiency.

### Materials and Methods

2-(Methylthio)ethanol (>99%), hydrogen peroxide solution (30%_{H2O2}, ACS grade), tris[2-(dimethylamino)ethyl]amine (Me₆Tren), anisole (99%), N,N-dimethylformamide (DMF, 99%), trifluoroacetic acid (TFA, 99%), gadolinium(II) chloride hexahydrate (GdCl₃·6H₂O, 99%), and HNO₃ (70%, trace metal grade) were purchased from Fisher Scientific. Acrylic acid (≥99%), tert-butyl acrylate (≥99%), N-(3-(dimethyl amino)propyl)-N′-ethylcarbodiimide hydrochloride (EDC, >99%), N,N-dimethyl aminopyridine (DMAP, >99%), copper bromide (≥99.99%), β-cyclodextrin (p-CD), 2-bromoisobutyryl bromide (BiBB, 98%), 1-methyl-2-pyrrolidone (NMP), methanol (99.8%), dichloromethane (DCM), sodium persulfate (98%), sodium sulfate (>99%), crystal violet (CV, >90%), and chloroform-d (CDCl₃) were purchased from Sigma Aldrich. Dialysis bags with various molecular weight cutoffs (Spectra/Por 7) were purchased from Spectrum Chemical Manufacturing Corp. SILWET® L-77 surfactant was purchased from PhytoTech labs, Inc. Tomato seeds (Roma VF) were purchased from Atlee Burpee & Co. Acrylate monomers were passed through a basic alumina column before use. Water was purified by Milli-Q IQ 7000 lab water system. Other chemicals were used without further purification.

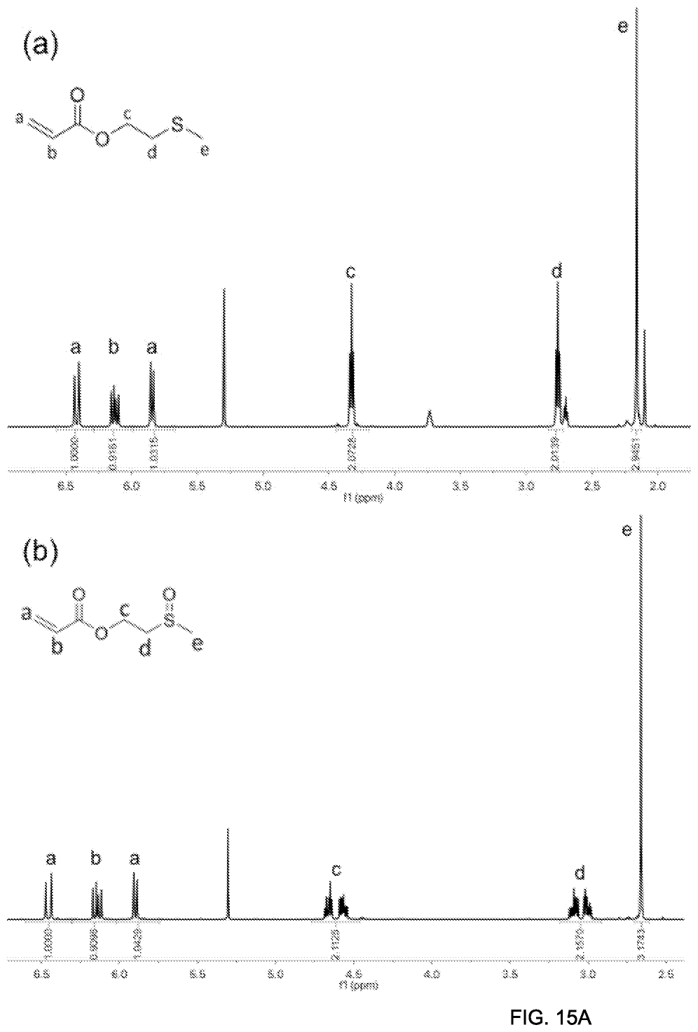

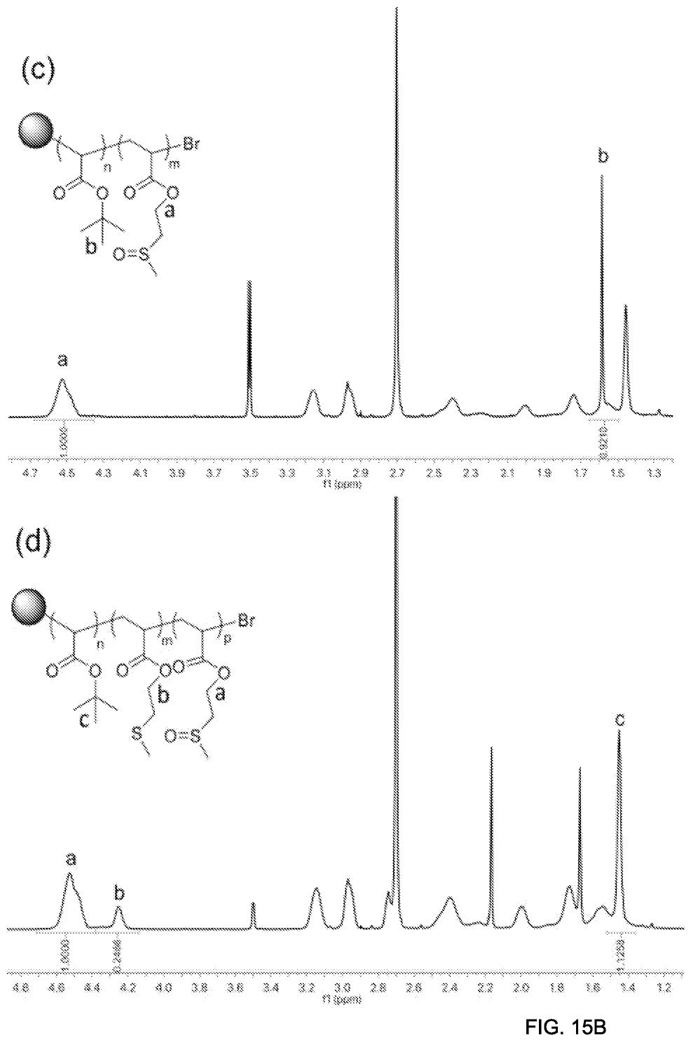

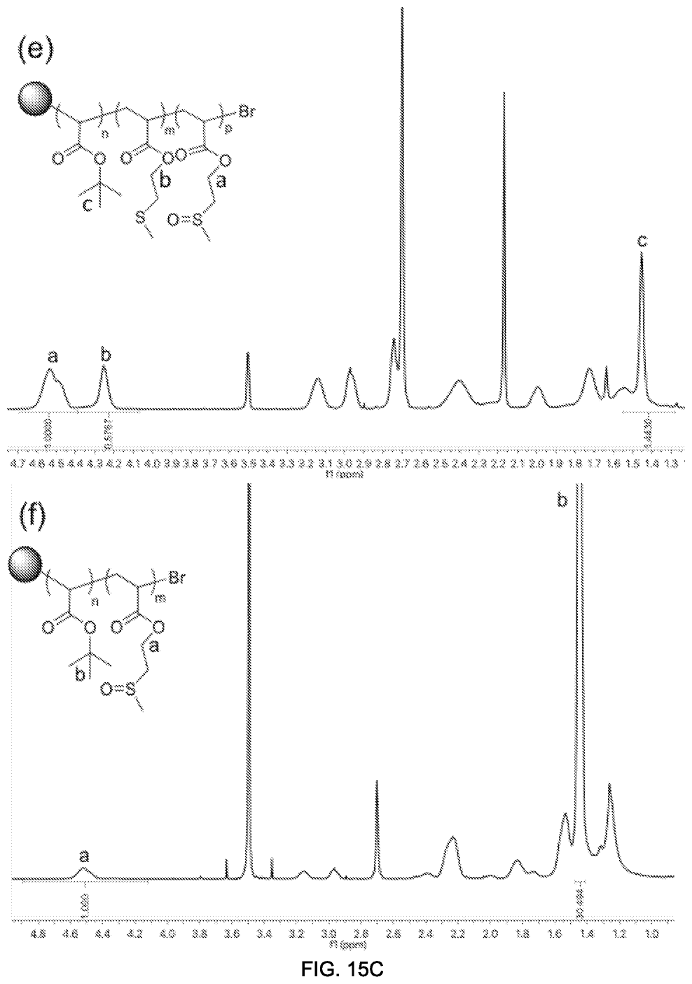

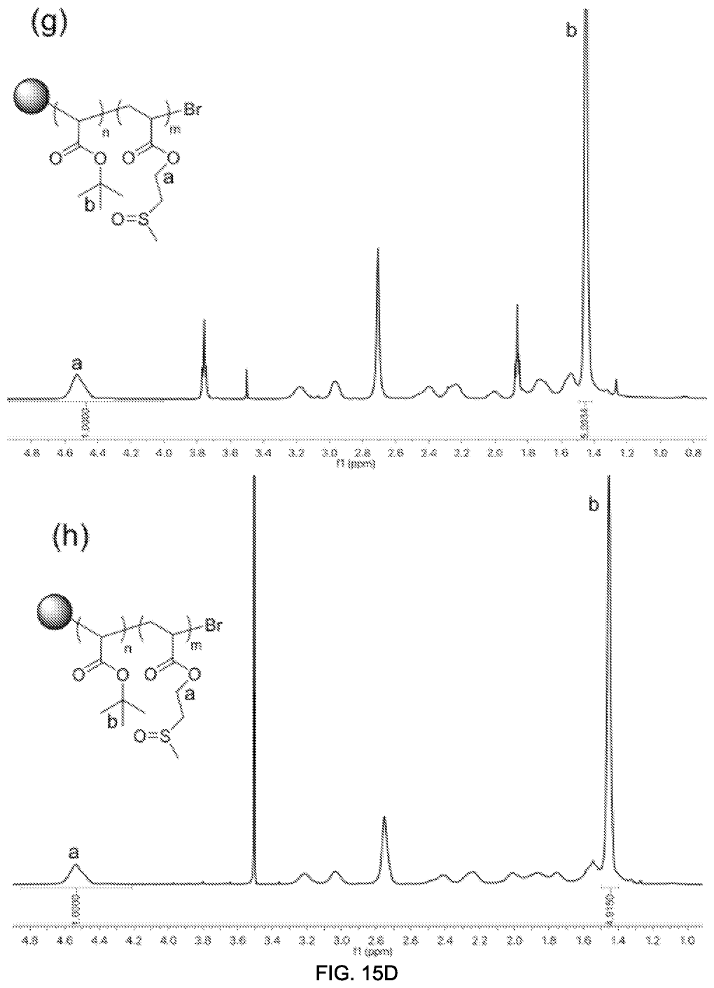

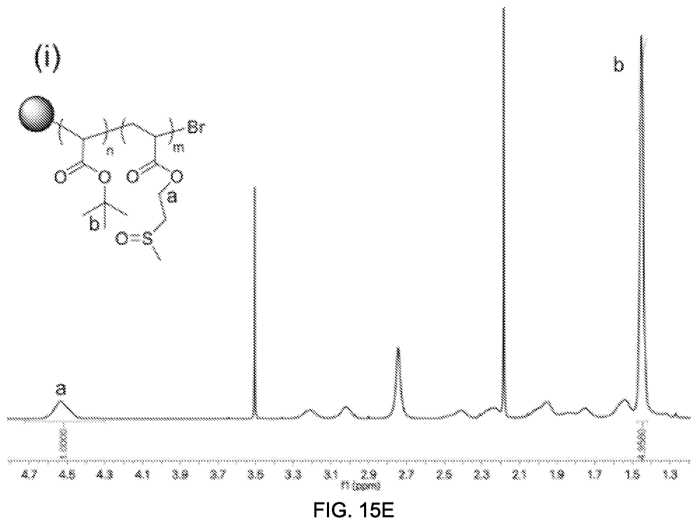

Synthesis of 2-(methylthio)ethyl acrylate (MTEA). Briefly, acrylic acid (8.6 g, 1.1 eq.), N-(3-Dimethylaminopropyl)-N′-ethylcarbodiimide hydrochloride (EDC-HCl, 24 g, 1.15 eq.) and 4-dimethylaminopyridine (DMAP, 1.89 g, 0.14 eq.) were dissolved into 200 mL dichloromethane (DCM) in a 500 mL round bottom flask equipped with a stir bar in ice bath. The reactor was sealed and purged with N₂ for 10 min. Then, 2-(Methylthio)ethanol (10 g, 1.0 eq.) was injected into the reactor. The reaction proceeded at room temperature for 24 h and reagent conversion was monitored by proton nuclear magnetic resonance (¹H NMR, Bruker 500 MHz NMR spectrometers). The product in DCM was washed by 0.1 M HCl (2×, 150 mL), followed by washing with saturated NaHCO₃ (2×, 150 mL) to remove residual reagents and washed by brine (1×, 150 mL) and followed by adding anhydrous Na₂SO₄ to remove residual water. DCM was removed by rotary evaporator (Buchi V-850). The purity of MTEA was confirmed by ¹H NMR (FIG. 15A).

Synthesis of 2-(methylsulfinyl)ethyl acrylate (MSEA). Five g MTEA was added into a glass vial sealed by a rubber stopper and equipped with a magnetic stir bar. The vial was kept in an ice bath and purged by N₂ for 5 min to remove water and oxygen. 3.8 g of 30% H₂O₂ solution was slowly added to MTEA by a syringe pump at 50 μL min⁻¹. The reaction proceeded for 24 h and was stopped by adding 50 mL MilliQ water. The MSEA in water was extracted three times into 100 mL DCM and passed through a column filled with 50 wt % anhydrous Na₂SO₄ and 50 wt % Na₂S₂Oₛ to remove water and H₂02. Excess solvent was removed by rotary evaporator to yield MSEA. The purity of MSEA is confirmed by ¹H NMR (FIG. 15A (b)).

Synthesis of 21-arm PAA-b-PMSEA and PAA-b-P(MSEA-co-MTEA) star polymers with different size, charge content and hydrophobicity. The PAA-b-PMSEA and PAA-b-P(MSEA-co-MTEA) star polymers with different size, charge content and shell hydrophobicity were made by a core-first approach. β-Cyclodextrin was first functionalized with 2-bromoisobutyryl bromide (BiBB) to yield an ATRP macroinitiator with 21 initiating sites (p-CD-21Br). The p-CD-21Br was then used to initiate ATRP of tBA, to make a 21-arm PtBA star polymer, with either 25, 75, 125, or 150 degree of polymerization (DP) in each arm. The arms in PtBA star polymers were then extended with different ratios of MSEA and MTEA to produce PtBA-b-PMSEA or PtBA-b-P(MSEA-co-MTEA) star polymers. The chemical composition of the star polymers were assessed by ¹H NMR and their dispersity was assessed by gel permeation chromatography (GPC). Star polymers with different size but similar compositions were made by varying the total DP in each arm from 50 to 300, while keeping the same monomer proportions. The star polymer charge content was adjusted by varying the molar ratio of the negatively charged PAA arms (core) and neutral PMSEA arms (shell). The star polymer hydrophobicity was adjusted by copolymerizing hydrophilic MSEA with hydrophobic MTEA in different ratios (FIG. 15A (a)).

Synthesis of PtBA core of star polymers with DP 25 in each arm. The PtBA core of star polymer was made by a core first approach. The β-CD-21Br ATRP Initiator was first synthesized according to previously published protocol (Pang, X.; Zhao, L.; Akinc, M.; Kim, J. K.; Lin, Z. Novel Amphiphilic Multi-Arm, Star-like Block Copolymers as Unimolecular Micelles. Macromolecules 2011, 44 (10), 3746-3752). The PtBA star polymer was then synthesized using Supplemental Activation Reducing Agent (SARA) ATRP. Briefly, β-CD-21 Br initiator (0.1 g, 1.0 eq.), tBA (3.16 g, 3.61 mL, 1050 eq.), copper (II) bromide (CuBr₂, 0.55 mg, 0.105 eq.), of Me₆TREN (1.7 μL, 0.2625 eq.) and copper wire (dia. 1.0 mm, length 1.0 cm) were added into 3.60 mL of anisole in a sealed Schlenk flask equipped with a stir bar. The reactor was degassed by purging with N₂ for 15 min and allowed to proceed at room temperature. The monomer conversion was monitored with ¹H NMR and stopped at ˜50% conversion to yield PtBA star polymers with 25 tBA repeat units in each arm. The products were purified by dialysis (MWCO=8,000 Da) in methanol for 3 cycles. Molecular weight (Mn) and molecular weight distribution (D) of the PtBA star polymers were measured by size exclusion chromatography equipped with a multi-angle light scattering detector. Star polymers with PtBA DP of 75, 125, and 150 were also prepared. Theirsynthesis procedures are documented in the SI.

Synthesis of PtBA₂₅-b-PMSEA₁₂₅ star polymer. The PtBA arms were extended with PMSEA blocks by UV light induced photo-ATRP. Briefly, 0.06 g of 25 DP PtBA star polymer (1 equiv), 0.713 g MSEA (5250 equiv), 0.98 mg CuBr₂ (5.25 equiv) and 0.0043 mL MeeTren (18.38 equiv) were dissolved in 4.40 mL DMF. The reaction was degassed by purging with N₂ for 15 min and proceeded under UV light (36 W) to activate the MeeTren ligand and reduce Cu(II) into Cu(I). The monomer conversion was monitored by ¹H NMR and stopped at ˜50% conversion to yield a PtBA₂₅-b-PMSEA₁₂₅ star polymer. The product was purified by dialysis against methanol for three cycles (MWCO=8000 Da) and the chemical composition of the product was verified by ¹H NMR.

Hydrolysis of PtBA-b-PMSEA and PtBA-b-P(MSEA-co-MTEA) star polymers. The PtBA in PtBA-b-PMSEA and PtBA-b-P(MSEA-co-MTEA) star polymers were selectively hydrolyzed by TFA to yield the corresponding PAA-b-PMSEA and PAA-b-P(MSEA-co-MTEA) star polymers. A 0.3 g mass of PtBA-b-PMSEA or PtBA-b-P(MSEA-co-MTEA) star polymer was dissolved in 10 mL DCM in a 25 mL glass vial with stirring. The polymer solution was placed in an ice bath and 1 mL of TFA was injected into the solution. The reaction was allowed to warm to room temperature and proceed for ˜24 h. The resulting solution was dialyzed against methanol for three cycles (MWCO=8000 Da) to remove excess TFA.

Plant growth. The tomato (Solanum lycopersicum) plants used in this study were cultured hydroponically with ¼ strength Hoagland's solution aerated using air pumps. This comparison of star polymer size, charge and hydrophobicity is conducted under conditions where plants have easy access to all necessary nutrients. Tomato seeds were rinsed by MilliQ water twice before they were surface sanitized with 10% bleach for 1 min, then thoroughly rinsed with MilliQ water five times. The sterilized seeds were kept in MilliQ water in the dark for 24 h before being germinated in a petri-dish on water-soaked filter paper in the dark for 10 days. The seedlings were then transplanted to 100 mL plastic cups. The plants were grown at lab temperature (˜20° C.) using a 16 h light:8 h dark cycle. Star polymers were foliarly applied to plants after 30 days of growth, in the vegetative stage with 5 to 6 true leaves, and before flowering.

Gd loading into star polymers for tracking their distribution in plants. Gd³⁺ was used as a marker to track star polymer uptake and distribution in plants. In a typical procedure, 20 mg of as synthesized star polymer was dissolved into 5 mL of 0.05 M NaOH water solution in an ice bath with sonication (iSonic P4800). The pH of the polymer solution was then adjusted to 6.5 using aliquots of 0.1 M HCl. 50 mg of GdCl₃·6H₂O was then added into the PAA₂₅-b-PMSEA₂₅, PAA₂₅-b-PMSEA₁₂₅, PAA₇₅-b-PMSEA₇₅ star polymer solutions and 10 mg of GdCl₃·6H₂O was added to PAA₁₂₅-b-PMSEA₂₅, PAA₁₅₀-b-PMSEA₁₅₀, PAA₂₅-b-P(MSEA₁₀₀-co-MTEA₂₅) and PAA₂₅-b-P(MSEA₇₅-co-MTEA₅₀) star polymer solutions. Less Gd was added for some polymers to avoid star polymer precipitation. As polymer precipitation cause the solution to become cloudy. The solutions were vortex mixed for 24 h to allow partitioning of Gd³⁺ into the PAA core of the star polymers before being dialyzed against 200 mL MilliQ water for seven cycles until free Gd concentration in the dialysate contains less than 0.1% of Gd loaded in star polymers (MWCO=8000 Da). The Gd loaded star polymer samples (0.05 mL) were digested by 0.5 mL of 70% HNO₃ at room temperature for 30 min, then diluted to 5 mL with MilliQ water before analyzed by ICP-MS (Agilent 7700X). Gd loading results are shown in Table 4. The stability of Gd loaded star polymer in plant leaves was evaluated in simulated leaf apoplastic fluid at pH 5.5 (Table 5). The Gd leaching result is shown in Table 6. Less than 0.5% of loaded Gd leached out of Gd loaded star polymers in simulated plant apoplastic fluid after 24 h.

TABLE 4
Gd loading into different star polymers
and free Gd detected outside of the dialysis bag.

| | Gd loading in | Mole of Gd | Free Gd out of |
|---|---|---|---|
| | star polymers | per mole | star polymers |
| Sample name | (mg L⁻¹) | of AA | (mg L⁻¹) |
| PAA₂₅-b-PMSEA₂₅ | 302.1 | 0.45 | 0.011 |
| PAA₇₅-b-PMSEA₇₅ | 314.7 | 0.48 | 0.012 |
| PAA₁₅₀-b-PMSEA₁₅₀ | 136.6 | 0.21 | 0.0025 |
| PAA₂₅-b-PMSEA₁₂₅ | 151.3 | 0.64 | 0.026 |
| PAA₂₅-b-P(MSEA₁₀₀-co- | 169.2 | 0.70 | 0.066 |
| MTEA₂₅) | | | |
| PAA₂₅-b-P(MSEA₇₅-co- | 203.9 | 0.83 | 0.002 |
| MTEA₅₀) | | | |
| PAA₁₂₅-b-PMSEA₂₅ | 195.1 | 0.13 | 0.02 |

TABLE 5
Composition of simulated apoplastic fluid with pH 5.5.

| Solute | Concentration (mM) | Chemical used |
|---|---|---|
| Sucrose | 1.6 | 1.6 mM sucrose |
| K⁺ | 12.8 | 4.7 mM KNO₃ |
| | | 8.1 mM KCl |
| Na⁺ | 0.4 | 0.4 mM NaCl |
| Mg²⁺ | 0.7 | 0.7 mM MgCl₂ |
| Ca²⁺ | 0.7 | 0.7 mM CaCl₂ |
| Amino acid | 9.6 | 9.6 mM glutamine |
| NO₃⁻ | 4.7 | From KNO₃ |
| Cl⁻ | 10.5 | From KCl, NaCl, |
| | | MgCl₂, CaCl₂ |

TABLE 6
Concentration of Gd remaining in star polymers and
free Gd outside of the star polymer after dialyzing 2 mL of
Gd loaded star polymer in 100 mL simulated apoplastic fluid.

| | Gd remain in star | Free Gd out of |
|---|---|---|
| | polymer suspension | star polymers |
| Sample name | (mg L⁻¹) | (mg L⁻¹) |
| PAA₂₅-b-PMSEA₂₅ | 98.5 | 0.13 |
| PAA₇₅-b-PMSEA₇₅ | 176.6 | 0.19 |
| PAA₁₅₀-b-PMSEA₁₅₀ | 66.0 | 0.04 |
| PAA₂₅-b-PMSEA₁₂₅ | 61.0 | 0.30 |
| PAA₂₅-b-P(MSEA₁₀₀-co- | 62.2 | 0.19 |
| MTEA₂₅) | | |
| PAA₂₅-b-P(MSEA₇₅-co- | 72.9 | 0.17 |
| MTEA₅₀) | | |
| PAA₁₂₅-b-PMSEA₂₅ | 159.4 | 0.21 |

Star polymer foliar exposure, uptake and transport in tomato plants. The Gd-loaded star polymers were applied to tomato leaves in aqueous 0.1 vol % SILWET® L-77 spreading agent solution to promote spreading on the leaf surface. SILWET® L-77 is a nonionic agricultural surfactant commonly used as a wetting agent for agrochemical sprays. Each treatment included 5-6 replicate plants. All of the star polymers were well dispersed before foliar application (Table 7). We deposited 20 μL of a 1 g L⁻¹ star polymer solution as 4 drops of 5 μL each (20 μg of star polymer total). Each drop was applied to a different location on the adaxial side of the second true leaf to fully cover the leaf. One gram per liter star polymer concentration was used as this concentration of a similar polymer did not cause a significant toxicity effect to plants in our previous study.² The plants were harvested three days after exposure, consistent with our previous study.² Each plant was cut into five parts: leaf where the Gd-loaded star solutions were applied (denoted as “exposed zone”), leaves at growth stages lower than the exposed leaves (denoted as “younger leaf”), leaves at growth stages higher than exposed leaves (denoted as “older leaf”), stem of the plant (denoted as “stem”), and roots (denoted as “root”).

TABLE 7
Calculated number average molecular weight (Mₙ), apparent zeta
potential and electrophoretic mobility (EPM) of unloaded
PAA-b-PMSEA and PAA-b-P(MSEA-co-MTEA) star polymers and
EPM, number average hydrodynamic diameter (Dₕ) of Gd loaded star polymers.

| | | Apparent | | EPM of | |
|---|---|---|---|---|---|
| | | zeta | EPM^{c} | Gd-star^{d} | Dₕ of |
| | M_{n,th} | potential | (μm cm | (μm cm | Gd-star |
| Star polymers^{a} | (g mol⁻¹)^{b} | (mV)^{c} | V⁻¹ s⁻¹) | V⁻¹ s⁻¹) | (nm)^{e} |
| PAA₂₅-b-PMSEA₂₅ | 1.27 × 10⁵ | −31.2 ± 2.7 | −2.44 ± 0.21 | −1.77 ± 0.18 | 8.9 ± 1.7 |
| PAA₁₅₀-b-PMSEA₁₅₀ | 7.41 × 10⁵ | −21.4 ± 6.8 | −1.68 ± 0.61 | −2.38 ± 0.21 | 47.1 ± 1.1 |
| PAA₇₅-b-PMSEA₇₅ | 3.73 × 10⁵ | −37.7 ± 1.9 | −3.31 ± 0.1 | −2.09 ± 0.04 | 26.1 ± 3.5 |
| PAA₁₂₅-b-PMSEA₂₅ | 2.78 × 10⁵ | −32.8 ± 2.3 | −2.57 ± 0.22 | −2.48 ± 0.05 | 29.5 ± 2.6 |
| PAA₂₅-b-PMSEA₁₂₅ | 4.67 × 10⁵ | −30.9 ± 4.8 | −3.06 ± 0.37 | −0.94 ± 0.06 | 23.2 ± 2.7 |
| PAA₂₅-b-P(MSEA₁₀₀- | 4.59 × 10⁵ | −25.3 ± 1.9 | −1.55 ± 0.12 | −1.83 ± 0.07 | 26.0 ± 4.0 |
| co-MTEA₂₅) | | | | | |
| PAA₂₅-b-P(MSEA₇₅- | 4.51 × 10⁵ | −26.7 ± 3.5 | −1.99 ± 0.14 | −1.88 ± 0.06 | 19.9 ± 1.3 |
| co-MTEA₅₀) | | | | | |

^{a}The molar ratio between PAA, PMSEA and PMTEA was confirmed by ¹H NMR.
^{b}Theoretical number average molecular weight of star polymers calculated by their compositions.
^{c}Number average hydrodynamic diameter measured by DLS at 100 mg L⁻¹ star polymer concentration at pH 6.5 in 10 mM NaCl.
^{d}Electrophoretic mobility of Gd loaded star polymers applied in tomato plants measured in 10 mM NaCl at pH 6.5 with 100 mg L⁻¹ star polymer concentration. Zeta potential was converted from electrophoretic mobility based on Smoluchowski equation.
^{e}Number average hydrodynamic diameter measured by DLS at 100 mg L⁻¹ Gd-loaded star polymer concentration at pH 6.5 in 10 mM NaCl.

To determine star polymer transport to different plant compartments, the Gd³⁺ content in different plant tissues were measured. All plant samples were first dried at 105° C. for 24 h to remove water. The dried plant tissues were weighed and digested overnight at room temperature with 1 mL of a 2:1 mixture of 70% HNO₃ and 30% H₂02, followed by heating at 100° C. for 45 min.^{2,34} Post digestion, the samples were diluted to 5% HNO₃ by MilliQ water and filtered through a 0.45 μm PTFE syringe filter before analysis by ICP-MS.

Crystal violet loading and star polymer foliar application to image NP-leaf interactions.

To assess star polymer-leaf interactions, the star polymers were loaded with crystal violet (CV) before foliar exposure and imaging. Briefly, 10 mg PAA₂₅-b-PMSEA₁₂₅ or PAA₂₅-b-P(MSEA₇₅-co-MTEA₅₀) star polymers was dissolved into 5 mL of 0.05 M NaOH water solution in an ice bath with sonication. The pH of the polymer solution was then adjusted to 6.5 by 0.1 M NaOH and HCl. 1 mg of CV was then added into the star polymer solutions and vortex mixed for 24 h. The solution was dialyzed against 1 L of MilliQ water (MWCO=8000) to remove free CV. The integrity of CV loading within similar star polymers based on PAA binding at 20° C. was confirmed experimentally as described above.

The CV-loaded star polymer solutions were mixed with or without 0.1 vol % SILWET® L-77 surfactant before foliar application. Four drops of 5 μL CV-loaded star polymer solution at 1 g L⁻¹ polymer concentration was applied. The exposed leaves were incubated for 2 days before imaging to assess the star polymer leaf uptake pathway with or without SILWET® L-77. While different from the star polymer translocation assessment, 2 days is sufficient to observe the differences.

Imaging polymer-leaf interactions. The distribution of CV-loaded star polymers in tomato leaves was assessed using an enhanced dark-field microscope coupled to a hyperspectral imaging system (CytoViva Inc.). Briefly, an enhanced resolution dark-field microscope system (BX51, Olympus,) was equipped with a 150 W halogen light source and a hyperspectral camera (CytoViva hyperspectral imaging system 1.4). The leaves were imaged in air at 10× or in oil immersion at 60× magnification. Hyperspectral images were acquired using 75% light source intensity and 0.1 to 0.5 s acquisition per line and corrected for the lamp contribution. The focal planes for hyperspectral images included the leaf surface (above the cuticle) and the epidermis cell layer. The spectral library for hyperspectral mapping was built using images of CV-loaded star polymers in plant leaves as described in SI. The spectral library was used to identify pixels with CV-loaded star polymers in order to map their locations in exposed leaves using spectral angle mapping (SAM, ENVI 5.2).

The loaded star-polymer spectral libraries were built based on images of the star polymer on leaves, using the following steps according to previous literature: (i) Spectral data reduction: The images were transformed into minimum noise fraction (MNF) images, where a noise covalence matrix is used to decorrelate and rescale the noise in the data. Coherent MNF images (containing spectral information with minimal noise) can then be separated from the noise-dominated ones. (ii) Endmember identification and pre-library building: A pixel purity index serves to find the most spectrally pure pixels in the images. This PPI is used as an input parameter in an n-dimensional visualizer (n is the number of reflectance spectra or pixels), in which an n-dimensional vector represents each spectrum. This visualization allows identifying and grouping the purest pixels, i.e., the most extreme spectral responses (here termed endmembers). The endmembers constitute the pre-library. The pre-library can still contain some spectra of materials other than the loaded star polymer. (iii) Endmembers Library building: The hyperspectral libraries were filtered using the “spectral filter” option of the software ENVI 5.2. During that step all of the hyperspectral signal coming from a control leaf were filtered out. This was done using a spectral angular mapping algorithm (SAM). The SAM algorithm provides a measure for the similarity between 2 spectrums (here between the one in the pre-library and the ones on the pixels of a control image) calculating the angle between the two spectra (again treated as n-dimensional vectors). The angle for SAM processing was set as the lowest level allowing the identification of endmembers in their own pictures (i.e., 0.085 rad). Vectors with angles 50.085 rad were considered as similar. The spectra (vectors) in the pre-library that matched pixels on hyperspectral images of the negative control leaves were considered as false positives and removed from the pre-library. The remaining spectra built the final hyperspectral library (i.e., a hyperspectral loaded star polymer specific signature).

### Results and Discussion

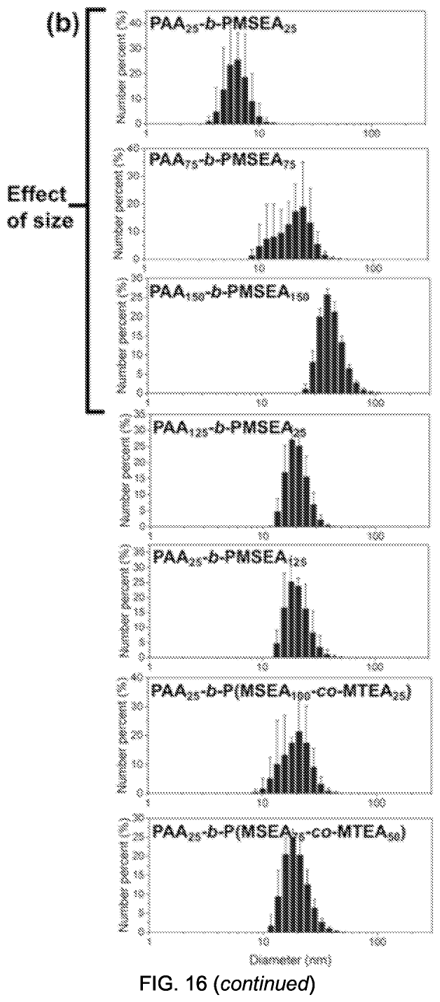

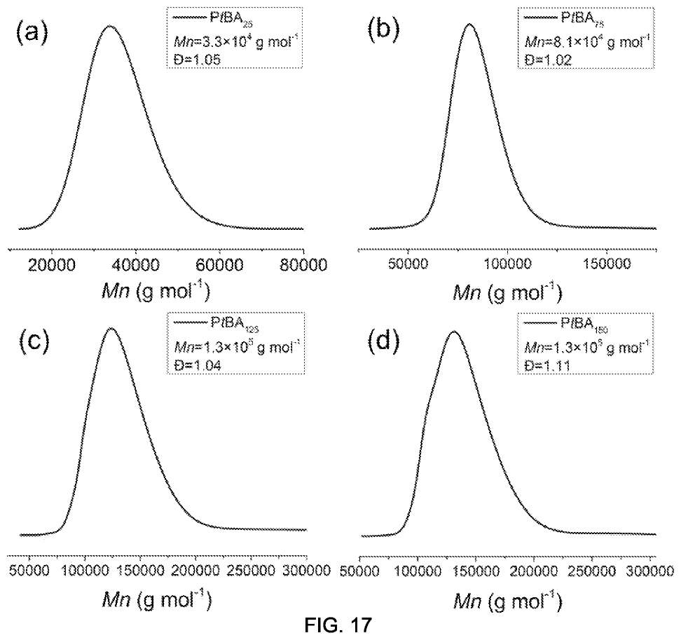

Synthesis and characterization of star polymers with different size, charge content and hydrophobicity. The theoretical molecular weight and chemical compositions of PAA-b-PMSEA and PAA-b-P(MSEA-co-MTEA) star polymers were calculated according to the molar ratios between PtBA, PMSEA and PMTEA in each star polymer, measured by ¹H NMR (FIGS. 15A-15E). The calculated number average molecular weights (Mₙ) of the different star polymers are shown in Table 3. The low dispersity of the star polymers was confirmed by GPC. PtBA star polymers having arms with DP=25, 75, 125 and 150 DP had dispersity D=1.05, 1.02, 1.04 and 1.11, respectively (FIG. 17).

Synthesis of 21-Armed PAA-b-PMSEA and PAA-b-P(MSEA-Co-MTEA) Star Polymers with Different Size, Charge Content, and Hydrophobicity.

Synthesis of PtBA core of star polymers with 75DP in each arm. The PtBA star polymer with 75 tBA repeat units in each arm was made by first adding 0.08 g of β-CD-21 Br initiator (β-CD-21 Br, 1 equiv), 8.65 mL of tBA (3150 equiv), 1.32 mg of CuBr₂ (0.315 equiv), 0.0041 mL of MeeTren (0.7875 equiv) and 1 cm Cu⁰ wire to 8.65 mL of anisole in a sealed Schlenk flask equipped with a stir bar. The reaction was degassed by purging with N₂ for 30 min and proceed under room temperature. The reaction was monitored by ¹H NMR and stopped at ˜50% conversion to yield PtBA star polymers with 75 tBA repeat units in each arm.

Synthesis of PtBA core of star polymers with 125DP in each arm. The PtBA star polymer with 125 tBA repeat units in each arm was made by first adding 0.025 g of β-CD-21 Br initiator (β-CD-21 Br, 1 equiv), 4.51 mL of tBA (5250 equiv), 0.687 mg of CuBr₂ (0.525 equiv), 0.00214 mL of Me₆Tren (1.3125 equiv) and 1 cm Cu⁰ wire to 4.51 mL of anisole in a sealed Schlenk flask equipped with a stir bar. The reaction was degassed by purging with N₂ for 15 min and proceed under room temperature. The reaction was monitored by ¹H NMR and stopped at ˜50% conversion to yield PtBA star polymers with 125 tBA repeat units in each arm.

Synthesis of PtBA core of star polymers with 150DP in each arm. The PtBA star polymer with 150 tBA repeat units in each arm was made by first adding 0.03 g of β-CD-21 Br initiator (β-CD-21 Br, 1 equiv), 6.49 mL of tBA (6300 equiv), 0.989 mg of CuBr₂ (0.63 equiv), 0.00308 mL of Me₆Tren (1.575 equiv) and 1 cm Cu⁰ wire to 6.49 mL of anisole in a sealed Schlenk flask equipped with a stir bar. The reaction was degassed by purging with N₂ for 30 min and proceed under room temperature. The reaction was monitored by ¹H NMR and stopped at ˜50% conversion to yield PtBA star polymers with 150 tBA repeat units in each arm.

Synthesis of PtBA₂₅-b-P(MSEA₇₅-co-MTEA₅₀) star polymer. The synthesis of PtBA₂₅-b-P(MSEA₇₅-co-MTEA₅₀) star polymer followed the same protocol as above. Briefly, 0.05 g of 25 DP PtBA star polymer (1 equiv), 0.594 g of MSEA (5250 equiv), 0.357 g of MTEA (3500 equiv), 1.37 mg of CuBr₂ (8.75 equiv), 0.0102 mL Me₆Tren (52.5 equiv) were dissolved in 5.87 mL of DMF. The reaction was degassed by purging N₂ for 15 min and proceed under UV light. The monomer conversion was monitored by ¹H NMR and stopped at ˜30% conversion to yield PtBA₂₅-b-P(MSEA₇₅-co-MTEA₅₀) star polymer.

Synthesis of PtBA₂₅-b-PMSEA₂₅ star polymer. The synthesis of PtBA₂₅-b-PMSEA₂₅ star polymer followed the same protocol as above. Briefly, 0.25 g of 25 DP PtBA star polymer (1 equiv), 0.594 g MSEA (1050 equiv), 0.41 mg CuBr₂ (0.525 equiv) and 0.0031 mL Me₆Tren (3.15 equiv) were dissolved in 4 mL DMF. The reaction was degassed by purging N₂ for 15 min and proceeded under UV light. The monomer conversion was monitored by ¹H NMR and stopped at ˜50% conversion to yield PtBA₂₅-b-PMSEA₂₅ star polymer.

Synthesis of PtBA₇₅-b-PMSEA₇₅ star polymer. The synthesis of PtBA₇₅-b-PMSEA₇₅ star polymer followed the same protocol as above. Briefly, 0.15 g of 75 DP PtBA star polymer (1 equiv), 0.62 g MSEA (5250 equiv), 0.85 mg CuBr₂ (5.25 equiv) and 0.0064 mL Me₆Tren (31.5 equiv) were dissolved in 5.74 mL DMF. The reaction was degassed by purging N₂ for 20 min and proceeded under UV light. The monomer conversion was monitored by ¹H NMR and stopped at ˜30% conversion to yield PtBA₇₅-b-PMSEA₇₅ star polymer.

Synthesis of PtBA₁₂₅-b-PMSEA₂₅ star polymer. The synthesis of PtBA₁₂₅-b-PMSEA₂₅ star polymer followed the same protocol as above. Briefly, 0.5 g of 125 DP PtBA star polymer (1 equiv), 0.249 g MSEA (1050 equiv), 0.17 mg CuBr₂ (0.525 equiv) and 0.00075 mL Me₆Tren (1.84 equiv) were dissolved in 3.1 mL DMF. The reaction was degassed by purging N₂ for 15 min and proceeded under UV light. The monomer conversion was monitored by ¹H NMR and stopped at ˜50% conversion to yield PtBA₁₂₅-b-PMSEA₂₅ star polymer.

Synthesis of PtBA₁₅₀-b-PMSEA₁₅₀ star polymer. The synthesis of PtBA₁₅₀-b-PMSEA₁₅₀ star polymer followed the same protocol as above. Briefly, 0.25 g of 150 DP PtBA star polymer (1 equiv), 0.625 g MSEA (6300 equiv), 0.86 mg CuBr₂ (6.3 equiv) and 0.0064 mL Me₆Tren (37.8 equiv) were dissolved in 3.86 mL DMF. The reaction was degassed by purging N₂ for 15 min and proceeded under UV light. The monomer conversion was monitored by ¹H NMR and stopped at ˜50% conversion to yield PtBA₁₅₀-b-PMSEA₁₅₀ star polymer.

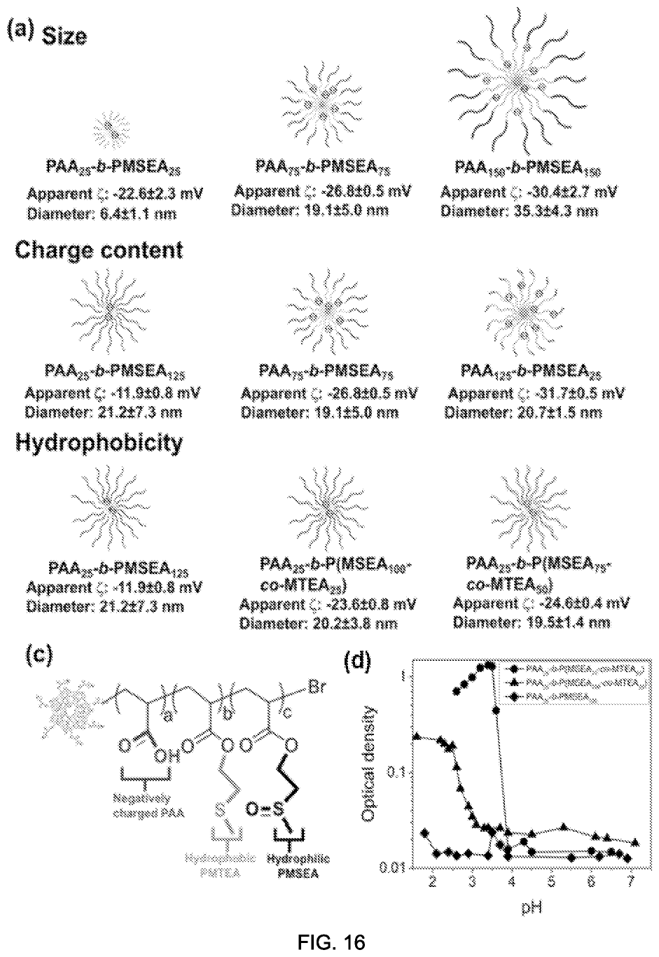

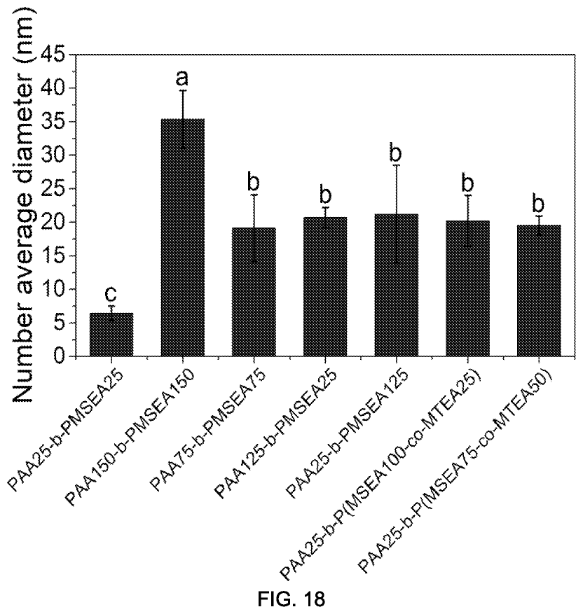

The size, charge content and hydrophobicity of the star polymers were adjusted by varying the length and chemical composition of polymer arms (FIG. 16 (a,c)). As shown in FIG. 16 (a) and FIGS. 15A-15E, the PAA₂₅-b-PMSEA₂₅, PAA₇₅-b-PMSEA₇₅ and PAA₁₅₀-b-PMSEA₁₅₀ star polymers, with the same 1:1 PAA to PMSEA molar ratio, have hydrodynamic diameters ranging from 6 nm for the smallest polymer to 35 nm for the largest polymer (FIG. 16 (b), FIG. 18). The electrophoretic mobility was measured in similar solutions using a Malvern zetasizer. Apparent zeta potentials (ζ), recognizing that such potentials are only apparent when applying the rigid particle Smoluchowski model to soft colloids, ranged from −22.6±2.3 to −30.4±2.7 mV (FIG. 16 (a)). The electrophoretic mobility was measured with Gd-loaded star polymers to represent the properties of the polymers tracked in leaves.

The PAA₂₅-b-PMSEA₁₂₅, PAA₇₅-b-PMSEA₇₅, and PAA₁₂₅-b-PMSEA₂₅, star polymers have different relative amounts of PAA and PMSEA, ranging from 17% PAA for the least charged polymer to 83% PAA repeating units in each arm for the most highly charged sample (FIG. 16 (a), FIGS. 15B, 15C, and 15D (c,f,g)). With arms of different PAA:PMSEA ratios but a constant total DP, these star polymers have similar hydrodynamic diameters of ˜20 nm and increasingly negative zeta potentials with increasing PAA content (FIG. 16 (a,b), FIG. 18). The Gd-loaded PAA₁₂₅-b-PMSEA₂₅ star polymer had the most negative ζ of −31.7±0.6 mV (EPM of −2.48±0.05 μm cm V⁻¹ s⁻¹), while the PAA₂₅-b-PMSEA₁₂₅ star polymer had the least negative ζ of −11.9±0.8 mV (EPM of −0.94±0.06 μm cm V⁻¹ s⁻¹) (FIG. 16 (a), Table 7).

The hydrophilic MSEA was co-polymerized with 20-40% hydrophobic MTEA to synthesize star polymers with different hydrophobicity (FIG. 16 (a,c)). Polymer hydrophobicity was assessed by measuring the optical density at 541 nm (Agilent Cary 5000) of solutions in 1 cm square cuvettes (0.5 g L⁻¹) as a function of pH at 20° C. At pH<4, PAA protonation decreases the charge and electrostatic repulsion between star polymers, allowing the hydrophobic MTEA block to drive aggregation. As shown in FIG. 16 (d), the most hydrophobic PAA₂₅-b-P(MSEA₇₅-co-MTEA₅₀) star polymers aggregated at pH ˜4, while the relatively less hydrophobic PAA₂₅-b-P(MSEA₁₀₀-co-MTEA₂₅) star polymer did not aggregate until pH<3.0, and the hydrophilic PAA₂₅-b-PMSEA₁₂₅ star polymer did not aggregate even at pH<2.0. Star polymer with less MTEA require lower pH and more charge neutralization to allow aggregation. The dispersability of the more hydrophobic star polymers in water is a result of the electrostatic charge residing in the PAA blocks of each star polymer.

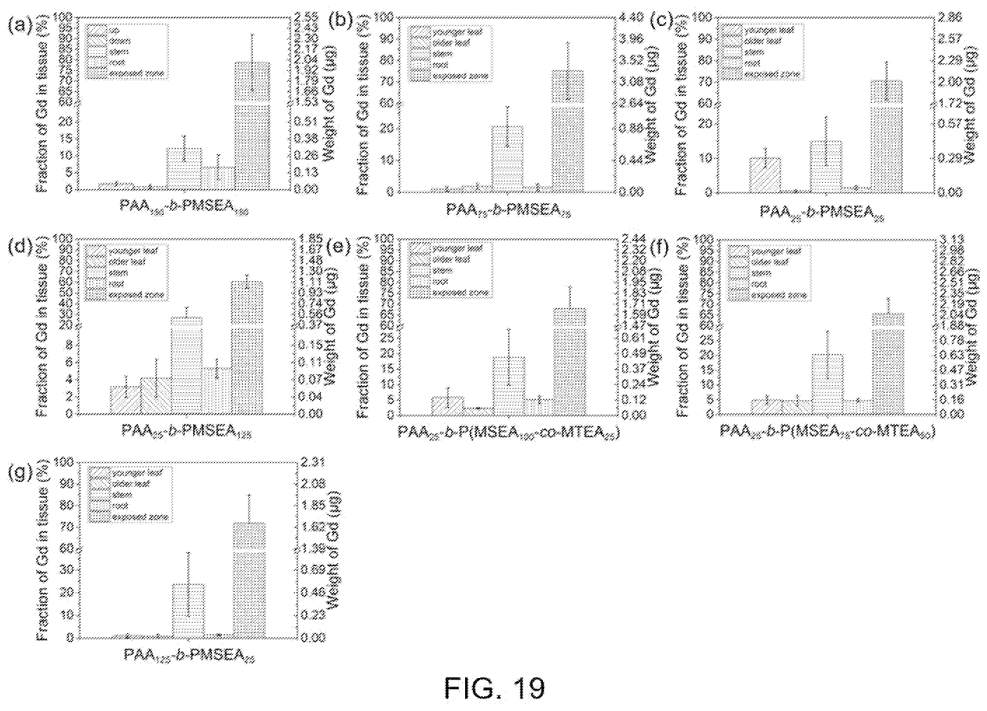

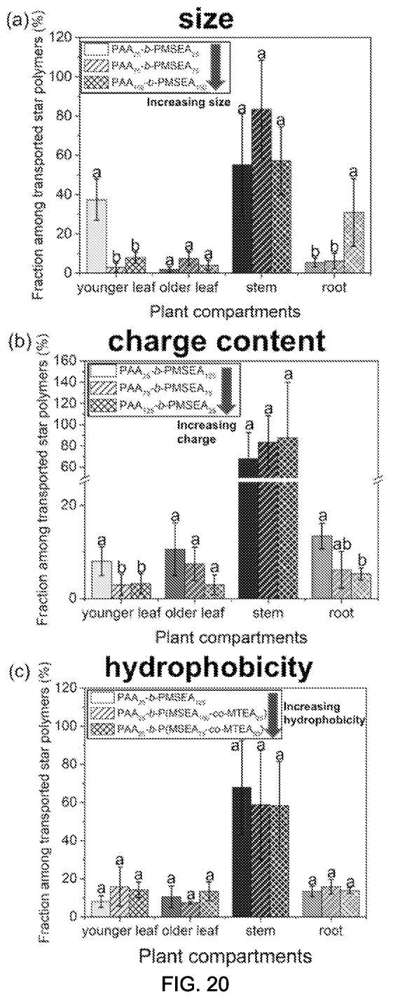

Star polymer uptake and phloem loading. Tomato plants (Solanum lycopersicum) were used as model system to evaluate star polymer uptake, phloem loading and transport after foliar application. The star polymers that have moved from the exposed leaf to other plant organs are assumed to have been loaded into the phloem translocated to stem, roots, and young leaves as the phloem is the vascular tissue responsible for long distance transport of photosynthetic products from mature leaves to these organs. FIG. 19 shows the Gd mass and percent of total applied Gd found in different plant organs. To better visualize how the star polymer properties affected transport, FIG. 20 shows the percent of the phloem loaded star polymers that have transported to different plant organs.

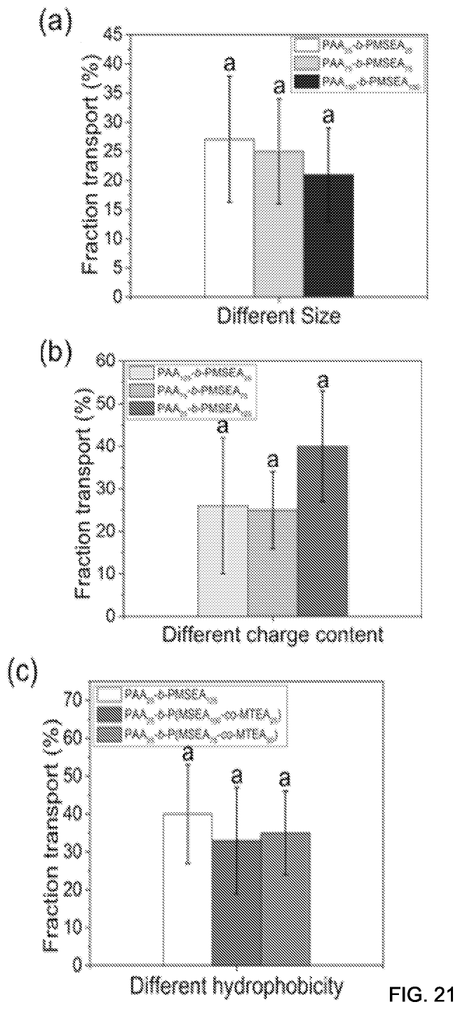

In our previous study, 1.4-2% of the star polymer was observed to transport out of exposed leaf without SILWET® L-77. When star polymers are applied with a commonly used surfactant SILWET® L-77, all of the star polymers showed similar ˜30±7% phloem transport after 3 days after exposure, regardless of size, negative charge content and hydrophobicity (FIG. 19 (a-g), FIG. 21). The leaf phloem loading process is not significantly affected by these properties for these star polymers. Also, the size cutoff for star polymer phloem loading and translocation is evidently larger than 35 nm in tomato plants (a dicot). This is larger than the previously reported size exclusion limits (-20 nm) estimated for engineered metal and metal oxide NP transport in pea (Pisum sativum) plants. From 15-24% of the applied star polymer mass ended up in the stem of the plant, with no specific trend in the accumulated mass observed for the different star polymer properties (FIG. 19 (a-g)). Because not all of the applied polymer was phloem loaded, this corresponds to a majority (-55-83%) of the phloem loaded star polymers that end up in the stem (FIG. 20). This is consistent with a previous study of foliar application a PAA-b-PNIPAm star polymer on tomato plants. However, some fraction of the star polymers were also found in older leaves for all of the polymer architectures used here (FIG. 20), suggesting some xylem transport. Mature leaves stop importing phloem materials from the rest of the plant and begin to export photosynthesis products through phloem.

Therefore, in older leaves as fully mature leaves, phloem sap flow goes outwards and the star polymers could transport to older leaves only through xylem flow. The exchange of sap that occurs between the phloem and xylem is the most likely explanation for this observation. The star polymer treatments did not show significant differences in their transport to older leaves indicating that the polymer design parameters did not significantly affect phloem-xylem nanoparticle exchange.

Effect of size on star polymer transport in plants. The PAA₂₅-b-PMSEA₂₅, PAA₇₅-b-PMSEA₇₅ and PAA₁₅₀-b-PMSEA₁₅₀ star polymers with similar charge content (50% negatively charged PAA, FIGS. 15D and 15E (g,h,i)) but different sizes ranging from 6 to 35 nm have different distributions in the plant compartments. According to FIG. 19 (a,b,c), the small (6 nm) PAA₂₅-b-PMSEA₂₅ star polymer (FIG. 19 (c)) moved more readily to the younger leaves of tomato plants, with approximately 10% of the applied mass ending up in the younger leaves. This corresponds to 37.4% of the phloem loaded star polymers, and is over four times higher than the transport of larger 20-35 nm star polymers to younger leaves (P≤0.05) (FIG. 20 (a)). Phloem unloading is needed for star polymers to access non-vascular compartments, and requires a symplastic transport step in leaves. Previous studies have suggested that smaller NPs may favor symplastic transport because the size cutoffs for NP transport through cell walls and plasmodesmata are considered to be ˜20 nm. This size exclusion effect on NPs moving between vascular and non-vascular tissue may be inhibiting more of the larger star polymers from getting into younger leaves. However, a finite fraction of the larger star polymers did make it to the younger leaves, so the 20 nm size cutoff is not strict.

The largest PAA₁₅₀-b-PMSEA₁₅₀ star polymer (35 nm) was mostly distributed to the stem and roots (FIG. 19 (a)). With 30.9% of the phloem-loaded PAA₁₅₀-b-PMSEA₁₅₀ star polymers found in roots (FIG. 20 (a)), this was more than five times higher root accumulation compared to the sub-20 nm star polymers (P≤0.05). The default pathway of root phloem unloading is through apoplasts, especially in the root cell expansion zone. Apoplastic transport in plants should be favored for larger NPs, while the smaller NPs more likely transport through symplastic pathways. Therefore, the higher accumulation of larger star polymers in roots could be explained by higher phloem unloading of large star polymers through an apoplastic pathway. Similarly, 3 nm AuNPs were found to transport preferentially to young shoots of plants, while the larger sized (50 nm) AuNPs tended to accumulate in plant roots after foliar application. This suggests that star polymers and rigid metal NPs may behave similarly in this regard.

Effect of charge content on star polymer transport in plants. Negative charge content also significantly affected the distribution of star polymers after foliar exposure. The Gd-loaded PAA₂₅-b-PMSEA₁₂₅ star polymers, with a smaller magnitude apparent (-potential (−11.9±0.8 mV and EPM −0.94±0.06 μm cm V⁻¹ s⁻¹) compared to PAA₇₅-b-PMSEA₇₅ (ζ-potential=−26.8±0.5 mV, EPM=−2.09±0.04 μm cm V⁻¹ s⁻¹) and PAA₁₂₅-b-PMSEA₂₅ (ζ-potential=−31.7±0.5 mV, EPM=−2.48±0.05 μm cm V⁻¹ s⁻¹), had greater transport into non-vascular tissues (FIG. 19 (b,d,g) and FIG. 20 (b)). The fraction of phloem-loaded PAA₂₅-b-PMSEA₁₂₅ star polymers transported into younger leaves and roots is twice that of the higher charge content PAA₇₅-b-PMSEA₇₅ and PAA₁₂₅-b-PMSEA₂₅ star polymers (FIG. 20 (b)). Thus, the lower charge content star polymers facilitate long distance transport through the vasculature to other plant organs.

The reasons for the influence of charge on translocation are likely a result of tissue-star polymer interactions. The star polymers with higher charge content and thinner neutral PMSEA passivation shell present a more negative electrical potential to plant mesophyll and phloem conducting cells. The PAA₇₅-b-PMSEA₇₅ and PAA₁₂₅-b-PMSEA₂₅ star polymers have a net negative apparent (-potential exceeding −25 mV (EPM exceeding −2 μm cm V⁻¹ s⁻¹) (FIG. 16 (a)). High NP charge has been demonstrated to promote plant protoplast and chloroplast uptake that results in the NPs becoming kinetically trapped within plant cell or organelle lipid bilayers. The star polymers having high content charge may have a lower mobility in plant cells and organelles due to their interactions with lipid membranes that reduces their long-distance transport in plants.

On the other hand, we hypothesize that this significant negative electrical potential could also be triggering the plant immune system. The plant immune system detects multivalent ions and stops their spread by expressing a glycine-rich protein cdiGRP, elevating the Callose (1,3-β-D-glucan) level in the vasculature to reinforce the cell wall and create a boundary between the vascular and non-vascular tissue. This immune mechanism has been reported to inhibit systemic transport of tobacco mosaic virus (TMV) in plants. Star polymers with a similar smallest dimension and charge to TMV (diameter ˜10 nm, apparent ζ-potential ˜−35 mV at pH 7.5) may also be trapped through this plant defense mechanism. Our data suggests that the immune regulation may be more restrictive to the higher charge content star polymers compared with the lower charge content ones. Apart from the plant immune response, the plant cell wall can also stop extraneous agents from moving in plants. For instance, multivalent metal ions can be immobilized in the stem by binding with cellulose on the cell wall. A possible role of direct star polymer interactions with cell wall components cannot be ruled out.

Star polymer hydrophobicity affect their foliar uptake pathway. Transport results for PAA₂₅-b-PMSEA₁₂₅, PAA₂₅-b-P(MSEA₁₀₀-co-MTEA₂₅) and PAA₂₅-b-P(MSEA₇₅-co-MTEA₅₀) star polymers that have similar charge content and hydrodynamic diameters but different hydrophobicities are shown in FIG. 19 (d,e,f). Star polymers with higher MTEA content are more hydrophobic (FIG. 16 (b,c)). Total translocation (phloem loading) and star polymer distributions in different plant organs are similar for the different hydrophobicities (FIG. 20 (c)). The absence of an effect of hydrophobicity in transport was not expected. This is because SILWET® L-77 (0.1 wt %) lowers the surface tension of the applied polymer solution to promote wetting and uptake through stomatal pores, and it also disturbs the cuticle and epidermis cells. The latter helps the star polymers to penetrate through the cuticle and epidermis and enter the mesophyll, and ultimately load into the phloem, regardless of their hydrophobicity.

We confirmed this by measuring the distribution of CV-loaded star polymers in tomato leaves using DF-HSI. The effectiveness of spectral library to pick up CV loaded star polymers signals was confirmed by mapping the control images. The CV-loaded star polymers could not be detected on the leaf surface (above the cuticle) or in or above the epidermis layer when CV loaded star polymers were applied together with SILWET® L-77 for both PAA-b-PMSEA and PAA-b-P(MSEA-co-MTEA) star polymers. This indicates that nearly all of the applied star polymers penetrated more deeply and accessed the mesophyll.

Interactions of CV loaded PAA₂₅-b-PMSEA₁₂₅ and PAA₂₅-b-P(MSEA₇₅-co-MTEA₅₀) star polymers with tomato leaves applied without surfactants were assessed by enhanced dark field hyperspectral imaging. Images showed the leaf surface, the epidermis and both low and high magnification, and leaf trichomes. Pixels containing the CV loaded polymers were highlighted based on their hyperspectral signature. Hyperspectral detection of CV-loaded star polymers is described in detail above, along with a hyperspectral library used for identifying CV loaded star polymers. When applied without surfactants, the star polymers with different hydrophobicity do interact with tomato leaves differently. Both the hydrophilic PAA₂₅-b-PMSEA₁₂₅ and hydrophobic PAA₂₅-b-P(MSEA₇₅-co-MTEA₅₀) star polymers were present on the leaf surface. However, the more hydrophilic PAA₂₅-b-PMSEA₁₂₅ star polymer is taken up into the epidermis layer through cuticle penetration, as more CV-loaded star polymers were found in the epidermis cell layer. In contrast, the more hydrophobic PAA₂₅-b-P(MSEA₇₅-co-MTEA₅₀) star polymers were found to accumulate mainly at the bases of trichomes in the epidermis layer. The presence of the relatively more hydrophobic PAA₂₅-b-P(MSEA₇₅-co-MTEA₅₀) star polymers in the epidermis was much less than their more hydrophilic counterparts. This is possibly due to stronger interaction between the more hydrophobic star polymer and the similarly lipophilic tomato leaf cuticle, which potentially inhibits hydrophobic star polymers from penetrating through and being taken up into the epidermis layer. A previous study also showed that Au NPs with a more hydrophobic surface coating adhere more strongly to wheat cuticle, which potentially inhibits their further transport. Recent studies have also shown that trichomes can be an important pathway for NP adsorption and accumulation. This study also indicates that trichomes may be a significant uptake pathway for relatively hydrophobic star polymers in the absence of a surfactant spreading agent. These results suggest that foliar applied polymer nanocarriers may be designed to target specific locations, e.g., epidermis or trichomes, by selecting appropriate properties.

Environmental implications. In this study, we have synthesized star polymers with different size, negative charge content and hydrophobicity, and tested their uptake, phloem loading and biodistribution after foliar application. The star polymers have significantly more efficient uptake and phloem loading (30%) than that of conventional active ingredients (0.1%) and micronutrients (5%). When loaded with active agents or micronutrients, enhanced uptake and transport efficiency achieved by star polymers could potentially help reduce agrochemical application rates and losses, which would alleviate the environmental burden caused by agrochemical runoff into natural water and soil.

Apart from high phloem loading, the star polymers with lower negative charge content exhibit higher translocation to non-vascular tissues such as younger leaves, older leaves and to roots. Smaller star polymers better translocate to younger leaves, and larger star polymers have higher accumulation in roots. Therefore, star polymers with different sizes and charges can be used for targeted agent delivery into different plant compartments. These findings can help in the rational design of polymer based nanocarriers, enabling targeted and more effective plant disease control. This study also suggests that star polymers with different hydrophobicity could interact with plant leaves differently when applied without surfactants, with the more hydrophilic star polymers showing better penetration through cuticle toward the epidermis cell layer, while the more hydrophobic counterpart transports to the epidermis layer mainly through trichomes on the leaf surface. This indicates hydrophobicity of nanocarriers can affect their uptake into leaf epidermis for agents applied without surfactants.

### Example 3

Plant abiotic stress from e.g. extreme heat and drought induces reactive oxygen species (ROS) accumulation that can decrease photosynthetic performance and crop yield. ROS include, without limitation: peroxides, superoxide, hydroxyl radical, singlet oxygen and alpha oxygen. Materials for effective plant stress management are needed to combat these climate induced effects on crops. Here, a ˜20 nm ROS responsive star polymer (RSP) poly(acrylic acid)-block-poly((2-(methylsulfinyl)ethyl acrylate)-co-(2-(methylthio)ethyl acrylate)) (PAA-b-P(MSEA-co-MTEA)) designed for both controlled agent release and ROS scavenging was synthesized and characterized both in-vitro and in-vivo. RSP scavenged up to 10 μmol mg⁻¹ ROS in vitro, and significantly suppressed ROS in vivo in stressed tomato (Solanum lycopersicum) leaf mesophyll. The Mg release from Mg loaded RSP was also enhanced by H₂O₂ at plant relevant pH (4.5 and 7.5). Hyperspectral-Enhanced Dark field Microscopy indicate that RSP penetrates through the tomato leaf epidermis and distributes around chloroplasts in mesophyll. The foliar applied RSP increased the tomato plant carbon assimilation rate by 67%, quantum yield of CO₂ assimilation by 59%, Rubisco carboxylation rate by 81% and photosystem II quantum yield by 57% compared to untreated plants after applying heat and excess light stress (T=40° C., 2000 μmol m⁻² s⁻¹ PAR). Mg loaded RSP enhanced carbon assimilation of Mg deficient plants by 29% and increased Rubisco carboxylation rate by 118%, improving photosynthesis of Mg deficient plants mainly by promoting Rubisco activity. These results underline the potential of ROS scavenging nanocarriers like RSP to alleviate abiotic stress in crop plants, allowing agriculture to be more resilient to heat stress, and potentially other climate change induced abiotic stressors.

In further detail, ROS is a major plant stress indicator that also damages plant organelles and suppresses photosynthesis. Environmental stressors like heat and drought can inhibit a subset of enzymes, causing functional uncoupling of metabolic pathways and accumulation of intermediate compounds such as ROS in plants. ROS serve as signaling molecules for plant defense system activation against environmental stress. However, ROS accumulation in plant cells lead to oxidation damage of carbohydrates, proteins, lipids and DNA. ROS generation in chloroplasts also hamper photosynthesis, decreasing crop yield. Therefore, the ROS concentration in plants under stress needs to be managed to suppress their inhibition of photosynthesis and damage to other cell organelles. Previous studies have managed plant stress and ROS accumulation by negatively charged nanoceria and bioself-assembled molybdenum-sulfur crystals. However, these approaches either require nanoparticle solution injection into each leaf or multiple sprays in large volume, limiting their practicality. Also, neither of these materials can offer agent delivery functionality in response to plant stress. For example, in addition to scavenging ROS, the simultaneous delivery of other stress relievers such as plant hormones or photosynthesis promoters like magnesium could increase the efficacy of these ROS scavenging nanocarriers. ROS accumulation resulting from plant stress can potentially be used to trigger agent release from the nanocarrier if it were designed to change its properties after reacting with the ROS.

Thioether is a promising functional group to be incorporated into materials for plant oxidative stress management and controlled agent release. Non-protein thiol molecules, including glutathione (GSH) can serve as antioxidants to scavenge ROS in the cytosol, preventing damage to cellular components. The relatively hydrophobic thioether groups can reduce various ROS species including hydrogen peroxide, superoxide and hydroxyl radical, transforming into more polar and hydrophilic sulfoxide or sulfone groups. For example, a thioether core-crosslinked nanoparticle made from thiol-ene crosslinked polysorbate 80 was able to reduce neuroinflammation by preventing ROS spreading (D. Yoo, A. W. Magsam, A. M. Kelly, P. S. Stayton, F. M. Kievit, A. J., Convertine, ACS Nano 2017, 11, 55). PEGylated polymeric nanoparticles (NPs) composed of poly(propylene sulfide) were used for ischemic stroke therapy by scavenging ROS (O. Rajkovic, C. Gourmel, R. d'Arcy, R. Wong, I. Rajkovic, N. Tirelli, E., Pinteaux, Adv. Ther. 2019). Apart from direct ROS scavenging, thioether chemistry is also widely used for ROS responsive agent release. An amphiphilic diblock copolypeptoid with a ROS responsive poly(N-3-(methylthio)propyl glycine) hydrophobic block can encapsulate a drug and self-assemble into micelles under normal conditions. The micelle collapses when encountering ROS through oxidation of thioether side chains into hydrophilic sulfoxides, releasing the drug.

While thioether chemistry has been well studied in biomedical research, none of the current materials are suitable for plant foliar application and stress management due to their large size (>50 nm) and lack of charge that limits their ability to enter plant protoplast, and, further, the instability of micelle structures limits their agent-carrying capability. This also limits their ability to penetrate cell membranes and enter plant mesophyll cells. A material that can enter crop plants after application as an aqueous foliar spray, and alleviate abiotic stress by scavenging ROS while delivering beneficial agents is highly useful, considering the strong correlation between ROS generation and plant stress. Plant nutrient and stress regulating agents are most needed when plant is under stress with excess ROS that need to be managed.

### Methods

Chemical materials. 2-(Methylthio)ethanol (≥99%), hydrogen peroxide solution (30%), Tris[2-(dimethylamino)ethyl]amine (Me₆Tren), anisole (99%), N,N-dimethylformamide (DMF, 99%), 2′,7′-dichlorodihydrofluorescein diacetate (DCFH-DA), trifluoroacetic acid (TFA) and HNO₃ (70%, trace metal grade) were purchased from Fisher Scientific. Acrylic acid (>99%), tert-butyl acrylate (99%), N-(3-(dimethyl amino)propyl)-N′-ethylcarbodiimide hydrochloride (EDC-HCl, 99%), N,N-dimethyl aminopyridine (DMAP, >99%), copper bromide (>99.99%), β-cyclodextrin (p-CD), 2-bromoisobutyryl bromide (BiBB, 98%), 1-methyl-2-pyrrolidone (NMP), 2′,7′-Dichlorofluorescin diacetate (DCFH-DA, 97%), methanol (99.8%), dichloromethane (DCM), crystal violet (CV, >90.0%), sodium persulfate (>98%), sodium sulfate (>99%) and chloroform-d (CDCl₃) were purchased from Sigma Aldrich. Dialysis bags with various molecular weight cutoffs were purchased from Spectrum lab (Spectra/Por 7). Acrylate monomers were passed through a basic alumina column before use.

Synthesis of PAA₂₅-b-PMSEA₁₂₅ (CSP) and PAA₂₅-b-P(MSEA₇₅-co-MTEA₅₀) (RSP) Star polymers by core-first method.

Synthesis of 2-(Methylthio)ethyl acrylate (MTEA). Briefly, 10 g of 2-(Methylthio)ethanol (1 equiv), 8.6 g of acrylic acid (1.1 equiv) and 24 g of EDC (1.15 equiv) were dissolved into 200 mL DCM in a 500 mL round bottom flask equipped with a stir bar in ice bath. The reaction was sealed and purged with N₂ for 10 min. Then, 1.89 g DMAP (0.14 equiv) was dissolved into 5 mL DCM and injected into the reaction. The reaction was allowed to pursue under room temperature for 24 h and reagent conversion was monitored by ¹H NMR (Bruker Advance 500 MHz NMR spectrometer). The product in DCM was washed twice by 1 M HCl and saturated NaHCO₃ and washed once by saturated NaCl. The product was passed through Na₂SO₄ column to remove water and DCM was removed by rotary evaporator to yield MTEA. Product was characterized by ¹H NMR.

Synthesis of 2-(Methylsulfinyl)ethyl acrylate (MSEA). In a typical procedure, 7.0 g of MTEA (1 equiv) was added into a 25 mL round bottom flask with a stir bar and sealed with a rubber stopper. The reaction was kept in ice bath and purged with N₂ for 5 min. Then, 5.98 mL of 30% H₂O₂ solution (1.1 equiv) was slowly injected into the flask at 50 μL/min. The reaction was allowed to warm to room temperature and pursued for 24 h. Reaction was stopped by mixing with 50 mL Milli Q water. The MSEA water solution was extracted by 150 mL DCM for 3 times. DCM phase was collected and passed through column filled with mixture of Na₂S₂O₈ and Na₂SO₄ to remove H₂O₂ and water. DCM was removed by rotary evaporator and the pure MSEA was characterized with ¹H NMR.

Synthesis of β-CD-21BrATRP Initiator. The β-CD based macroinitiator with 21 ATRP initiation sites was synthesized as above. Composition of this macro-initiator was confirmed by ¹H NMR (CDCl₃ 500 MHz) 5: 5.28 (7H, d, J=3.6 Hz), 4.86 (7H, dd, J=10.2, 3.5 Hz), 4.61 (7H, m), 4.35 (7H, m), 4.11 (14H, m), 3.79 (7H, t, J=9.2 Hz), 1.97 (21H, s) ppm.

Synthesis of PtBA core for PtBA₂₅-b-PMSEA₁₂₅ and PtBA₂₅-b-P(MSEA₇₅-co-MTEA₅₀) star polymers. The 21-armed PtBA star polymer was prepared using Supplemental Activation Reducing Agent (SARA) ATRP. Briefly, 0.1 g of β-CD-21Br initiator (β-CD-21 Br, 1 equiv), 3.61 mL of tBA (1050 equiv), 0.55 mg of CuBr₂ (0.105 equiv), 1.71 μL of Me₆Tren (0.263 equiv), 3.61 mL of anisol and 1 cm Cu⁰ wire were added and mixed in a sealed Schlenk flask with a stir bar. The Schlenk flask was degassed by purging with N₂ for 20 min, and the reaction was allowed to proceed at room temperature for ˜20 h. The reaction was monitored by ¹H NMR and stopped at 50% conversion to yield PtBA star polymers with 25 tBA repeat units in each arm. Excess reagents were removed by dialysis (MWCO=8000) against methanol for 3 cycles.

Synthesis of PtBA₂₅-b-PMSEA₁₂₅ star polymers. The PMSEA chains were extended from previously synthesized PtBA star polymer by photo ATRP. All photo ATRP in this study were conducted in a 4.9 mW cm⁻² MelodySusie® UV lamp. Briefly, 0.06 g of 25 DP PtBA star polymer (1 equiv), 0.713 g of MSEA (5250 equiv), 0.98 mg of CuBr₂ (5.25 equiv), 4.28 μL of Me₆Tren (18.4 equiv) and 4.4 mL DMF were added and mixed in a sealed Schlenk flask with a stir bar. The Schlenk flask was degassed by purging with N₂ for 30 min, and the reaction was allowed to proceed under UV light at room temperature for ˜3 h. Monomer conversion was monitored by ¹H NMR and reaction was stopped at ˜50% conversion to yield PtBA₂₅-b-PMSEA₁₂₅ star polymers. The product was purified by dialysis against methanol for 3 cycles (MWCO=8000). The chemical composition of product was verified by ¹H NMR in CDCl₃.

Synthesis of PtBA₂₅-b-P(MSEA₇₅-co-MTEA₅₀) star polymers. Synthesis of PAA₂₅-b-P(MSEA₇₅-co-MTEA₅₀) star polymer followed the same protocol as above but used different reagent ratios. Briefly, 0.05 g of PtBA star polymer (1 equiv), 0.595 g of MSEA (5250 equiv), 0.357 g of MTEA (3500 equiv), 1.37 mg of CuBr₂ (8.75 equiv), 10.18 μL of Me₆Tren (52.5 equiv) and 5.87 mL of DMF were mixed in a sealed Schlenk flask with a stir bar. The reaction was purged by N₂ for 30 min, pursued under UV light at room temperature for ˜6 h and stopped at ˜35% total conversion to yield PAA₂₅-b-P(MSEA₇₅-co-MTEA₅₀) star polymer.

Hydrolysis of PtBA₂₅-b-PMSEA₁₂₅ and PtBA₂₅-b-P(MSEA₇₅-co-MTEA₅₀) star polymers. A 0.3 g mass of synthesized PtBA₂₅-b-PMSEA₁₂₅ or PtBA₂₅-b-P(MSEA₇₅-co-MTEA₅₀) star polymer was dissolved in 10 mL DCM in a 25 mL glass vial with stirring. The polymer solution was placed in ice bath and 1 mL of TFA was injected into the solution. The reaction was allowed to warm to room temperature and pursued for ˜24 h. Resulting solution was dialyzed against methanol for 3 cycles (MWCO=8000) to remove excess TFA.

Mg loading and in vitro controlled release experiments. To load Mg into star polymers, 10 mg of RSP was dissolved into 5.0 mL of Milli Q water with pH 6.5 by sonication in ice bath for 10 min (isonic P4800, 60 W). Then, 5 mg of MgSO₄ was added into the polymer solution and mixed for 24 h with a vortex mixer. The resulting solution was dialyzed against 1 L of Milli Q water (MWCO=8000) to remove excess Mg. To assess the ROS and pH responsive agent release property of RSP, the controlled release study was performed in 10 mM phosphate buffer at pH of either 4.5 or 7.5. 50 mM of H₂O₂ was added as ROS to trigger response from star polymers. In a typical procedure, 2.5 mL of Mg loaded star polymer solution was dialyzed against 100 mL phosphate buffer (MWCO=8000). Aliquots of the dialysis solution was sampled at multiple time points to assess Mg release profile of RSP. The Mg loading and release were quantified by ICP-MS (Agilent 7700X).

Monitoring MTEA reaction with H₂O₂ by ¹H NMR. Five mg of RSP was dissolved into 0.5 mL of D₂O to prepare a 10 g L⁻¹ polymer solution. The ¹H NMR spectra of RSP in D₂O was acquired and denoted as time zero (0 h). Then, 100 mM of H₂O₂ was added into polymer solution by diluting 30% H₂O₂. The ¹H NMR spectra of this mixture was acquired 1, 2, 4 and 12 h after H₂O₂ addition to monitor the reaction between RSP and H₂O₂.

In vitro ROS scavenging study. DCFH-DA was first dissolved into methanol to make 1 mM stock solution. The stock solution was stored in 2 mL aliquots under −80° C. The DCFH-DA was diluted by 10 mM phosphate buffer (pH=7.5) to make a 500 μM working solution. The RSP and CSP at 0.05 and 0.5 g L⁻¹ was dissolved in 0, 0.5, 1, 2 and 5 mM H₂O₂ solution in 10 mM phosphate buffer (pH=7.5) in 1.8 mL. The mixture was shaken in dark for 4 h to allow H₂O₂ fully react with star polymers, followed by adding 0.2 mL of DCFH-DA working solution and react for another 4 h in dark. Three replicates were prepared for each treatment. The fluorescence (ex: 480 nm, em: 530 nm) was assessed by a fluorometer (Horiba FluoroMax-4) to quantify H₂O₂ concentrations in each sample.

Plant growth. For plant photosynthesis and star polymer uptake study, tomato (Solanum lycopersicum) seeds were rinsed by Milli Q water for two times before surface sterilized with 10% (v/v) bleach for 3 min, then thoroughly rinsed by Milli Q water for five times. The sterilized seeds were germinated in petri-dish on water-soaked filter paper under dark for 10 days. Afterwards, the seedlings were transplanted to 100 mL plastic cups. Each seedling was grown hydroponically using ¼ strength Hoagland's solution aerated using air pumps. The plants were grown at room temperature (−20° C.) with a 16 h light and 8 h dark cycle. The plants were used for foliar uptake and photosynthesis experiments after 30 days of growth. The Mg deficient plants were cultured in the same way as regular tomato plants but used Mg free ¼ strength Hoagland solution to culture the plants for another 20 days after cultured in regular ¼ strength Hoagland solution for 20 days.

### Tracking Star Polymer Distribution in Exposed Leaves by Enhanced Dark Field Hyperspectral Imaging (DF-HSI).

Tracer loading into star polymers. To load CV into star polymers, 10 mg of star polymer was dissolved into 5 mL of Milli Q water with pH adjusted to 7.5 by adding aliquots of 0.1M HCl and 0.1 M NaOH. 2 mg of CV was added into the star polymer solution and the mixture was vortex mixed for 24 h. The resulting solution was dialyzed against 2 L of Milli Q water for 2 cycles to remove free CV. After dialysis, the sample volume was adjusted to 20 mL to get a 0.5 g L⁻¹ CV loaded star polymer solution. Spreading agent Silwet L-77 was added into the star polymer solution at 0.1% (v/v) before foliar application. 20 μL of the CV loaded star polymer was applied onto tomato leaves by drop deposition. The distribution of CV loaded star polymers in plant leaf mesophyll was studied by enhanced dark field hyperspectral imaging (DF-HSI).

This enhanced resolution dark-field microscope system (BX51, Olympus, USA) was equipped with a 150 W halogen light source (Fiber-Lite, Dolan-Jenner, USA) and a hyperspectral camera (CytoViva hyperspectral imaging system 1.4). The leaves were observed at 10× in air or in oil immersion at 60× magnification. Hyperspectral images were acquired using 100% light source intensity and 0.1 to 0.25 s acquisition per line and corrected for the lamp contribution. The hyperspectral libraries were built using images of leaves exposed to the different loaded star polymer, as described in the SI section “hyperspectral library building”. All contributions of the hyperspectrum contained in control images were background subtracted from exposed samples before image analysis. The hyperspectral libraries were used to map the locations of loaded star polymer in hyperspectral images of dosed leaves. A spectral angular mapping algorithm (SAM, ENVI 5.2) was used to identify the pixels matching the loaded star polymer hyperspectral libraries (angles≤0.085 rad were considered similar) on bands 1-177 (between 400 and 670 nm). Each pixel identified that way was highlighted in red. All the hyperspectral images were acquired at cross-section focus. Because of the narrow depth of field (less than a μm), signals of CV loaded star polymers were only mapped by SAM in the focal plane shown in the pictures, and out-of-focus CV loaded star polymers adsorbed on top or under the focus plane were not mapped, in agreement with previous studies, which allows distinguishing polymers inside vs outside cells.

Monitoring in vivo ROS scavenging by RSP. A 2′,7′-dichlorodihydrofluorescein diacetate (H₂DCFDA, Thermo Fisher Scientific) assay for ROS detection in vivo in plant leaves was performed as reported previously with modifications.^{[1]} A 100 μL solution of star polymers suspended in 0.1 wt % SILWET® was applied onto tomato leaves and incubated for 24 h. Tomato leaf discs were collected with a cork borer and incubated in ROS dye in TES buffer (10 mM pH 7.5) for 0.5 h under darkness. Leaf discs were washed with TES buffer and transferred on a microscopy glass slide for confocal microscopy imaging. Confocal microscopy images were taken in selected regions of leaf mesophyll cells using Leica SP5 confocal microscope and water objective 40×. Leaf samples were exposed to a 405 nm UV laser for 3 min followed by imaging of DCF fluorescence signal in leaf mesophyll cells. Settings for confocal fluorescence microscopy imaging were as follows: laser excitation 496 nm; detection range for DCF fluorescence (PMT1, 500-600 nm) and chloroplast autofluorescence (PMT2, 700-800 nm). Four to six plants were measured per star polymer and control treatments. Changes in fluorescence intensity in collected images were analyzed with Fiji software.

Leaf carbon assimilation rate and chlorophyll fluorescence. Plant leaf carbon assimilation and chlorophyll fluorescence was measured by a Li-Cor Li-6800 portable photosynthesis system. The tomato plant leaves were exposed with 0.5 g L-1 RSP, 0.5 g L-1 Mg loaded RSP, MgCl₂, CSP without ROS responsiveness and MilliQ water control together with 0.1 v/v Silwet L-77 spreading agent. The treated leaves were incubated for 24 h after foliar application to allow star polymers enter the tomato leaves.

Combined heat and excess light stress. The carbon (A-Ci) and light response (A-PAR) curves of treated leaves were measured before stress conditions. The gas chamber of Li-Cor was used to create heat and light stress condition (T=40° C., 2000 μmol m⁻² s⁻¹ PAR, RH=40%) for 1.5 h. The carbon and light response curves were measured again and compared with the curve acquired before stress. A-Ci curves were performed at 1200, 1000, 800, 600, 400, 200, 100, 50, and 0 ppm of Ci at 40° C. under 2000 μmol m⁻² s⁻¹ PAR light. The A-PAR curves were acquired at 1200, 900, 600, 400, 300, 200, 100, 50, and 0 μmol m⁻² s⁻¹ PAR at 40° C., 400 ppm Ci. Light adapted (PhiPSII) chlorophyll fluorescent test were also performed before and after stress conditions. The A-Ci curves were analyzed according to previously reported model for C₃ plants:

A=V_{Cmax}[(C_{c}−Γ*)/(C_{c}+K_{C}(1+O/K_{O}))]−R_{d}

where V_{Cmax} is the maximum carboxylation rate, C_{c} is the CO₂ partial pressure in Rubisco, Γ* is the photorespiratory compensation point, O is partial pressure of oxygen, R_{d} is mitochondrial respiration, K_{C} and K_{O} are Michaelis constants of Rubisco for carbon dioxide and oxygen, respectively. The quantum yield of CO₂ assimilation (PhiCO₂) was acquired by calculating the slope of A-PAR curve at 200, 100, 50, and 0 μmol m⁻² s⁻¹ PAR.

Mitigating Mg deficiency. The A-Ci and A-PAR curves of tomato leaves before and 48 hours after treatments were assessed to evaluate the ability of star polymers to alleviate nutrient deficiency. The A-Ci curve were performed at 1200, 1000, 800, 600, 400, 200, 100, 50, and 0 ppm of Ci at 25° C. under normal light (400 μmol m⁻² s⁻¹ PAR). A-PAR curve were acquired at 1200, 900, 600, 400, 300, 200, 100, 50, and 0 μmol m⁻² s⁻¹ PAR at 25° C., 400 ppm Ci. Light adapted (PhiPSII) fluorescent was also measured before and after treatments. The treated Mg deficient plants were then stressed by light and high heat to examine the stress response of deficient plants after RSP treatments using the procedure above.

### Results and Discussion

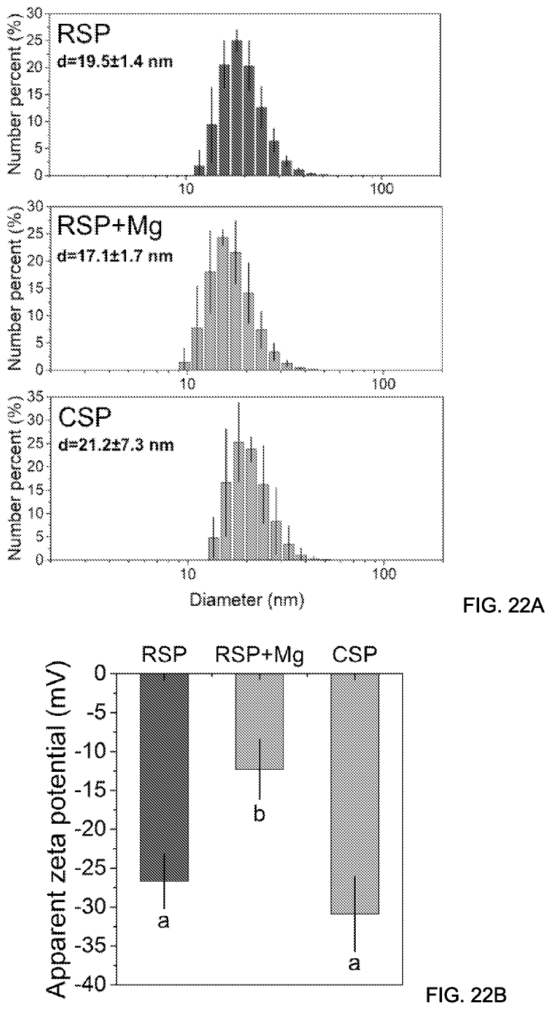

Synthesis and characterization of ROS responsive star polymers. The RSP with 21 PAA₂₅-b-P(MSEA₇₅-co-MTEA₅₀) di-block copolymer arms were made by a core-first approach sa described above. β-Cyclodextrin was functionalized by 2-bromoisobutyryl bromide (BiBB) to create the macroinitiator with 21 atom transfer radical polymerization (ATRP) initiating sites, followed by synthesis of 21 star polymers having a 25 degree of polymerization (DP) poly(tert-butyl acrylate) (PtBA) arms, the precursor of poly(acrylic acid) (PAA) that makes up the RSP core capable of carrying positively charged molecules. The PtBA arms were then block-copolymerized with 2-(Methylsulfinyl)ethyl acrylate (MSEA) and 2-(Methylthio)ethyl acrylate (MTEA), and hydrolyzed to yield a PAA₂₅-b-P(MSEA₇₅-co-MTEA₅₀) ROS responsive star polymer (RSP). A PAA₂₅-b-PMSEA₁₂₅ star polymer (CSP) with similar size and charge, but without the MTEA's ROS scavenging functionality was made as a control to compare with RSP. The chemical composition of RSP and CSP were confirmed by ¹H NMR. The RSP and CSP with the same total DP in each arm had a similar hydrodynamic size of ˜20 nm (FIG. 22A) The carboxylic groups in the PAA core of RSP gives negative charge to star polymers and enables cationic agent loading. Without agent loading, the RSP and CSP had a similar apparent zeta potential of −26.7±3.5 mV and −30.9±4.8 mV, respectively (FIG. 22B). Previous studies suggest that the high magnitude of charge (>±25 mV) of RSP and CSP could enable their penetration through plant cell membranes and entry into leaf mesophyll cells.

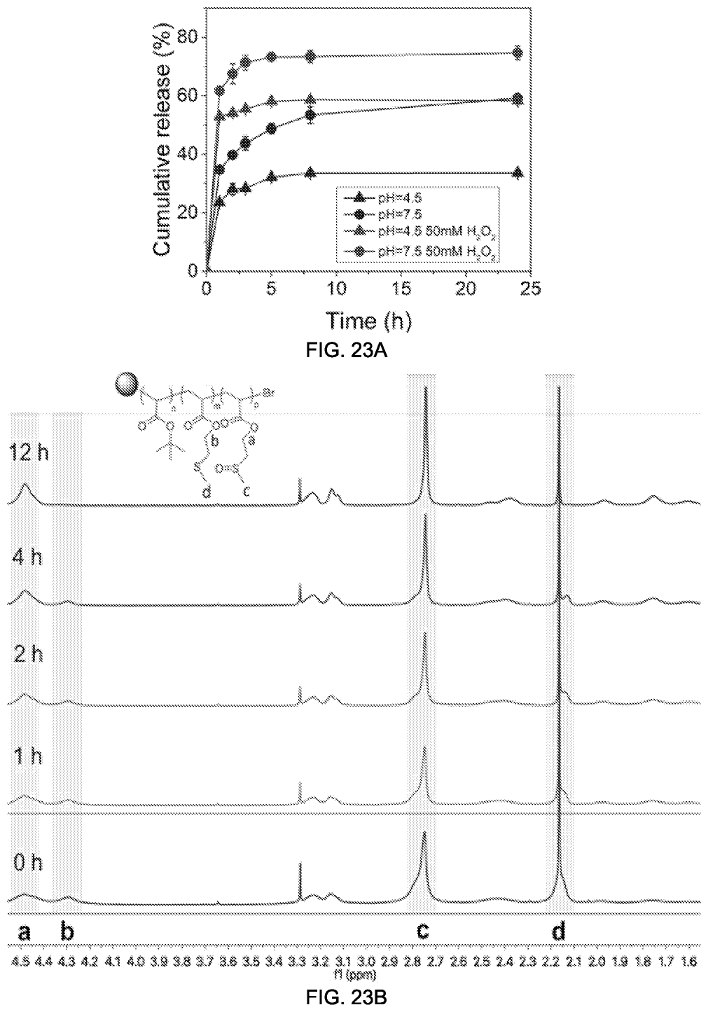

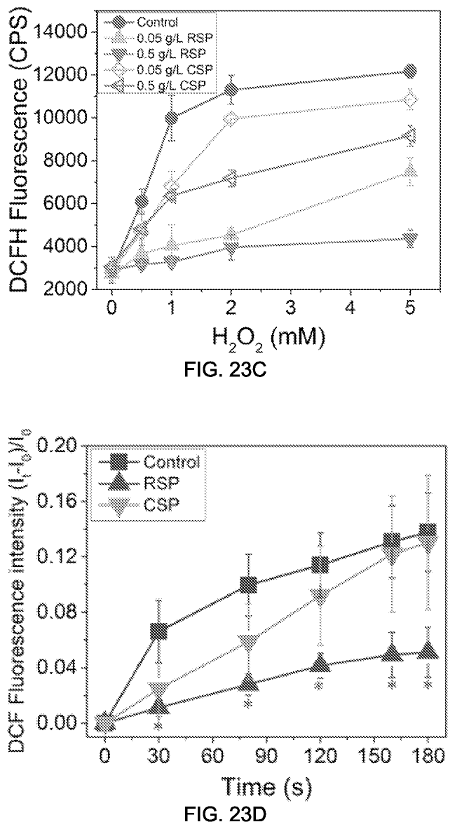

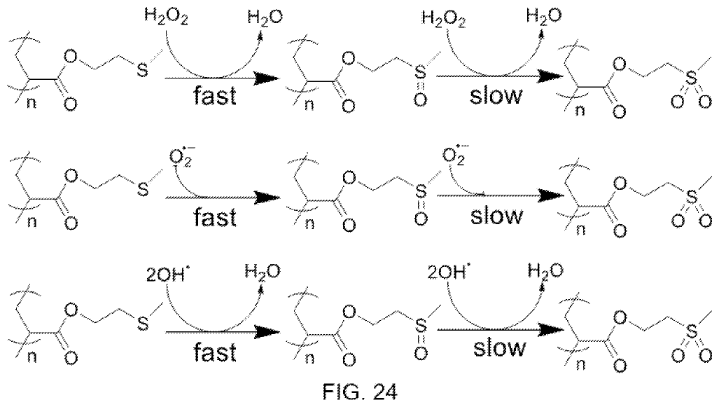

RSP reaction with ROS and responsive agent release. The RSP was designed to scavenge ROS by conversion of hydrophobic thioether (MTEA) into hydrophilic thiosulfinate (MSEA) and thiosulfonate (FIG. 23 (a,b), FIG. 24). The conversion of hydrophobic MTEA into hydrophilic MSEA also led to better hydration of star polymer arms, allowing agents held in the PAA core to more easily diffuse out of the PAA core through hydrated polymer arms, favoring agent release (FIG. 23A). The thioether groups have been reported to reduce ROS species including hydrogen peroxide, superoxide and hydroxyl radical (FIG. 24), which are the predominant ROS species suppressing plant photosynthesis in chloroplast. The reaction between ROS (100 mM H₂02) and MTEA in RSP was monitored by ¹H NMR. The evolution of ¹H NMR spectra as a function of the oxidation time is shown in FIG. 23B. The peaks at 4.28 (b) and 2.15 (d) ppm indicate that MTEA is gradually decreasing in the presence of H₂O₂, while the peaks for MSEA at 4.48 (a) and 2.75 (c) ppm increasing over time indicating that H₂O₂ is oxidizing MTEA into MSEA, confirming that the ROS scavenging mechanism within RSP by is oxidation of the thioether groups in MTEA.

To determine if the star polymers could deliver Mg²⁺ (a plant nutrient necessary for photosynthesis) the RSP was loaded with Mg²⁺ at pH 6.5 via electrostatic attraction between Mg and PAA. Approximately 7.7 mg L⁻¹ (0.32 mM) of Mg was loaded into 0.5 g L⁻¹ RSP solution (0.58 mM PAA), corresponding to ˜2 carboxylic groups binding to each Mg. The Mg loading did not change size distribution of the RSP but reduced the magnitude of the apparent zeta potential to −12.3±3.8 mV by neutralizing the negative charged PAA with Mg²⁺ (FIGS. 24A and 24B). The Mg loaded RSP was first tested in vitro to assess the impact of ROS on its agent release profile. The RSP had greater Mg release upon exposure to ROS at both pH 4.5 and 7.5, with higher cumulative Mg release for all ROS exposed RSP compared to control treatments without ROS at the same pH (FIG. 23A). This is due to the conversion of hydrophobic MTEA into hydrophilic MSEA, which lead to better hydration of the star polymer arms, favoring hydrophilic Mg²⁺ diffusion out of the PAA core. This ROS responsive agent release functionality of RSP may enable delivery of beneficial agents to plants in accordance to stress and elevated ROS production, potentially promoting plant disease and stress management in plants.

In-vitro and in-vivo ROS scavenging by RSP. The in-vitro ROS scavenging capacity of RSP was assessed by the 2′,7′-dichlorodihydrofluorescein diacetate (DCFH-DA). DCFH-DA is initially hydrolyzed into DCFH by a base catalyzed process. DCFH become highly fluorescent at 530 nm upon oxidation by ROS. [¹⁸] DCF fluorescence was measured as function of H₂O₂ concentration (0, 0.5, 1, 2 and 5 mM) with the presence of 0, 0.05 or 0.5 g L⁻¹ RSP or CSP in 10 mM phosphate buffer (pH=7.5) to mimic the cytosol pH (FIG. 23C). The CSP caused some decrease in DCFH fluorescence, likely due to the DCFH interactions with PAA in polymer core. Despite the impact from PAA, the RSP at both 0.05 and 0.5 g L⁻¹ concentrations, had significantly lower DCFH fluorescence compared to both CSP and a phosphate buffer control (FIG. 23C), confirming the role of MTEA in reducing ROS. RSP achieved highest ROS scavenging capacity of ˜10 μmol ROS per mg RSP using 0.05 g L⁻¹ RSP and 5 mM H₂O₂ after subtracting the impact of PAA on DCFH fluorescence. This level of ROS scavenging capacity is comparable to some of the previously reported benchmark antioxidant small molecules, polymers and nanoparticles such as Polymeric PLGA-EC nanoparticles, PS80 core cross-linked nanoparticles and N,O-quaternized chitosans.

In vivo ROS generation in RSP or CSP treated leaf mesophyll cells was assessed by confocal microscopy imaging of the fluorescent ROS prob DCFH-DA. The illuminated chloroplast, major source of ROS in mesophyll cells, was monitored upon stressing the plants. Tomato leaves were treated with RSP, CSP or MilliQ water (control) before being infiltrated with the DCFH-DA ROS probe. The leaves were then exposed to a 405 nm UV-A light for 3 min to induce ROS generation by chloroplasts in mesophyll cells. DCF (2′,7′-dichlorofluorescein) fluorescence intensity was monitored by confocal microscopy. The RSP effectively reduced ROS levels in the UV-A stressed leaf mesophyll, as the DCF fluorescent intensity of RSP treated leaves were significantly lower than the control leaves (P≤0.05), whereas CSP treatment led to similar levels of ROS accumulation relative to no star polymer control (FIG. 23D). These results indicate that RSP indeed scavenges ROS in vivo in stressed leaf mesophyll.

RSP uptake and distribution in tomato leaves. RSP interactions with the plant leaf after foliar application was assessed by dark field hyperspectral imaging (DF-HSI) of crystal violet (CV) loaded RSP in tomato leaves. The CV loaded RSP and free CV were applied to mature tomato leaves with 0.1 vol % SILWET® L-77. Hyperspectral images were acquired both at the leaf epidermis layer and within mesophyll. The effectiveness of the spectral library to recognize CV loaded RSP was confirmed by mapping control images without applied polymer. Hyperspectral imaging and the spectral library of CV loaded (a) PAA₂₅-b-P(MSEA₇₅-co-MTEA₅₀) star polymers (RSP) and (b) free CV were conducted essentially as in the previous examples.

CV loaded RSP was not detected on the leaf epidermis, but was found in the leaf mesophyll 24 h after foliar application, suggesting that all of applied RSP penetrated through epidermis and entered leaf mesophyll. In contrast, free CV was primarily found on the leaf epidermis, with a limited amount inside the mesophyll, revealing the role of RSP in facilitating agent entrance into the leaf mesophyll. From higher resolution images it appears that the CV loaded RSP in mesophyll are mainly found around the boundaries of mesophyll cells, near the chloroplast. However, the CV loaded RSP was not found in chloroplasts extracted from RSP-treated leaves, suggesting the RSP distribute close to the chloroplasts but are not delivered into chloroplast. Considering the size (19.5±1.4 nm) and apparent zeta potential (−26.7±3.5 mV) of RSP, the RSP transport behavior in tomato leaves is consistent with a previously reported nanoparticle plant uptake model, where −20 nm nanoparticles with net charge below 30 mV can enter the plant protoplast, but not the chloroplast.

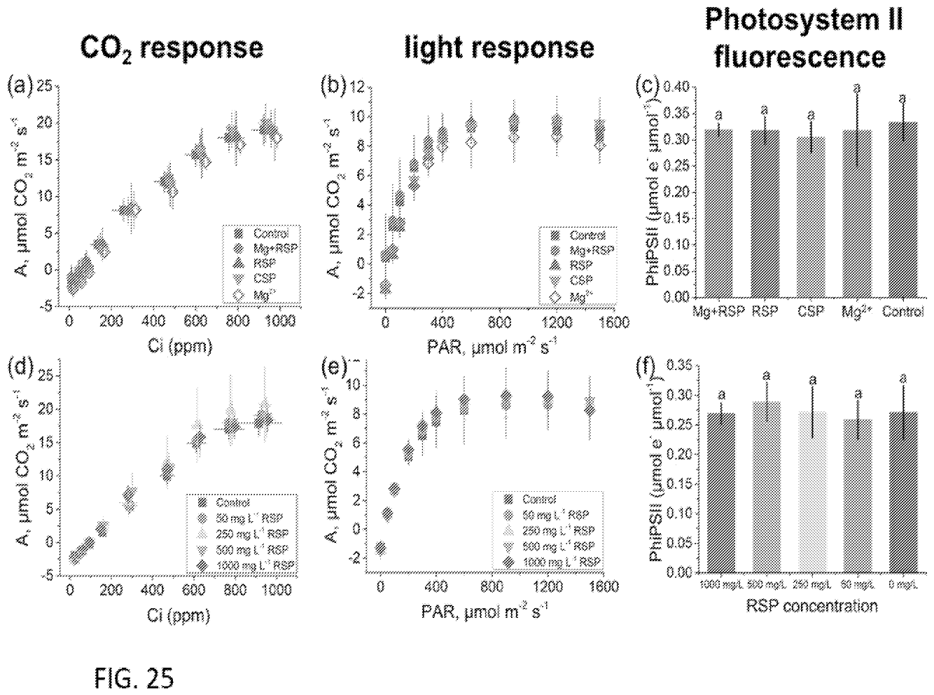

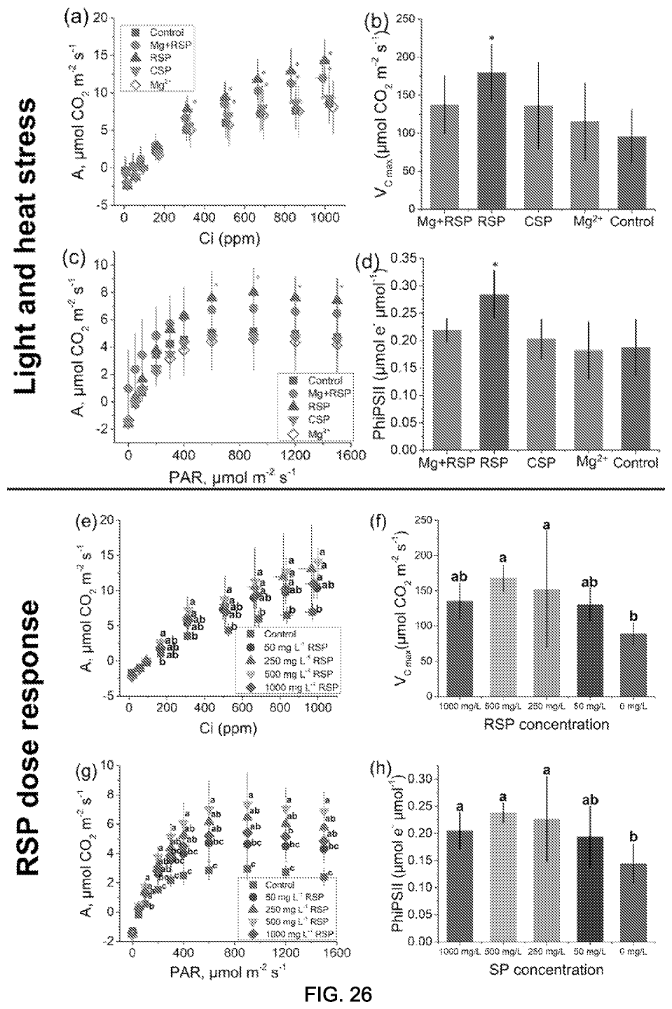

RSP enhances plant photosynthesis under light and heat stress. Abiotic stress such as heat and high light can cause ROS accumulation and damage photosynthetic machinery in chloroplast, such as PSII RC proteins, D1 protein, chloroplast genomes and lipids. Combination of light and heat stress can lead to more severe damage to plant photosynthesis. The ROS scavenging and controlled agent release functionalities of RSP, and their facile uptake into leaf mesophyll suggests that they should be able to scavenge ROS in vivo and enhance plant performance under stress. To test this, the RSP, Mg-loaded RSP, CSP, Mg²⁺ and MilliQ water (control) with 0.1 vol % SILWET® L-77 were applied to mature tomato leaves to assess their impact on plant stress tolerance. No toxicity effects were found for any of the treatments as the photosynthetic activity of all treated leaves were the same before light and heat stress (FIG. 25 (a,b,c)). After being exposed to excess light and heat for 1.5 h (40° C. and 2000 μmol m⁻² s⁻¹ PAR, close to full sun light level), the RSP treatment (20 μL of 500 mg L-RSP) increased photosynthetic carbon assimilation by 67% at high intercellular CO₂ concentration (C-i1000 ppm) (FIG. 26 (a,c)), and Rubisco carboxylation rate (V_{Cmax}) increased by 81% (FIG. 26 (b)) compared to control leaves (P≤0.05). No significant photosynthesis enhancement was observed for CSP and Mg²⁺ treatments compared to control leaves (FIG. 26). The ROS scavenging RSP not only enhanced the in vivo Rubisco carboxylation activity (V_{Cmax}) within the low CO₂ regime (Ci<300 ppm), but also protected the ribulose-1,5-bisphosphate (RuBP) regeneration, promoting the maximum carbon assimilation rate also at Ci>300 ppm.

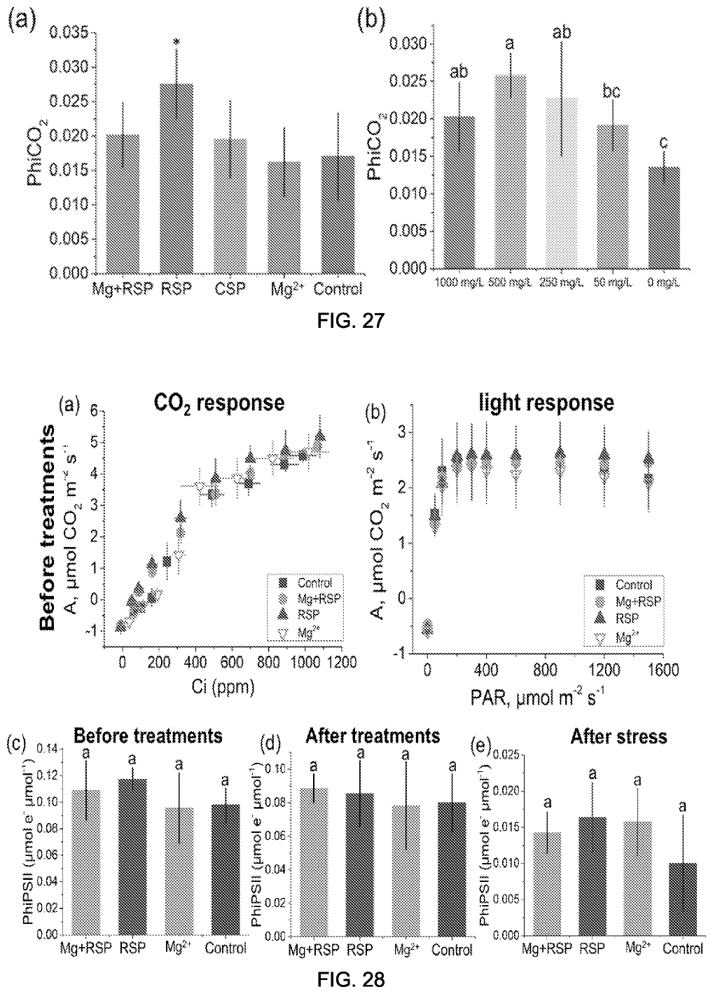

Apart from protecting the carbon reaction, the RSP treated leaves also shown 57% higher photosystem II quantum yield (PhiPSII) and 59% increase in quantum yield of CO₂ assimilation (PhiCO₂) than control plants (P≤0.05) (FIG. 26 (d), FIG. 27 (a)). Mg loaded RSP also slightly increased the PhiPSII of plants but not statistically significantly, while the PhiPSII of CSP and Mg²⁺ treated plants were similar to controls (FIG. 26 (d)). This suggests that RSP treatment suppressed ROS accumulation in the thylakoid membrane, which eliminates the damage to water-oxidizing proteins and favors PSII self-repair. This helped promote the light reaction in photosynthesis under stress by increasing the proportion of photons used in photosynthesis. Mg loaded RSP only significantly enhanced carbon assimilation for up to 39% (p≤0.05) (FIG. 26 (a,c)), but not for other photosynthetic parameters (FIG. 26 (b,d), FIG. 27 (a)). The less effective stress alleviation from Mg loaded RSP compared to unloaded RSP is possibly due to less efficient cell membrane penetration for the less charged (-12.3±3.8 mV) Mg loaded RSP (FIG. 22B), which can lead to lower RSP uptake into mesophyll cells and less effective ROS scavenging around the chloroplast.

The dose response of RSP was studied to confirm its effect on the plant's stress response and determine if there is an optimal dosage for RSP plant application. A 20 μL aliquot of either a 0, 50, 250, 500 or 1000 mg L⁻¹ RSP suspension together with 0.1 vol % Silwet L-77 was applied to each leaf. RSP application at up to 1000 mg L⁻¹ did not induce plant toxicity, as all of treated plants had similar photosynthetic activity before stress (FIG. 25 (d,e,f)). The highest enhancement in photosynthetic activities, including photosynthetic carbon assimilation (FIG. 26 (e,g)), V_{Cmax} (FIG. 26 (f)), PhiPSII (FIG. 26 (h)) and PhiCO₂ (FIG. 27 (b)) was achieved at intermediate (250 and 500 mg L⁻¹) RSP concentrations. The 1000 mg L⁻¹ RSP treatment also increased photosynthetic carbon assimilation, PhiPSII (FIG. 26 (h)) and PhiCO₂ (FIG. 27 (b)) compared to control treatments, but not as much enhancement as 500 and 250 mg L⁻¹ RSP treatments. Rubisco carboxylation (V_{Cmax}) was not promoted for the 1000 mg L⁻¹ RSP treated plants (FIG. 26 (f)). The 50 mg L⁻¹ RSP treatment did not significantly enhance plant photosynthesis after stress, indicating 50 mg L⁻¹ RSP could not offer sufficient ROS scavenging capacity under light and heat stress.

The intermediate optimum dose may be explained by ROS production in stressed and normal plants. Abiotic stress can cause 10-500 μM ROS accumulation in tomato plants. The 20 μL, 250 or 500 mg L⁻¹ treatment yields from 24 to 47 mg g⁻¹ RSP concentration in the tomato leaf assuming 100% RSP uptake and ˜236±70 mg leaf fresh weight (average of 10 leaves). This correspond to ˜235 to 470 μM ROS scavenging capacity (quenching 10 μmol ROS mg⁻¹ RSP), close to the highest amount that has been reported for plant ROS levels under stress (˜500 μM). The 50 mg L⁻¹ RSP offering ˜47 μM ROS scavenging capacity appears insufficient to scavenge enough of the plant mesophyll ROS under stress to manage the heat and light stress. Although ROS accumulation can hinder plant photosynthesis, low levels of ROS serve as signaling molecules to activate plant stress adaptation. The 1000 mg L⁻¹ RSP with ˜940 μM ROS scavenging capacity may be quenching all of the ROS in plant leaves, preventing plant defense system activation through ROS signaling and impeding plant adaptation to stress conditions.

RSP enhances photosynthesis in nutrient deficient tomato plants. Simultaneously scavenging ROS and supplying Mg to plants could further alleviate plant stress and promote photosynthesis. Mg deficiency can cause over 30% increase in leaf ROS levels, decreasing both photosynthetic carbon assimilation and biomass. Mg is required for chlorophyll formation, and is involved in Rubisco activation by complexing with Rubisco activase and directly binding with carbamate groups in Rubisco. Therefore, Mg deficiency can decrease plant photosynthesis by generating excess ROS, eliminating the light reaction due to low leaf chlorophyll content and impeding the carbon reaction by lowering Rubisco activity.

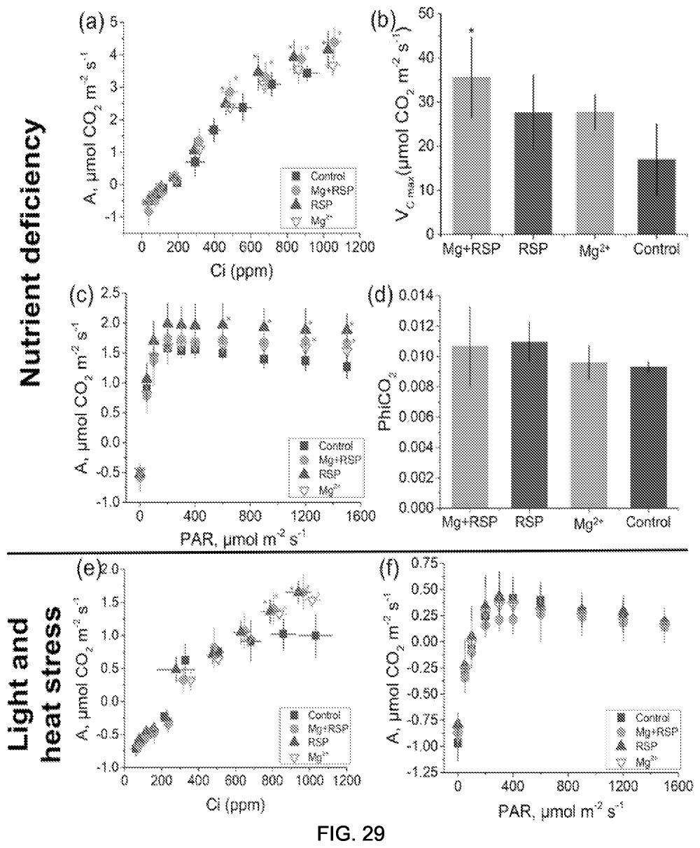

To determine if the Mg loaded RSP could benefit Mg deficient plants under stress, plants were treated with the Mg loaded RSP and the unloaded RSP. All of the Mg deficient plants cultured in this study had ˜75% decrease in carbon assimilation rate, and ˜60% decrease in PhiPSII compared to healthy plants with sufficient Mg (FIG. 28). Treating the Mg deficient plants with Mg loaded RSP enhanced the carbon assimilation rate by 29% (FIG. 29 (a,c)) and increased Rubisco carboxylation rate by 118% (P≤0.05) compared to control plants (FIG. 29 (b)). However, the PhiPSII and PhiCO₂ of RSP and Mg loaded RSP treated plants were not significantly promoted (FIG. 28 (d), FIG. 29 (d)), indicating the light reaction is not enhanced by Mg loaded RSP treatments. Treatments with RSP alone have only enhanced carbon assimilation rate by 20% at higher CO₂ concentration (P≤0.05) (FIG. 29 (a,c)), possibly by scavenging excess ROS in Mg deficient plant mesophyll. Therefore, the Mg loaded RSP partly alleviated Mg deficiency by scavenging ROS and enhancing the carbon reaction by delivering Mg to Rubisco and promoting Rubisco activity. After heat and light stress, the Mg loaded RSP and RSP treated plants had a 51% higher carbon assimilation rate than control plants at high CO₂ concentrations (FIG. 29 (e)) (P≤0.05), suggesting that the RSP treatments can partly reduce impacts from heat and light stress in Mg deficient plants, but the treatments could not fully recover photosynthetic activity of stressed plants.

Although the Mg loaded RSP have partly enhanced photosynthesis of plants under Mg deficiency, the photosynthetic performance of Mg deficient plants is still much lower than the healthy plants. A healthy leaf require 0.1-0.2 wt % Mg in leaf dry weight to maintain photosynthetic activity, corresponding to ˜20 μg Mg per leaf. While 20 μL of Mg loaded RSP can only supply ˜0.16 μg Mg. Therefore, the Mg loaded RSP treatment could only supply less than 1% of the total Mg in plant leaf and may not fully recover plant photosynthesis as the Mg delivering capacity of RSP is limited. The small amount of Mg delivered by the RSP did enhance the carbon reaction by increasing Rubisco activity, but was an insufficient amount to recover chlorophyll and promote light reaction. Future works need to focus on developing agent carriers with higher agent (Mg) loading capacity, or potentially loading nanocarriers such as RSP with agents like hormones that promote plant health at low concentrations.

In conclusion, we have synthesized a PAA-b-P(MSEA-co-MTEA) star polymer (RSP) with ‘built in’ ROS scavenging and ROS triggered agent (Mg²⁺) release functionalities. The RSP may serve as a promising stress regulating agent that alleviate plant stress by quenching excess ROS and deliver stress mitigating agents into mesophyll. The thioether groups in RSP reduced up to 10 μmol mg⁻¹ ROS in vitro, and effectively suppressed ROS in vivo, in UV-A stressed tomato leaf mesophyll cells. The CV loaded RSP efficiently penetrated the leaf epidermis and was taken up into mesophyll and distributed near chloroplast, enabling the RSP to quench ROS around plant photosynthetic machinery. The RSP effectively enhanced plant photosynthesis after heat and light stress by promoting both the light reaction (PhiPSII and PhiCO₂) and carbon reaction (maximum carbon assimilation, V_{Cmax}) of plant photosynthesis. RSP achieved maximum photosynthesis enhancement in 250-500 mg L⁻¹ treatments. 50 mg L⁻¹ RSP treatment was insufficient to quench excess ROS under stress, while the 1000 mg L⁻¹ RSP treatment potentially quenched too much ROS, including the ROS that activate plant stress regulating enzymes. Mg loaded RSP partly recovered photosynthesis in Mg deficient plants by scavenging excess ROS and promoting Rubisco activity by delivering Mg. However, more Mg would have to be delivered to fully overcome the Mg deficiency.

Overall, the RSP demonstrated significant ROS quenching and controlled agent release functionality both in vitro and in vivo. The RSP taken up by leaf mesophyll post foliar application enhanced plant photosynthesis under multiple abiotic stresses, including heat, excess light and Mg deficiency. RSP foliar application can be a promising approach to manage plant stress, alleviate stress induced plant disease and make agriculture more resilient to climate change induced extreme weather. However, the RSP with relatively low PAA content (17 mol %) had lower than desirable capacity for Mg delivery. Other nutrient and plant health regulating agents such as plant hormones that improve plant health at lower concentrations should be tested to determine the suitability of RSP for plant agent delivery. Other than changing the agent being delivered, the structure and size of the star polymers can be further engineered to increase agent loading capacity and meet the demand for nutrient delivery.

Having described this invention, it will be understood to those of ordinary skill in the art that the same can be performed within a wide and equivalent range of conditions, formulations and other parameters without affecting the scope of the invention or any embodiment thereof.

1. A composition comprising a star, comb, bottlebrush, or dendritic polymer particle having a diameter, optionally a hydrodynamic diameter, of 50 nm or less, the particle comprising:
a core moiety; and
pendent block copolymer chains extending from the core moiety and comprising a first, acidic or basic (co)polymer segment attached to and extending from the core, and a second, environment-sensitive (co)polymer segment attached to and extending from the first segment, wherein the pendent chains, the first segment, and the second segment each, independently, have a polydispersity index of no more than 2.

2. The composition of claim 1, wherein the first copolymer segment is acidic.

3. The composition of claim 1, further comprising a cargo retained within the particle.

4. The composition of claim 3, wherein the cargo is monoatomic, a non-peptidyl compound, or an antimicrobial peptide.

5. The composition of claim 4, wherein the cargo comprises Mg²⁺, Fe²⁺/Fe³⁺, Zn²⁺, or Ca²⁺, K⁺, Cu²⁺, Mn²⁺/Mn⁴⁺, Mo²⁺/Mo⁶⁺, or Ni²⁺.

6. (canceled)

7. The composition of claim 2, wherein the cargo is crystal violet, a polyamine plant growth promoter such as spermidine, spermine, choline, streptomycin, a tetracycline, a bacteriocin, a defensin, a peptaibol, an antimicrobial cyclopeptide (e.g., an amphisin, a corpeptin, a putisolvin, a syringomycin, a syringopeptin, a tolaasin, a viscosin, a gramicidin, a calophycin, a bacitracin, or a lazaphycin) or pseudopeptide, or an antimicrobial fragment of any of the preceding, or an antimicrobial synthetic peptide.

8-11. (canceled)

12. The composition of claim 1, wherein the core is a polysaccharide residue.

13. (canceled)

14. The composition of claim 12, wherein the core is a cyclodextrin residue, such as a β-cyclodextrin residue.

15. The composition of claim 1, wherein the first segment comprises from 25 to 150 monomer residues, and/or comprises acrylic acid, methacrylic acid, styrene sulfonic acid, or 2-acrylamido-2-methyl-l-propane sulfonic acid residues.

16. (canceled)

17. (canceled)

18. The composition of claim 1, wherein the ratio of the number of monomer residues in the first segment to the number of monomer residues in the second segment ranges from 1:0.25 to 1:<9, or from 1:1 to 1:7.

19. The composition of claim 1, wherein the second segment is thermoresponsive.

20. The composition of claim 19, wherein the second segment imparts a lower critical solution temperature (LCST) between 25° C. to 40° C. to the pendant block copolymer chains and optionally comprises a monomer selected from N-isopropyl acrylamide (NIPAAm), 2-(dimethylamino)ethyl methacrylate (DMAEMA), vinylcaprolactam, 2-hydroxyethyl methacrylate (HEMA diethylacrylamide, and/or poly)ethylene glycol) methyl ether methacrylate.

21. (canceled)

22. (canceled)

23. The composition of claim 1, wherein the second segment oxidizes in the presence of a reactive oxygen species (ROS), becoming more soluble in an aqueous solution and optionally comprises one or more pendant thioether, boronic ester, or selenium-containing groups, and optionally comprises one or more 2-(methylthio)ethyl acrylate residues.

24. (canceled)

25. (canceled)

26. The composition of claim 1, further comprising a surfactant, such as a non-ionic detergent, e.g., 3-(2-methoxyethoxy)propyl-methyl-bis(trimethylsilyloxy)silane.

27. (canceled)

28. (canceled)

29. A method of introducing a cargo into a plant, comprising administering to the plant a composition a star, comb, bottlebrush, or dendritic polymer particle having a diameter, optionally a hydrodynamic diameter, of 50 nm or less, the particle comprising:
a core moiety;
pendent block copolymer chains extending from the core moiety and comprising a first, acidic or basic (co)polymer segment attached to and extending from the core, and a second, environment-sensitive (co)polymer segment attached to and extending from the first segment, wherein the pendent chains, the first segment, and the second segment each, independently, have a polydispersity index of no more than 2; and
a cargo retained within the particle.

30. A method of introducing a cargo into a plant to treat a disease in the plant, comprising administering to the plant a composition comprising a star, comb, bottlebrush, or dendritic polymer particle having a diameter, optionally a hydrodynamic diameter, of 50 nm or less, the particle comprising:
a core moiety;
pendent block copolymer chains extending from the core moiety and comprising a first, acidic or basic (co)polymer segment attached to and extending from the core, and a second, environment-sensitive (co)polymer segment attached to and extending from the first segment, wherein the pendent chains, the first segment, and the second segment each, independently, have a polydispersity index of no more than 2; and
a cargo retained within the particle,
wherein the cargo treats the disease and is administered in an amount effective to treat the disease.

31. The method of claim 29, wherein the particles have a hydrodynamic diameter of less than 20 nm to target new growth in the plant.

32. The method of claim 29, wherein the particles have a hydrodynamic diameter of at least 20 nm to target roots and stem of the plant.

33. (canceled)

34. The method of claim 29, wherein the second segment is poly(NIPAAm).

35. The method of claim 29, wherein the second segment comprises pendant thioether, boronic ester, or selenium-containing groups.

36. The method of claim 35, wherein the second segment comprises a plurality of 2-(Methylthio)ethyl acrylate residues.

37. The method of claim 29, for treating heat stress in the plant, wherein the cargo is an antimicrobial peptide, crystal violet, a polyamine plant growth promotor such as spermidine, Mg²⁺, Fe²⁺/Fe³⁺, Zn²⁺, or Ca²⁺, K⁺, Cu²⁺, Mn²⁺/Mn⁴⁺, Mo²⁺/Mo⁶⁺, Ni²⁺, or an antimicrobial peptide such as streptomycin, tetracycline, a bacteriocin, a defensin, a peptaibol, an antimicrobial cyclopeptide (e.g., an amphisin, a corpeptin, a putisolvin, a syringomycin, a syringopeptin, a tolaasin, a viscosin, a gramicidin, a calophycin, a bacitracin, or a laxaphycin) or pseudopeptide, or an antimicrobial fragment of any of the preceding, or an antimicrobial synthetic peptide, and wherein optionally the pendant block copolymer chains are thermoresponsive, having an LCST between 25° C. to 40° C.

38-49. (canceled)

50. The method of claim 29, wherein the core is a polysaccharide residue, such as a cyclodextrin residue, such as a β-cyclodextrin residue.

51-66. (canceled)
